(19) United States
(12) Patent Application Publication
(10) Pub. No.: US 2025/0105246 A1
(43) Pub. Date: Mar. 27, 2025

(54) CELL FORMATION METHODS AND SYSTEMS FOR LITHIUM BASED SECONDARY BATTERIES

(71) Applicant: Enovix Corporation, Fremont, CA (US)

(72) Inventor: Ross M. Fosler, Snohomish, WA (US)

(21) Appl. No.: 18/884,408

(22) Filed: Sep. 13, 2024

Related U.S. Application Data
(60) Provisional application No. 63/584,700, filed on Sep. 22, 2023.

(51) Int. Cl. H01M 4/04; H01M 10/052; H01M 50/209; H01M 50/507

(52) U.S. Cl. CPC H01M 4/0447; H01M 10/052; H01M 50/209; H01M 50/507

(57) ABSTRACT

A method of pre-lithiating a lithium based secondary battery. The battery includes a population of unit cells, an electrode busbar, and a counter-electrode busbar. Each unit cell includes an electrode structure, a separator structure, and a counter-electrode structure. An auxiliary electrode containing lithium metal is connected to the unit cells. A current sink is connected to the electrode busbar and the auxiliary electrode, the current sink is controlled to conduct current from the electrode busbar through the auxiliary electrode, a voltage between the auxiliary electrode and counter-electrode busbar is detected periodically, an adjustment to the voltage is determined periodically, and the current sink is controlled to control an amplitude of the current to cause a sum of the voltage and the adjustment to be about zero volts.

### CROSS-REFERENCE TO RELATED APPLICATION

This application claims benefit of U.S. Provisional Patent Application Ser. No. 63/584,700, filed on Sep. 22, 2023, which is hereby incorporated by reference herein in its entirety.

### FIELD

The field of the disclosure relates generally to the formation of secondary batteries, and more specifically, to a cell formation system for lithium based secondary batteries.

### BACKGROUND

In rocking-chair battery cells, both the positive electrode and the negative electrode of a secondary battery comprise materials into which a carrier ion, such as lithium, inserts and extracts. As the battery is discharged, carrier ions are extracted from the negative electrode and inserted into the positive electrode. As the battery is charged, the carrier ion is extracted from the positive electrode and inserted into the negative electrode.

Silicon has become a promising candidate to replace carbonaceous materials as the anode because of its high specific capacity. For instance, graphite anodes formed from LiC₆ may have a specific capacity of about 370 milli-amp hours per gram (mAh/g), while crystalline silicon anodes formed from Li₁₅Si₄ may have a specific capacity of about 3600 mAh/g, a nearly 10-fold increase over graphite anodes. However, the use of silicon anodes has been limited, due to the large volumetric changes (e.g., 300%) in silicon when Li carrier ions are inserted into silicon anodes. This volumetric increase along with the cracking and pulverization associated with the charge and discharge cycles has limited the use of silicon anodes in practice. In addition, the use of silicon anodes has been limited due to its poor initial columbic efficiency (ICE), which leads to a capacity loss during the initial formation of secondary batteries that utilize silicon anodes.

After a lithium based secondary battery is assembled, the assembled battery is typically subjected to a formation process. During the formation process the battery is slowly charged and discharged one or more times. At least some known formation processes include a pre-lithiation process to add lithium to the battery. These formation processes are typically performed by large centralized systems. Such systems include a central control center that is connected to all of the batteries that are to undergo the formation process. The central control center directly controls the charging, discharging, and (where applicable) pre-lithiation of all of the batteries to which it is connected. In order to be capable of controlling the formation processes and distributing electrical power to a large number of batteries, the central control centers are relatively large and expensive systems using a significant amount of power, occupying a significant amount of space, and utilizing a large amount of wire to connect to all of the batteries undergoing formation.

### BRIEF DESCRIPTION

One aspect of the present disclosure is a method of pre-lithiating a lithium based secondary battery, the lithium based secondary battery including a population of unit cells, an electrode busbar, and a counter-electrode busbar. Each unit cell of the population of unit cells includes an electrode structure, a separator structure, and a counter-electrode structure. The electrode structure of each member of the unit cell population includes an electrode current collector and an electrode active material layer. The counter-electrode structure of each member of the unit cell population includes a counter-electrode current collector and a counter-electrode active material layer. An auxiliary electrode containing lithium metal is connected to the population of unit cells. The method includes connecting a current sink to the electrode busbar and the auxiliary electrode, controlling the current sink to conduct a current from the electrode busbar through the auxiliary electrode to diffuse lithium from the auxiliary electrode to the electrode active material layers of the lithium based secondary battery, periodically detecting a voltage between the auxiliary electrode and counter-electrode busbar, periodically determining an adjustment to the voltage, and controlling the current sink to control an amplitude of the current from the electrode busbar through the auxiliary electrode to cause a sum of the voltage and the adjustment to be about zero volts.

Another aspect of this disclosure is a pre-lithiation module for pre-lithiating a lithium based secondary battery using auxiliary electrode containing lithium metal. The lithium based secondary battery includes a population of unit cells, an electrode busbar, and a counter-electrode busbar. Each unit cell of the population of unit cells includes an electrode structure, a separator structure, and a counter-electrode structure. The electrode structure of each member of the unit cell population includes an electrode current collector and an electrode active material layer. The counter-electrode structure of each member of the unit cell population includes a counter-electrode current collector and a counter-electrode active material layer. The auxiliary electrode is connected to the population of unit cells. The pre-lithiation module includes a current sink; a pre-lithiation module controller connected to the current sink, the pre-lithiation module controller including a processor and a memory; a battery connector for electrical connection of the current sink to the electrode busbar of the lithium based secondary battery; and a pre-lithiation connector for electrical connection of the current sink to the auxiliary electrode. The memory of the pre-lithiation module controller stores instructions that program the pre-lithiation module controller to: control the current sink to conduct a current from the electrode busbar through the auxiliary electrode to diffuse lithium from the auxiliary electrode to the electrode active material layers of the lithium based secondary battery; periodically detect a voltage between the auxiliary electrode and counter-electrode busbar; periodically determine an adjustment to the voltage; and control the current sink to control an amplitude of the current from the electrode busbar through the auxiliary electrode to cause a sum of the voltage and the adjustment to be about zero volts.

Another aspect of this disclosure is a formation cluster for connection to a single lithium based secondary battery in a cell formation system for lithium based secondary batteries, the formation cluster comprising: a battery connector configured for connecting to the lithium based secondary battery; a charging module connected to the battery connector and configured to charge the lithium based secondary battery connected to the battery connector; a discharging module connected to the battery connector and configured to discharge the lithium based secondary battery connected to the battery connector; and the pre-lithiation module. The prelithiation module includes a current sink; a pre-lithiation module controller connected to the current sink, the pre-lithiation module controller including a processor and a memory; a battery connector for electrical connection of the current sink to the electrode busbar of the lithium based secondary battery; and a pre-lithiation connector for electrical connection of the current sink to the auxiliary electrode. The memory of the pre-lithiation module controller stores instructions that program the pre-lithiation module controller to: control the current sink to conduct a current from the electrode busbar through the auxiliary electrode to diffuse lithium from the auxiliary electrode to the electrode active material layers of the lithium based secondary battery; periodically detect a voltage between the auxiliary electrode and counter-electrode busbar; periodically determine an adjustment to the voltage; and control the current sink to control an amplitude of the current from the electrode busbar through the auxiliary electrode to cause a sum of the voltage and the adjustment to be about zero volts.

Various refinements exist of the features noted in relation to the above-mentioned aspects. Further features may also be incorporated in the above-mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a partially assembled secondary battery having a cutaway portion, prior to application of an enclosure.

FIG. 2 depicts a section view of the secondary battery taken from section line D-D in FIG. 1.

FIG. 3 depicts an example cathode structure for a unit cell of FIG. 2.

FIG. 4 depicts an example anode structure for a unit cell of FIG. 2.

FIG. 5 depicts a perspective view of a buffer system of an exemplary embodiment.

FIG. 6 depicts an exploded view of the buffer system of FIG. 5.

FIG. 7 depicts a perspective view of an auxiliary electrode of an exemplary embodiment.

FIG. 8 depicts an exploded view of the auxiliary electrode of FIG. 7.

FIG. 9 is a perspective view of the auxiliary electrode of FIG. 7 at a stage in an assembly process for the auxiliary electrode of FIG. 7.

FIG. 10 is a perspective view of the auxiliary electrode of FIG. 7 at another stage in an assembly process for the auxiliary electrode of FIG. 7.

FIG. 11 is a perspective view of the auxiliary electrode of FIG. 7 at another stage in an assembly process that adds an extension tab to the auxiliary electrode of FIG. 7.

FIG. 12 is a perspective view of the buffer system of FIG. 5 at a stage in an assembly process for the buffer system.

FIG. 13 is a perspective view of the buffer system of FIG. 5 at another stage in an assembly process for the buffer system.

FIG. 14 is a perspective view of the buffer system of FIG. 5 at another stage in an assembly process for the buffer system.

FIG. 15 is a cross-sectional view of a portion of the buffer system of FIG. 14.

FIG. 16 is a perspective view of the buffer system of FIG. 5 at another stage in an assembly process for the buffer system.

FIG. 17 is a perspective view of the buffer system of FIG. 5 subsequent to performing a buffer process on a secondary battery.

FIG. 18 is a flow chart of a method of pre-lithiating a secondary battery with carrier ions using an auxiliary electrode of an exemplary embodiment.

FIG. 19 is a flow chart depicting additional details of the method of FIG. 18.

FIG. 20 is a flow chart depicting additional details of the method of FIG. 18.

FIG. 21 is a flow chart depicting additional details of the method of FIG. 18.

FIG. 22 is a block diagram of an example cell formation system.

FIG. 23 is a perspective view of an example battery tray for the cell formation system of FIG. 22.

FIG. 24 is a perspective view of an example formation base for the cell formation system of FIG. 22.

FIG. 25 is a magnified view of connector groups of the formation base of FIG. 24.

FIG. 26 is a side view of the battery tray of FIG. 23 being positioned to attach to the formation base of FIG. 24 to form a formation assembly.

FIG. 27 is a partial view of the battery tray of FIG. 23 positioned over the formation base of FIG. 24 with assembly connectors aligned.

FIG. 28 is a partial view of the battery tray of FIG. 23 lowered onto the formation base of FIG. 24.

FIG. 29 is a partial view of the battery tray of FIG. 23 lowered onto the formation base of FIG. 24 with the assembly connectors engaged.

FIG. 30 is a block diagram of an example cell formation system for lithium based secondary batteries.

FIG. 31 is a block diagram of an example cell formation cluster for use in the cell formation system of FIG. 30.

FIG. 32 is a block diagram of an example pre-lithiation module for use in the cell formation cluster of FIG. 31.

FIG. 33 is a simplified circuit diagram of an example embodiment of the pre-lithiation module of FIG. 32 connected to a secondary battery and an auxiliary electrode.

FIG. 34 is a signal flow graph of an example control algorithm for operating the pre-lithiation module of FIG. 33.

FIG. 35 is a graph of the first and second voltages as a function of time during pre-lithiation according to an example control algorithm.

FIG. 36 is a graph of the current from the cathode to the auxiliary electrode during pre-lithiation according to an example control algorithm.

FIG. 37 is a simplified circuit diagram of a first operational state of another example pre-lithiation module connected to a secondary battery and an auxiliary electrode.

FIG. 38 is a simplified circuit diagram of a second operational state of the example embodiment pre-lithiation module of FIG. 37.

Corresponding reference numerals used throughout the drawings indicate corresponding parts.

### DEFINITIONS

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 micrometers (μm) would include 225 μm to 275 μm. By way of further example, in one instance, about 1,000 μm would include 900 μto 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Anode” as used herein in the context of a secondary battery refers to the negative electrode in the secondary battery.

“Anode material” or “Anodically active material” as used herein means material suitable for use as the negative electrode of a secondary battery.

“Cathode” as used herein in the context of a secondary battery refers to the positive electrode in the secondary battery.

“Cathode material” or “Cathodically active material” as used herein means material suitable for use as the positive electrode of a secondary battery.

“Conversion chemistry active material” or “Conversion chemistry material” refers to a material that undergoes a chemical reaction during the charging and discharging cycles of a secondary battery.

“Counter-electrode” as used herein may refer to the negative or positive electrode (anode or cathode), opposite of the Electrode, of a secondary battery unless the context clearly indicates otherwise.

“Counter-electrode current collector” as used herein may refer to the negative or positive (anode or cathode) current collector, opposite of the Electrode current connector, of a secondary battery unless the context clearly indicates otherwise.

“Counter-electrode material” as used herein may refer to anode material or cathode material, opposite of the Electrode material, unless the context clearly indicates otherwise.

“Counter-electrode structure” as used herein may refer to an anode structure (e.g., negative electrode structure) or a cathode structure (e.g., positive electrode structure), opposite of the Electrode structure, adapted for use in a battery unless the context clearly indicates otherwise.

“Cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

“Electrochemically active material” as used herein means anodically active or cathodically active material.

“Electrode” as used herein may refer to the negative or positive electrode (anode or cathode) of a secondary battery unless the context clearly indicates otherwise.

“Electrode current collector” as used herein may refer to the negative or positive (anode or cathode) current collector of a secondary battery unless the context clearly indicates otherwise.

“Electrode material” as used herein may refer to anode material or cathode material unless the context clearly indicates otherwise.

“Electrode structure” as used herein may refer to an anode structure (e.g., negative electrode structure) or a cathode structure (e.g., positive electrode structure) adapted for use in a battery unless the context clearly indicates otherwise.

“Capacity” or “C” as used herein refers to an amount of electric charge that a battery (or a sub-portion of a battery comprising one or more pairs of electrode structures and counter-electrode structures that form a bilayer) can deliver at a pre-defined voltage unless the context clearly indicates otherwise.

“Electrolyte” as used herein refers to a non-metallic liquid, gel, or solid material in which current is carried by the movement of ions adapted for use in a battery unless the context clearly indicates otherwise.

“Charged state” as used herein in the context of the state of a secondary battery refers to a state where the secondary battery is charged to at least 75% of its rated capacity unless the context clearly indicates otherwise. For example, the battery may be charged to at least 80% of its rated capacity, at least 90% of its rated capacity, and even at least 95% of its rated capacity, such as 100% of its rated capacity.

“Discharge capacity” as used herein in connection with a negative electrode means the quantity of carrier ions available for extraction from the negative electrode and insertion into the positive electrode during a discharge operation of the battery between a predetermined set of cell end of charge and end of discharge voltage limits unless the context clearly indicates otherwise.

“Discharged state” as used herein in the context of the state of a secondary battery refers to a state where the secondary battery is discharged to less than 25% of its rated capacity unless the context clearly indicates otherwise. For example, the battery may be discharged to less than 20% of its rated capacity, such as less than 10% of its rated capacity, and even less than 5% of its rated capacity, such as 0% of its rated capacity.

“Reversible coulombic capacity” as used herein in connection with an electrode (i.e., a positive electrode, a negative electrode or an auxiliary electrode) means the total capacity of the electrode for carrier ions available for reversible exchange with a counter-electrode.

“Longitudinal axis,” “transverse axis,” and “vertical axis,” as used herein refer to mutually perpendicular axes (i.e., each are orthogonal to one another). For example, the “longitudinal axis,” “transverse axis,” and the “vertical axis” as used herein are akin to a Cartesian coordinate system used to define three-dimensional aspects or orientations. As such, the descriptions of elements of the disclosed subject matter herein are not limited to the particular axis or axes used to describe three-dimensional orientations of the elements. Alternatively stated, the axes may be interchangeable when referring to three-dimensional aspects of the disclosed subject matter.

“Composite material” or “Composite” as used herein refers to a material which comprises two or more constituent materials unless the context clearly indicates otherwise.

“Void fraction” or “Porosity” or “Void volume fraction” as used herein refers to a measurement of the voids (i.e., empty) spaces in a material, and is a fraction of the volume of voids over the total volume of the material, between 0 and 1, or as a percentage between 0% and 100%.

“Polymer” as used herein may refer to a substance or material consisting of repeating subunits of macromolecules unless the context clearly indicates otherwise.

“Microstructure” as used herein may refer to the structure of a surface of a material revealed by an optical microscope above about 25× magnification unless the context clearly indicates otherwise.

“Microporous” as used herein may refer to a material containing pores with diameters less than about 2 nanometers unless the context clearly indicates otherwise.

“Macroporous” as used herein may refer to a material containing pores with diameters greater than about 50 nanometers unless the context clearly indicates otherwise.

“Nanoscale” or “Nanoscopic scale” as used herein may refer to structures with a length scale in the range of about 1 nanometer to about 100 nanometers.

“Pre-lithiation” or “pre-lithiate” as used herein may refer to the addition of lithium to the active lithium content of a lithium based secondary battery as part of the formation process prior to battery operation to compensate for the loss of active lithium. “Pre-lithiation” or “pre-lithiate” may also be referred to herein as a “buffer process.”

“Separator,” “Separator layer,” or “Separator structure” as used herein may refer to electrically insulating but ionically permeable separator material that is adapted to electrically isolate an electrode structure and an adjacent counter-electrode structure.

“Unit cell” as used herein may refer to a subassembly of a secondary battery that includes an electrode structure, a counter-electrode structure, and a separator between the electrode structure and the counter-electrode structure.

### DETAILED DESCRIPTION

Some embodiments of the present disclosure may provide benefits such as mitigation or improvement of the poor ICE associated with silicon-based anodes in secondary batteries utilizing an auxiliary anode electrochemically coupled with the secondary battery that provides additional carrier ion during and/or subsequent to initial battery formation. The use of an auxiliary anode mitigates the initial loss of carrier ions in the secondary battery during initial formation, thereby providing a technical benefit of, for example, increasing the capacity of the secondary battery after formation. Further, the introduction of additional carrier ions after battery formation mitigates the cycle-based decrease in carrier ions that are typically lost through secondary reactions, thereby providing a technical benefit of decreasing the cycle-by-cycle capacity loss in a secondary battery. Further still, the introduction of additional carrier ions after battery formation improves the cycling performance of the secondary battery by maintaining the anode of the secondary battery at a lower potential voltage at discharge, as the anode includes additional carrier ions. In some embodiments, the auxiliary anode is removed from the secondary battery after formation, thereby providing a technical benefit of increasing the energy density of the battery.

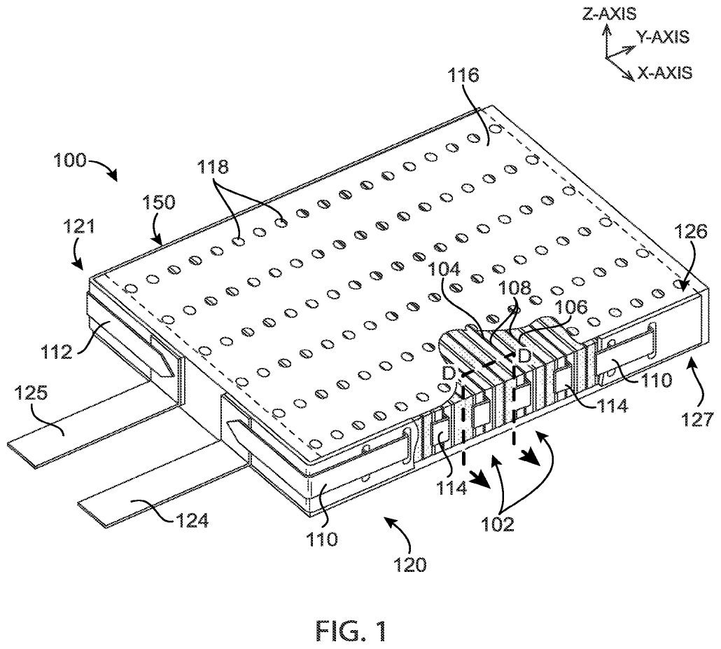

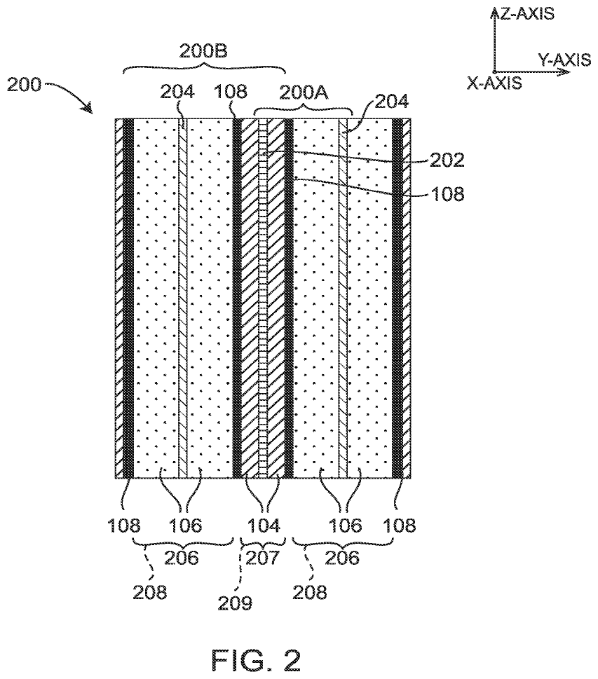

FIG. 1 is a perspective view of a secondary battery 100 of an exemplary embodiment, and FIG. 2 depicts a portion of a multilayer stack 200 used to form the secondary battery 100. The secondary battery 100 in FIG. 1 has a portion exposed showing some of the internal structures of the secondary battery, as further described below. The secondary battery 100 is also shown partially assembled in FIG. 1. When fully assembled, the second battery 100 includes a battery enclosure made of an insulating packaging material, such as a multi-layer aluminum polymer material, plastic, or the like. The battery enclosure is omitted from FIG. 1 to show an electrode assembly 150 of the secondary battery 100. The electrode assembly 150 is disposed within the battery enclosure when the secondary battery is fully assembled.

As illustrated in FIG. 1, the electrode assembly 150 includes a plurality of adjacent unit cells 102. Each of the unit cells 102 has a dimension in the X-axis, Y-axis and Z-axis, respectively. The X-axis, Y-axis and Z-axis are each mutually perpendicular, akin to a Cartesian coordinate system. As used herein, dimensions of each component of a unit cell 102 in the Z-axis may be referred to as a “height”, dimensions in the X-axis may be referred to as a “length” and dimensions in the Y-axis may be referred to as a “width.” As used herein, the term thickness and width may be used interchangeably to denote a dimension in the Y-axis direction. The secondary battery 100 defines a transverse direction in the X-axis, a longitudinal direction in the Y-axis, and a vertical direction in the Z-axis. The X-axis may also be referred to herein as a transverse axis, the Y-axis may also be referred to herein as a longitudinal axis, and the Z-axis may also be referred to herein as a vertical axis. The unit cells 102 are stacked in the longitudinal or Y-axis direction and arranged as a multilayer stack 200 (see FIG. 2).

Each of the unit cells 102 includes at least one the anodically active material layer 104 and at least one cathodically active material layer 106. The anodically active material layer 104 and the cathodically active material layer 106 of each unit cell 102 are electrically isolated by a separator layer 108, which may also be referred to as a separator 108. It should be appreciated that in suitable embodiments of the present disclosure, any number of the unit cells 102 may be used, such as from 1 to 200 or more of the unit cells 102 in the secondary battery 100.

For each of the unit cells 102, in some embodiments, the separator layer 108 is an ionically permeable polymeric woven material suitable for use as a separator in a secondary battery. In an embodiment, the separator layer 108 is coated with ceramic particles on one or both sides.

Referring to FIG. 1, the secondary battery 100 includes a first busbar 110 that is in electrical contact with the anodically active material layers 104 of each unit cell 102 and a second busbar 112 that is in electrical contact with the cathodically active material layers 106 of each unit cell 102 via electrode tabs 114. The electrode tabs 114 are only visible on a first side 120 of the secondary battery 100 in FIG. 1, although a different set of the electrode tabs 114 are present on a second side 121 of the secondary battery. The electrode tabs 114 on the first side 120 of the secondary battery 100 are electrically coupled with the first busbar 110, which may be referred to as an anode busbar. The first busbar 110 is shown with a portion cut away in FIG. 1 to show the underlying electrode tabs 114. The electrode tabs 114 on the second side 121 of the secondary battery 100 (not visible in FIG. 1) are electrically coupled to the second busbar 112, which may be referred to as a cathode busbar. Each unit cell 102 includes an electrode tab 114 on the first side 120 and an electrode tab 114 on the second side 121. The electrode tabs 114 on the second side 121 of the secondary battery may also be referred to as counter-electrode tabs 114.

In this embodiment, the first busbar 110 is electrically coupled with a first electrical terminal 124 of the secondary battery 100, which is electrically conductive. When the first busbar 110 comprises an anode busbar for the secondary battery 100, the first electrical terminal 124 comprises a negative terminal for the secondary battery. Further in this embodiment, the second busbar 112 is electrically coupled with a second electrical terminal 125 of the secondary battery 100, which is electrically conductive. When the second busbar 112 comprises a cathode busbar for the secondary battery 100, the second electrical terminal 125 comprises a positive terminal for the secondary battery.

In one embodiment, a casing 116, which may be referred to as a constraint, may be applied over one or both of the X-Y surfaces of the electrode assembly 150. In the embodiment shown in FIG. 1, the casing 116 includes a plurality of perforations 118 to facilitate distribution or flow of an electrolyte solution once the electrode assembly 150 has been fully assembled. In one embodiment, the casing 116 comprises stainless steel, such as SS301, SS316, 440C or 440C hard. In other embodiments, the casing 116 comprises aluminum (e.g., aluminum 7075-T6, hard H18, etc.), titanium (e.g., 6Al-4V), beryllium, beryllium copper (hard), copper (O₂ free, hard), nickel, other metals or metal alloys, composite, polymer, ceramic (e.g., alumina (e.g., sintered or Coorstek AD96), zirconia (e.g., Coorstek YZTP), yttriastabilizedzirconia (e.g., ENrG E-Strate®)), glass, tempered glass, polyetheretherketone (PEEK) (e.g., Aptiv 1102), PEEK with carbon (e.g., Victrex 90HMF40 or Xycomp 1000-04), polyphenylene sulfide (PPS) with carbon (e.g., Tepex Dynalite 207), polyetheretherketone (PEEK) with 30% glass, (e.g., Victrex 90HMF40 or Xycomp 1000-04), polyimide (e.g., Kapton®), E Glass Std Fabric/Epoxy, 0 deg, E Glass UD/Epoxy, 0 deg, Kevlar Std Fabric/Epoxy, 0 deg, Kevlar UD/Epoxy, 0 deg, Carbon Std Fabric/Epoxy, 0 deg, Carbon UD/Epoxy, 0 deg, Toyobo Zylon® HM Fiber/Epoxy, Kevlar 49 Aramid Fiber, S Glass Fibers, Carbon Fibers, Vectran UM LCP Fibers, Dyneema, Zylon or other suitable material.

In some embodiments, the casing 116 comprises a sheet having a thickness in the range of about 10 to about 100 micrometers. In one embodiment, the casing 116 comprises a stainless-steel sheet (e.g., SS316) having a thickness of about 30 μm. In another embodiment, the casing 116 comprises an aluminum sheet (e.g., 7075-T6) having a thickness of about 40 μm. In another embodiment, the casing 116 comprises a zirconia sheet (e.g., Coorstek YZTP) having a thickness of about 30 μm. In another embodiment, the casing 116 comprises an E Glass UD/Epoxy 0 deg sheet having a thickness of about 75 μm. In another embodiment, the casing 116 comprises 12 μm carbon fibers at >50% packing density.

The casing 116 defines a first major surface 126 and a second major surface 127 that opposes the first major surface 126. The major surfaces 126, 127 of the casing 116 may be substantially planar is some embodiments.

With reference to FIG. 2, which depicts a partial section of the secondary battery 100 taken along section line D-D in FIG. 1, the individual layers of a portion of the multilayer stack 200 included in the electrode assembly 150 are shown. The multilayer stack 200 may include one or more of the unit cells 102 (shown in FIG. 1) stacked in the longitudinal direction.

An anode current collector 202 of the multilayer stack 200 is shown in the center of the portion of the multilayer stack 200 shown in FIG. 2. The anode current collector 202 may comprise or be electrically coupled with one of the electrode tabs 114 on one of the sides 120, 121 of the secondary battery 100 (see FIG. 1). The anode current collector 202 is arranged with the anodically active material layer 104, the separator layer 108, the cathodically active material layer 106, and a cathode current collector 204 in a stacked formation in the longitudinal direction from each side of the anode current collector 202. The cathode current collector 204 may comprise or be electrically coupled with, one of the electrode tabs 114 on one of the sides 120, 121 of the secondary battery 100 that is different than the anode current collector 202.

In the example embodiment, each of the anodically active material layers 104 is a layer of anodically active material on at least one major surface of an anode current collector 202. Each of the cathodically active material layers 106 is a layer of cathodically active material on at least one major surface of a cathode current collector 204. In other embodiments, one or more of the anodically active material layers 104 and corresponding anode current collector 202 may be a single layer of suitable material. Additionally, and/or alternatively, one or more of the cathodically active material layers 106 and corresponding cathode current collector 204 may be a single layer of suitable material.

The relative placement of the anode current collector layer 202, the anodically active material layer 104, the separator 108, the cathodically active material layer 106, and the cathode current collector layer 204 in the portion of the multilayer stack 200 shown in FIG. 2 is by way of example only and varies along sections of the secondary battery 100 taken along lines other than section line D-D in FIG. 1. In another example portion of the multilayer stack 200, the placement of the cathodically active material layer 106 and the anodically active material layer 104 may be swapped, such that the cathodically active material layer(s) 106 are toward the center and the anodically active material layer(s) 104 are distal to the cathodically active material layers 106.

The multilayer stack 200 includes stacked groups of the anode current collector layer 202, the anodically active material layer 104, the separator 108, the cathodically active material layer 106, and the cathode current collector layer 204. The stacked groups of the multilayer stack 200 may also be referred to as “unit cells,” such as the unit cells 102 in FIG. 1. A unit cell may be considered to include, from left to right in stacked succession as shown in FIG. 2, the anode current collector 202, the anodically active material layer 104, the separator 108, the cathodically active material layer 106, and the cathode current collector 204. This arrangement is depicted as a unit cell 200A in FIG. 2. Additionally and/or alternatively, a unit cell may be considered to include, from left to right in stacked succession as shown in FIG. 2, the separator layer 108, a first layer of the cathodically active material layer 106, the cathode current collector 204, a second layer of the cathodically active material layer 106, the separator layer 108, a first layer of the anodically active material layer 104, the anode current collector 202, a second layer of the anodically active material layer 104, and the separator layer 108. This arrangement is depicted as a unit cell 200B in FIG. 2. The unit cells 102 in FIG. 1 may be arranged as unit cells 200A, unit cells 200B, or a combination of unit cells 200A and unit cells 200B.

In FIG. 2, a layered structure comprising cathodically active material layer(s) 106 and a cathode current collector 204 may be referred to as a cathode structure 206, while a layered structure comprising anodically active material layer(s) 104 and an anode current collector 202 may be referred to as an anode structure 207. Collectively, the population of the cathode structure 206 for the secondary battery 100 may be referred to as a positive electrode 208 of the secondary battery, and the population of the anode structures 207 for the secondary battery 100 (only one of the anode structures are shown in FIG. 2) may be referred to as the negative electrode 209 of the secondary battery.

A voltage difference V exists between adjacent cathode structures 206 and anode structures 207, with the adjacent structures considered a bilayer in some embodiments. Each bilayer has a capacity C determined by the makeup and configuration of the cathode structures 206 and the anode structures 207. In this embodiment, each bilayer produces a voltage difference of about 4.35 volts. In other embodiments, each bilayer has a voltage difference of about 0.5 volts, about 1.0 volts, about 1.5 volts, about 2.0 volts, about 2.5 volts, about 3.0 volts, about 3.5 volts, about 4.0 volts, 4.5 volts, about 5.0 volts, between 4 and 5 volts, or any other suitable voltage. During cycling between a charged state and a discharged state, the voltage may vary, for example, between about 2.5 volts and about 4.35 volts. The capacity C of a bilayer in this embodiment is about 3.5 milliampere-hour (mAh). In other embodiments, the capacity C of a bilayer is about 2 mAh, less than 5 mAh, or any other suitable capacity. In some embodiments, the capacity C of a bilayer may be up to about 10 mAh.

The cathode current collector 204 may comprise aluminum, nickel, cobalt, titanium, and tungsten, or alloys thereof, or any other material suitable for use as a cathode current collector layer. In general, the cathode current collector 204 will have an electrical conductivity of at least about 10³ Siemens/cm. For example, in one such embodiment, the cathode current collector 204 will have a conductivity of at least about 10⁴ Siemens/cm. By way of further example, in one such embodiment, the cathode current collector 204 will have a conductivity of at least about 10⁵ Siemens/cm. In general, the cathode current collector 204, may comprise a metal such as aluminum, carbon, chromium, gold, nickel, NiP, palladium, platinum, rhodium, ruthenium, an alloy of silicon and nickel, titanium, or a combination thereof (see “Current collectors for positive electrodes of lithium-based batteries” by A. H. Whitehead and M. Schreiber, Journal of the Electrochemical Society, 152(11) A2105-A2113 (2005)). By way of further example, in one embodiment, the cathode current collector 204 comprises gold or an alloy thereof such as gold silicide. By way of further example, in one embodiment, the cathode current collector 204 comprises nickel or an alloy thereof such as nickel silicide.

The cathodically active material layer 106 may be an intercalation-type chemistry active material, a conversion chemistry active material, or a combination thereof.

Exemplary conversion chemistry materials useful in the present disclosure include, but are not limited to, S (or Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5, and the like.

Exemplary cathodically active material layers 106 also include any of a wide range of intercalation-type cathodically active materials. For example, for a lithium-ion battery, the cathodically active material may comprise a cathodically active material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathodically active materials include lithium cobalt oxide (LiCoO₂), LiNi_{0.5}Mn_{1.5}O₄, Li(NiₓCo_{y}Al_{z})O₂, lithium metal phosphate (e.g., lithium iron phosphate, LiFePO₄), Li₂MnO₄, V₂O₅, molybdenum oxysulfides, phosphates, silicates, vanadates, sulfur, sulfur compounds, oxygen (air), lithium nickel manganese cobalt oxide (Li(NiₓMn_{y}Co_{z})O₂), and combinations thereof.

In general, the cathodically active material layers 106 will have a thickness of at least about 20 μm. For example, in one embodiment, the cathodically active material layers 106 will have a thickness of at least about 40 μm. By way of further example, in one such embodiment, the cathodically active material layers 106 will have a thickness of at least about 60 μm. By way of further example, in one such embodiment, the cathodically active material layers 106 will have a thickness of at least about 100 μm. Typically, the cathodically active material layers 106 will have a thickness of less than about 90 μm or less than about 70 μm.

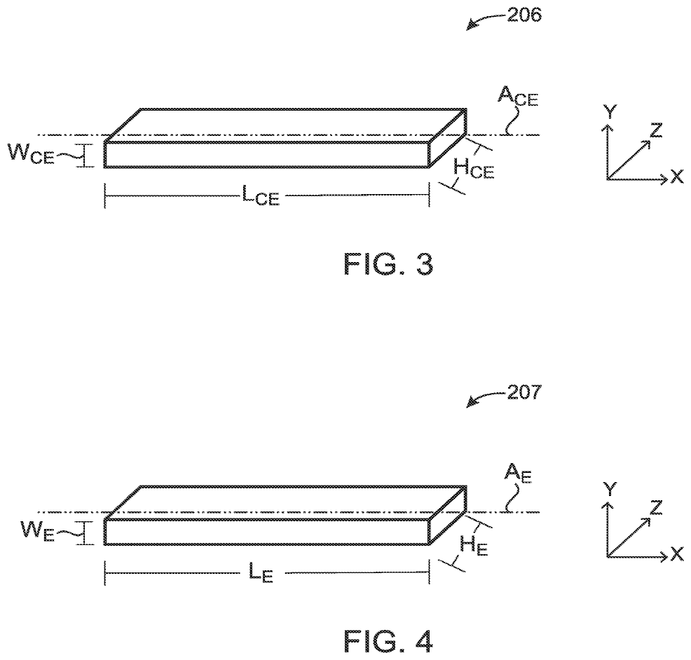

FIG. 3 depicts one of the cathode structures 206 of FIG. 2. Each cathode structure 206 has a length (L_{CE}) measured along the transverse axis (A_{CE}), a width (W_{CE}) measured along the longitudinal direction or Y-axis, and a height (H_{CE}) measured in a vertical direction that is perpendicular to each of the directions of measurement of the length L_{CE} and the width W_{CE}.

The length LCE of the cathode structures 206 will vary depending upon the secondary battery 100 and its intended use. In general, however, each cathode structure 206 will typically have a length L_{CE} in the range of about 5 millimeters (mm) to about 500 mm. For example, in one such embodiment, each cathode structure 206 has a length L_{CE} of about 10 mm to about 250 mm. By way of further example, in one such embodiment each cathode structure 206 has a length L_{CE} of about 25 mm to about 100 mm. According to one embodiment, the cathode structures 206 include one or more first electrode members having a first length, and one or more second electrode members having a second length that is different than the first length. In yet another embodiment, the different lengths for the one or more first electrode members and one or more second electrode members may be selected to accommodate a predetermined shape for an electrode assembly (e.g., the electrode assembly 150 of FIG. 1), such as an electrode assembly shape having a different lengths along one or more of the longitudinal and/or transverse axis, and/or to provide predetermined performance characteristics for the secondary battery 100 shown in FIG. 1.

The width W_{CE} of the cathode structures 206 will also vary depending upon the secondary battery 100 and its intended use. In general, however, the cathode structures 206 will typically have a width W_{CE} within the range of about 0.01 mm to 2.5 mm. For example, in one embodiment, the width W_{CE} of each cathode structure 206 will be in the range of about 0.025 mm to about 2 mm. By way of further example, in one embodiment, the width W_{CE} of each cathode structure 206 will be in the range of about 0.05 mm to about 1 mm. According to one embodiment, the cathode structures 206 include one or more first electrode members having a first width, and one or more second electrode members having a second width that is different than the first width. In yet another embodiment, the different widths for the one or more first electrode members and one or more second electrode members may be selected to accommodate a predetermined shape for the secondary battery 100, such as an assembly having a different widths along one or more of the longitudinal and/or transverse axis, and/or to provide predetermined performance characteristics for the secondary battery.

The height H_{CE} of the cathode structures 206 will also vary depending upon the secondary battery 100 and its intended use. In general, however, the cathode structures 206 will typically have a height H_{CE} within the range of about 0.05 mm to about 25 mm. For example, in one embodiment, the height H_{CE} of each cathode structure 206 will be in the range of about 0.05 mm to about 5 mm. By way of further example, in one embodiment, the height H_{CE} of each cathode structure 206 will be in the range of about 0.1 mm to about 1 mm. According to one embodiment, the cathode structures 206 include one or more first cathode members having a first height, and one or more second cathode members having a second height that is different than the first height. In yet another embodiment, the different heights for the one or more first cathode members and one or more second cathode members may be selected to accommodate a predetermined shape for the secondary battery 100, such as a shape having a different heights along one or more of the longitudinal and/or transverse axis, and/or to provide predetermined performance characteristics for the secondary battery.

In general, each cathode structure 206 has a length L_{CE} that is substantially greater than its width W_{CE} and substantially greater than its height H_{CE}. For example, in one embodiment, the ratio of L_{CE} to each of W_{CE} and H_{CE} is at least 5:1, respectively (that is, the ratio of L_{CE} to W_{CE} is at least 5:1, respectively and the ratio of L_{CE} to H_{CE} is at least 5:1, respectively), for each cathode structure 206. By way of further example, in one embodiment the ratio of L_{CE} to each of W_{CE} and H_{CE} is at least 10:1 for each cathode structure 206. By way of further example, in one embodiment, the ratio of L_{CE} to each of W_{CE} and H_{CE} is at least 15:1 for each cathode structure 206. By way of further example, in one embodiment, the ratio of L_{CE} to each of W_{CE} and H_{CE} is at least 20:1 for each cathode structure 206.

In one embodiment, the ratio of the height H_{CE} to the width W_{CE} of the cathode structures 206 is at least 0.4:1, respectively. For example, in one embodiment, the ratio of H_{CE} to W_{CE} will be at least 2:1, respectively, for each cathode structure 206. By way of further example, in one embodiment the ratio of H_{CE} to W_{CE} will be at least 10:1, respectively, for each cathode structure 206. By way of further example, in one embodiment the ratio of H_{CE} to W_{CE} will be at least 20:1, respectively, for each cathode structure 206. Typically, however, the ratio of H_{CE} to W_{CE} will generally be less than 1,000:1, respectively, for each cathode structure 206. For example, in one embodiment the ratio of H_{CE} to W_{CE} will be less than 500:1, respectively, for each cathode structure 206. By way of further example, in one embodiment the ratio of H_{CE} to W_{CE} will be less than 100:1, respectively. By way of further example, in one embodiment the ratio of H_{CE} to W_{CE} will be less than 10:1, respectively. By way of further example, in one embodiment the ratio of H_{CE} to W_{CE} will be in the range of about 2:1 to about 100:1, respectively, for each cathode structure 206.

### Anodic Type Structures and Materials

Referring again to FIG. 2, the anode current collector 202 in the multilayer stack 200 may comprise a conductive material such as copper, carbon, nickel, stainless-steel, cobalt, titanium, and tungsten, and alloys thereof, or any other material suitable as an anode current collector layer. In general, the anode current collector 202 will have an electrical conductivity of at least about 10³ Siemens/cm. For example, in one such embodiment, the anode current collector 202 will have a conductivity of at least about 10⁴ Siemens/cm. By way of further example, in one such embodiment, the anode current collector 202 will have a conductivity of at least about 10⁵ Siemens/cm.

In general, the anodically active material layers 104 in the multilayer stack 200 may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo2O4; (f) particles of graphite and carbon; (g) lithium metal; and (h) combinations thereof.

Exemplary anodically active material layers 104 include carbon materials such as graphite and soft or hard carbons, or graphene (e.g., single-walled or multi-walled carbon nanotubes), or any of a range of metals, semi-metals, alloys, oxides, nitrides and compounds capable of intercalating lithium or forming an alloy with lithium. Specific examples of the metals or semi-metals capable of constituting the anode material include graphite, tin, lead, magnesium, aluminum, boron, gallium, silicon, Si/C composites, Si/graphite blends, silicon oxide (SiOx), porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one exemplary embodiment, the anodically active material comprises aluminum, tin, or silicon, or an oxide thereof, a nitride thereof, a fluoride thereof, or other alloy thereof. In another exemplary embodiment, the anodically active material layers 104 comprise silicon or an alloy or oxide thereof.

In one embodiment, the anodically active material layers 104 are microstructured to provide a significant void volume fraction to accommodate volume expansion and contraction as lithium ions (or other carrier ions) are incorporated into or leave the anodically active material layers 104 during charging and discharging processes for the secondary battery 100. In general, the void volume fraction of (each of) the anodically active material layer 104 is at least 0.1. Typically, however, the void volume fraction of (each of) the anodically active material layer 104 is not greater than 0.8. For example, in one embodiment, the void volume fraction of (each of) the anodically active material layer 104 is about 0.15 to about 0.75. By way of the further example, in one embodiment, the void volume fraction of (each of) the anodically active material layer 104 is about 0.2 to about 0.7. By way of the further example, in one embodiment, the void volume fraction of (each of) the anodically active material layer 104 is about 0.25 to about 0.6.

Depending upon the composition of the microstructured anodically active material layers 104 and the method of their formation, the microstructured anodically active material layers may comprise macroporous, microporous, or mesoporous material layers or a combination thereof, such as a combination of microporous and mesoporous, or a combination of mesoporous and macroporous. Microporous material is typically characterized by a pore dimension of less than 10 nanometer (nm), a wall dimension of less than 10 nm, a pore depth of 1 μm to 50 μm, and a pore morphology that is generally characterized by a “spongy” and irregular appearance, walls that are not smooth, and branched pores. Mesoporous material is typically characterized by a pore dimension of 10 nm to 50 nm, a wall dimension of 10 nm to 50 nm, a pore depth of 1 μm to 100 μm, and a pore morphology that is generally characterized by branched pores that are somewhat well defined or dendritic pores. Macroporous material is typically characterized by a pore dimension of greater than 50 nm, a wall dimension of greater than 50 nm, a pore depth of 1 μm to 500 μm, and a pore morphology that may be varied, straight, branched, or dendritic, and smooth or rough-walled. Additionally, the void volume may comprise open or closed voids, or a combination thereof. In one embodiment, the void volume comprises open voids, that is, the anodically active material layers 104 contain voids having openings at the lateral surface of the anodically active material layers through which lithium ions (or other carrier ions) can enter or leave. For example, lithium ions may enter the anodically active material layers 104 through the void openings after leaving the cathodically active material layers 106. In another embodiment, the void volume comprises closed voids, that is, the anodically active material layers 104 contain voids that are enclosed. In general, open voids can provide greater interfacial surface area for the carrier ions whereas closed voids tend to be less susceptible to SEI formation, while each provides room for the expansion of anodically active material layers 104 upon the entry of carrier ions. In certain embodiments, therefore, it is preferred that the anodically active material layers comprise a combination of open and closed voids.

In one embodiment, the anodically active material layers 104 comprise porous aluminum, tin or silicon or an alloy, an oxide, or a nitride thereof. Porous silicon layers may be formed, for example, by anodization, by etching (e.g., by depositing precious metals such as gold, platinum, silver or gold/palladium on the surface of single crystal silicon and etching the surface with a mixture of hydrofluoric acid and hydrogen peroxide), or by other methods known in the art such as patterned chemical etching. Additionally, the porous anodically active material layers 104 will generally have a porosity fraction of at least about 0.1, but less than 0.8 and have a thickness of about 1 μm to about 100 μm. For example, in one embodiment, the anodically active material layers 104 comprise porous silicon, have a thickness of about 5 μm to about 100 μm, and have a porosity fraction of about 0.15 to about 0.75. By way of further example, in one embodiment, the anodically active material layers 104 comprise porous silicon, have a thickness of about 10 μm to about 80 μm, and have a porosity fraction of about 0.15 to about 0.7. By way of further example, in one such embodiment, the anodically active material layers 104 comprise porous silicon, have a thickness of about 20 μm to about 50 μm, and have a porosity fraction of about 0.25 to about 0.6. By way of further example, in one embodiment, the anodically active material layers 104 comprise a porous silicon alloy (such as nickel silicide), have a thickness of about 5 μm to about 100 μm, and have a porosity fraction of about 0.15 to about 0.75.

In another embodiment, the anodically active material layers 104 comprise fibers of aluminum, tin, or silicon, or an alloy thereof. Individual fibers may have a diameter (thickness dimension) of about 5 nm to about 10,000 nm and a length generally corresponding to the thickness of the anodically active material layers 104. Fibers (nanowires) of silicon may be formed, for example, by chemical vapor deposition or other techniques known in the art such as vapor liquid solid (VLS) growth and solid liquid solid (SLS) growth. Additionally, the anodically active material layers 104 will generally have a porosity fraction of at least about 0.1, but less than 0.8 and have a thickness of about 1 μm to about 200 μm. For example, in one embodiment, the anodically active material layers 104 comprise silicon nanowires, have a thickness of about 5 μm to about 100 μm, and a porosity fraction of about 0.15 to about 0.75. By way of further example, in one embodiment, the anodically active material layers 104 comprise silicon nanowires, have a thickness of about 10 μm to about 80 μm, and a porosity fraction of about 0.15 to about 0.7. By way of further example, in one such embodiment, the anodically active material layers 104 comprise silicon nanowires, have a thickness of about 20 μm to about 50 μm, and a porosity fraction of about 0.25 to about 0.6. By way of further example, in one embodiment, the anodically active material layers 104 comprise nanowires of a silicon alloy (such as nickel silicide), have a thickness of about 5 μm to about 100 μm, and a porosity fraction of about 0.15 to about 0.75.

In yet other embodiments, the anodically active material layers 104 are coated with a particulate lithium material selected from the group consisting of stabilized lithium metal particles, e.g., lithium carbonate-stabilized lithium metal powder, lithium silicate stabilized lithium metal powder, or other source of stabilized lithium metal powder or ink. The particulate lithium material may be applied on the anodically active material layers 104 by spraying, loading, or otherwise disposing the lithium particulate material onto the anodically active material layers at a loading amount of about 0.05 mg/cm² to 5 mg/cm², e.g., about 0.1 mg/cm² to 4 mg/cm², or even about 0.5 mg/cm² to 3 mg/cm². The average particle size (D₅₀) of the lithium particulate material may be 5 μm to 200 μm, e.g., about 10 μm to 100 μm, 20 μm to 80 μm, or even about 30 μm to 50 μm. The average particle size (D₅₀) may be defined as a particle size corresponding to 50% in a cumulative volume-based particle size distribution curve. The average particle size (D₅₀) may be measured, for example, using a laser diffraction method.

In one embodiment, the anode current collector 202 has an electrical conductance that is substantially greater than the electrical conductance of its associated the anodically active material layers 104. For example, in one embodiment the ratio of the electrical conductance of the anode current collector 202 to the electrical conductance of the anodically active material layers 104 is at least 100:1 when there is an applied current to store energy in the secondary battery 100 or an applied load to discharge the secondary battery. By way of further example, in some embodiments the ratio of the electrical conductance of the anode current collector 202 to the electrical conductance of the anodically active material layers 104 is at least 500:1 when there is an applied current to store energy in the secondary battery 100 or an applied load to discharge the secondary battery. By way of further example, in some embodiments the ratio of the electrical conductance of the anode current collector 202 to the electrical conductance of the anodically active material layers 104 is at least 1000:1 when there is an applied current to store energy in the secondary battery 100 or an applied load to discharge the secondary battery. By way of further example, in some embodiments the ratio of the electrical conductance of the anode current collector 202 to the electrical conductance of the anodically active material layers 104 is at least 5000:1 when there is an applied current to store energy in the secondary battery 100 or an applied load to discharge the secondary battery. By way of further example, in some embodiments, the ratio of the electrical conductance of the anode current collector 202 to the electrical conductance of the anodically active material layers 104 is at least 10,000:1 when there is an applied current to store energy in the secondary battery 100 or an applied load to discharge the secondary battery.

FIG. 4 depicts one of the anode structures 207 of FIG. 2 of an exemplary embodiment. Each anode structure 207 has a length (L_{E}) measured along a transverse axis (A_{E}), a width (W_{E}) measured along the longitudinal direction or Y-axis, and a height (H_{E}) measured in a vertical direction that is orthogonal to each of the directions of measurement of the length L_{E} and the width W_{E}.

The length L_{E} of the anode structures 207 will vary depending upon the secondary battery 100 and its intended use. In general, however, the anode structures 207 will typically have a length L_{E} in the range of about 5 millimeters (mm) to about 500 mm. For example, in one such embodiment, the anode structures 207 have a length L_{E} of about 10 mm to about 250 mm. By way of further example, in one such embodiment, the anode structures 207 have a length L_{E} of about 25 mm to about 100 mm. According to one embodiment, the anode structures 207 include one or more first electrode members having a first length, and one or more second electrode members having a second length that is different than the first length. In yet another embodiment, the different lengths for the one or more first electrode members and the one or more second electrode members may be selected to accommodate a predetermined shape for the secondary battery 100, such as a shape having a different lengths along one or more of the longitudinal and/or transverse axis, and/or to provide predetermined performance characteristics for the secondary battery 100.

The width W_{E} of the anode structures 207 will also vary depending upon the secondary battery 100 and its intended use. In general, however, each anode structure 207 will typically have a width W_{E} within the range of about 0.01 mm to 2.5 mm. For example, in one embodiment, the width W_{E} of each anode structure 207 will be in the range of about 0.025 mm to about 2 mm. By way of further example, in one embodiment, the width W_{E} of each anode structure 207 will be in the range of about 0.05 mm to about 1 mm. According to one embodiment, the anode structures 207 include one or more first electrode members having a first width, and one or more second electrode members having a second width that is different than the first width. In yet another embodiment, the different widths for the one or more first electrode members and one or more second electrode members may be selected to accommodate a predetermined shape for the secondary battery 100, such as a shape having a different widths along one or more of the longitudinal and/or transverse axis, and/or to provide predetermined performance characteristics for the secondary battery 100.

The height H_{E} of the anode structures 207 will also vary depending upon the secondary battery 100 and its intended use. In general, however, the anode structures 207 will typically have a height H_{E} within the range of about 0.05 mm to about 25 mm. For example, in one embodiment, the height H_{E} of each anode structure 207 will be in the range of about 0.05 mm to about 5 mm. By way of further example, in one embodiment, the height H_{E} of each anode structure 207 will be in the range of about 0.1 mm to about 1 mm. According to one embodiment, the anode structures 207 include one or more first electrode members having a first height, and one or more second electrode members having a second height that is different than the first height. In yet another embodiment, the different heights for the one or more first electrode members and one or more second electrode members may be selected to accommodate a predetermined shape for the secondary battery 100, such as a shape having a different heights along one or more of the longitudinal and/or transverse axis, and/or to provide predetermined performance characteristics for the secondary battery.

In general, each anode structure 207 has a length L_{E} that is substantially greater than each of its width W_{E} and its height H_{E}. For example, in one embodiment, the ratio of L_{E} to each of W_{E} and H_{E} is at least 5:1, respectively (that is, the ratio of L_{E} to W_{E} is at least 5:1, respectively and the ratio of L_{E} to H_{E} is at least 5:1, respectively), for each anode structure 207. By way of further example, in one embodiment the ratio of L_{E} to each of W_{E} and H_{E} is at least 10:1. By way of further example, in one embodiment, the ratio of L_{E} to each of W_{E} and H_{E} is at least 15:1. By way of further example, in one embodiment, the ratio of L_{E} to each of W_{E} and H_{E} is at least 20:1, for each anode structure 207.

In one embodiment, the ratio of the height H_{E} to the width W_{E} of the anode structures 207 is at least 0.4:1, respectively. For example, in one embodiment, the ratio of H_{E} to W_{E} will be at least 2:1, respectively, for each anode structure 207. By way of further example, in one embodiment the ratio of H_{E} to W_{E} will be at least 10:1, respectively. By way of further example, in one embodiment the ratio of H_{E} to W_{E} will be at least 20:1, respectively. Typically, however, the ratio of H_{E} to W_{E} will generally be less than 1,000:1, respectively. For example, in one embodiment the ratio of H_{E} to W_{E} will be less than 500:1, respectively. By way of further example, in one embodiment the ratio of H_{E} to W_{E} will be less than 100:1, respectively. By way of further example, in one embodiment the ratio of H_{E} to W_{E} will be less than 10:1, respectively. By way of further example, in one embodiment the ratio of H_{E} to W_{E} will be in the range of about 2:1 to about 100:1, respectively, for each anode structure 207.

### Separator Structures, Separator Materials, and Electrolytes

Referring again to FIG. 2, the separator layer(s) 108 separate the cathode structures 206 from the anode structures 207. The separator layers 108 are made of electrically insulating but ionically permeable separator material. The separator layers 108 are adapted to electrically isolate adjacent pairs of a member of the plurality of the cathode structures 206 and a member of the plurality of the anode structures 207. Each separator layer 108 will typically include a microporous separator material that can be permeated with a non-aqueous electrolyte; for example, in one embodiment, the microporous separator material includes pores having a diameter of at least 50 Angstroms (Å), more typically in the range of about 2,500 Å, and a porosity in the range of about 25% to about 75%, more typically in the range of about 35% to 55%

In general, the separator layers 108 will each have a thickness of at least about 4 μm. For example, in one embodiment, the separator layers 108 will have a thickness of at least about 8 μm. By way of further example, in one such embodiment the separator layers 108 will have a thickness of at least about 12 μm. By way of further example, in one such embodiment the separator layers 108 will have a thickness of at least about 15 μm. In some embodiments, the separator layers 108 will have a thickness of up to 25 μm, up to 50 μm, or any other suitable thickness. Typically, however, the separator layers 108 will have a thickness of less than about 12 μm or less than about 10 μm.

In general, the material of the separator layers 108 may be selected from a wide range of material having the capacity to conduct carrier ions between the anodically active material layers 104 and the cathodically active material layers 106 of the multilayer stack 200. For example, the separator layers 108 may comprise a microporous separator material that may be permeated with a liquid, non-aqueous electrolyte. Alternatively, the separator layers 108 may comprise a gel or solid electrolyte capable of conducting carrier ions between the anodically active material layers 104 and the cathodically active material layers 106 of the multilayer stack 200.

In one embodiment, the separator layers 108 may comprise a polymer-based electrolyte. Exemplary polymer electrolytes include PEO-based polymer electrolytes and polymer-ceramic composite electrolytes.

In another embodiment, the separator layers 108 may comprise an oxide-based electrolyte. Exemplary oxide-based electrolytes include lithium lanthanum titanate (Li_{0.34}La_{0.56}TiO₃), Al-doped lithium lanthanum zirconate (Li_{6.24}La₃Zr₂Al_{0.24}O_{11.98}), Ta-doped lithium lanthanum zirconate (Li_{6.4}La₃Zr_{1.4}Ta_{0.6}O₁₂), and lithium aluminum titanium phosphate (Li_{1.4}Al_{0.4}Ti_{1.6}(PO₄)₃).

In another embodiment, the separator layers 108 may comprise a solid electrolyte. Exemplary solid electrolytes include sulfide-based electrolytes such as lithium tin phosphorus sulfide (Li₁₀SnP₂S₁₂), lithium phosphorus sulfide (β-Li₃PS₄), and lithium phosphorus sulfur chloride iodide (Li₆PS₅Cl_{0.9}I_{0.1}).

In some embodiments, the separator layers 108 may comprise a solid-state lithium ion conducting ceramic, such as a lithium-stuffed garnet.

In one embodiment, the separator layers 108 comprise a microporous separator material comprising a particulate material and a binder, with the microporous separator material having a porosity (void fraction) of at least about 20 vol. %. The pores of the microporous separator material will have a diameter of at least 50 Å and will typically fall within the range of about 250 Å to about 2,500 Å. The microporous separator material will typically have a porosity of less than about 75%. In one embodiment, the microporous separator material has a porosity (void fraction) of at least about 25 vol %. In one embodiment, the microporous separator material will have a porosity of about 35-55%.

The binder for the microporous separator material may be selected from a wide range of inorganic or polymeric materials. For example, in one embodiment, the binder is an organic material selected from the group consisting of silicates, phosphates, aluminates, aluminosilicates, and hydroxides such as magnesium hydroxide, calcium hydroxide, etc. For example, in one embodiment, the binder is a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, and polyethylene oxide. In another embodiment, the binder is selected from the group consisting of acrylates, styrenes, epoxies, and silicones. In another embodiment, the binder is a copolymer or blend of two or more of the aforementioned polymers.

The particulate material comprised by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10⁻⁴ S/cm. By way of further example, in one embodiment, the particulate material has a conductivity for carrier ions of less than 1×10⁻⁵ S/cm. By way of further example, in one embodiment, the particulate material has a conductivity for carrier ions of less than 1×10⁻⁶ Siemens/cm (S/cm). Exemplary particulate materials include particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO₂, SiO₂, Al₂O₃, GeO₂, B₂O₃, Bi₂O₃, BaO, ZnO, ZrO₂, BN, Si₃N₄, and Ge3N4. See, for example, P. Arora and J. Zhang, “Battery Separators” Chemical Reviews 2004, 104, 4419-4462). In one embodiment, the particulate material will have an average particle size of about 20 nm to 2 μm, more typically 200 nm to 1.5 μm. In one embodiment, the particulate material will have an average particle size of about 500 nm to 1 μm.

In an alternative embodiment, the particulate material comprised by the microporous separator material may be bound by techniques such as sintering, binding, curing, etc. while maintaining the void fraction desired for electrolyte ingress to provide the ionic conductivity for the functioning of the battery.

In the secondary battery 100 (see FIG. 1), the microporous separator material of the separator layers 108 are permeated with a non-aqueous electrolyte suitable for use as a secondary battery electrolyte. Typically, the non-aqueous electrolyte comprises a lithium salt and/or mixture of salts dissolved in an organic solvent and/or solvent mixture. Exemplary lithium salts include inorganic lithium salts such as LiClO₄, LiBF₄, LiPF₆, LiAsF₆, LiCl, and LiBr; and organic lithium salts such as LiB(C₆H₅)₄, LiN (SO₂CF₃)₂, LiN(SO₂CF₃)₃, LiNSO₂CF₃, LINSO₂CF₅, LiNSO₂C₄F₉, LiNSO₂C₅F₁₁, LiNSO₂C₆F₁₃, and LiNSO₂C₇F₁₅. Exemplary organic solvents to dissolve the lithium salt include cyclic esters, chain esters, cyclic ethers, and chain ethers. Specific examples of the cyclic esters include propylene carbonate, butylene carbonate, γ-butyrolactone, vinylene carbonate, 2-methyl-65 -butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

### Additional Embodiments of the Present Disclosure

When a secondary battery is assembled, the amount of carrier ions available for cycling between the anode and the cathode is often initially provided in the cathode, because cathodically active materials, such as lithium cobalt oxide, are relatively stable in ambient air (e.g., they resist oxidation) compared to lithiated anode materials, such as lithiated graphite. When a secondary battery is charged for the first time, the carrier ions are extracted from the cathode and introduced into the anode. As a result, the anode potential is lowered significantly (toward the potential of the carrier ions), and the cathode potential is increased (to become even more positive). These changes in potential may give rise to parasitic reactions on both the cathode and the anode, but sometimes more severely on the anode. For example, a decomposition product comprising lithium (or other carrier ions) and electrolyte components, known as solid electrolyte interphase (SEI), may readily form on the surfaces of carbon anodes. These surfaces or covering layers are carrier ion conductors, which establish an ionic connection between the anode and the electrolyte and prevent the reactions from proceeding any further.

Although formation of the SEI layer is desired for the stability of a half-cell system comprising the anode and the electrolyte, a portion of the carrier ions introduced into the cells via the cathode is irreversibly bound and thus removed from cyclic operation, i.e., from the capacity available to the user. As a result, during the initial discharge, fewer carrier ions are returned to the cathode from the anode than was initially provided by the cathode during the initial charging operation, leading to irreversible capacity loss. During each subsequent charge and discharge cycle, the capacity losses resulting from mechanical and/or electrical degradation to the anode and/or the cathode tend to be much less per cycle, but even the relatively small carrier ion losses per cycle contribute significantly to reductions in energy density and cycle life as the battery ages. In addition, chemical and electrochemical degradation may also occur on the electrodes and cause capacity losses. To compensate for the formation of SEI (or another carrier ion-consuming mechanism such as mechanical and/or electrical degradation of the negative electrode), additional or supplementary carrier ions may be provided from an auxiliary electrode after formation of the battery.

In general, the positive electrode 208 of the secondary battery 100 (e.g., the collective population of the cathode structures 206 in the secondary battery 100) preferably has a reversible coulombic capacity that is matched to the discharge capacity of the negative electrode 209 (e.g., the collective population of the anode structures 207 in the secondary battery 100). Stated differently, the positive electrode 208 of the secondary battery 100 is sized to have a reversible coulombic capacity that corresponds to the discharge capacity of the negative electrode 209 which, in turn, is a function of the negative electrode 209 end of discharge voltage.

In some embodiments, the negative electrode 209 of the secondary battery 100 (e.g., the collective population of the anode structures 207 in the secondary battery 100) is designed to have a reversible coulombic capacity that exceeds the reversible coulombic capacity of the positive electrode 208. For example, in one embodiment a ratio of the reversible coulombic capacity of the negative electrode 209 to the reversible coulombic capacity of the positive electrode 208 is at least 1.2:1, respectively. By way of further example, in one embodiment a ratio of the reversible coulombic capacity of the negative electrode 209 to the reversible coulombic capacity of the positive electrode 208 is at least 1.3:1, respectively. By way of further example, in one embodiment a ratio of the reversible coulombic capacity of the negative electrode 209 to the reversible coulombic capacity of the positive electrode 208 is at least 2:1, respectively. By way of further example, in one embodiment a ratio of the reversible coulombic capacity of the negative electrode 209 to the reversible coulombic capacity of the positive electrode 208 is at least 3:1, respectively. By way of further example, a ratio of the reversible coulombic capacity of the negative electrode 209 to the reversible coulombic capacity of the positive electrode 208 is at least 4:1, respectively. By way of further example, a ratio of the reversible coulombic capacity of the negative electrode 209 to the reversible coulombic capacity of the positive electrode 208 is at least 5:1, respectively. Advantageously, the excess coulombic capacity of the negative electrode 209 provides a source of anodically active material to allow the secondary battery 100 to reversibly operate within a specified voltage that inhibits formation of crystalline phases (incorporating carrier ions) on the negative electrode 209 that reduce cycle-life of the negative electrode 209 as result of cycling.

As previously noted, the formation of SEI during the initial charge/discharge cycle reduces the amount of carrier ions available for reversible cycling. Mechanical and/or electrical degradation of the negative electrode 209 during cycling of the secondary battery 100 may further reduce the amount of carrier ions available for reversible cycling. To compensate for the formation of SEI (or another carrier ion-consuming mechanism such as mechanical and/or electrical degradation of the negative electrode), therefore, additional or supplementary carrier ions may be provided from an auxiliary electrode after formation of the secondary battery 100. In the embodiments of the present disclosure, the auxiliary electrode is used to electrochemically transfer additional carrier ions to the positive electrode 208 and/or the negative electrode 209 of the secondary battery 100 during and/or after formation. In one embodiment, the auxiliary electrode is removed after transferring the additional carrier ions to the secondary battery 100 in order to improve the energy density of the secondary battery in its final form.

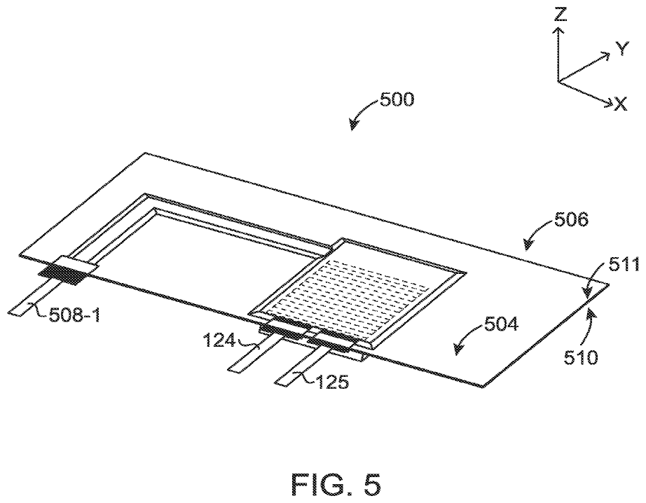

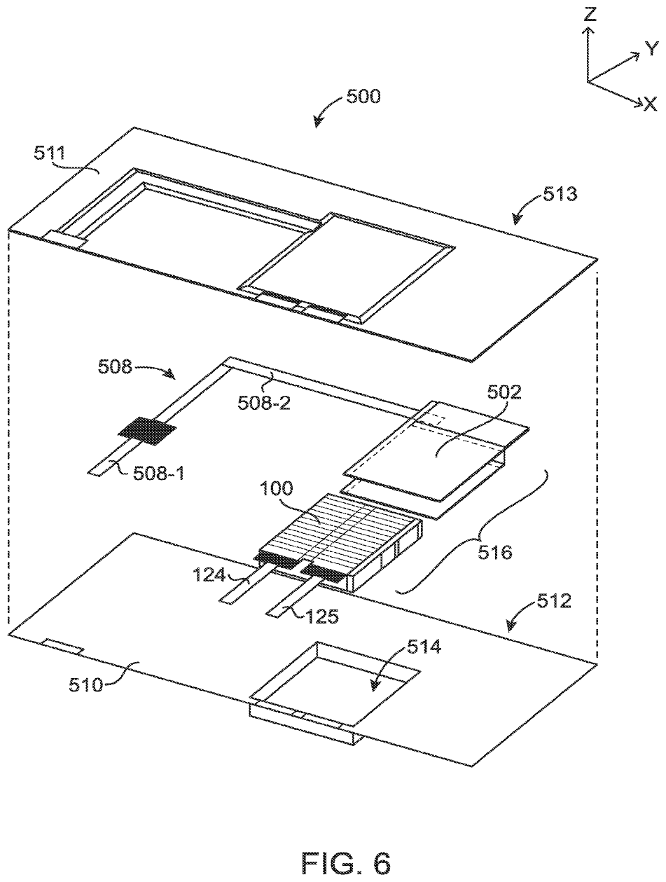

FIG. 5 is a perspective view of a buffer system 500 of an exemplary embodiment, and FIG. 6 is an exploded view of the buffer system 500. Generally, the buffer system 500 may be temporarily assembled during or after initial formation of the secondary battery 100. The buffer system 500 is used to introduce additional carrier ions into the positive electrode 208 and/or the negative electrode 209 of the secondary battery 100 using an auxiliary electrode 502 (see FIG. 6). In this embodiment, the buffer system 500 includes an enclosure 504 that encapsulates the auxiliary electrode 502 (see FIG. 6) and the secondary battery 100 within a perimeter 506 of the enclosure 504. In FIG. 5, the electrical terminals 124, 125 of the secondary battery 100 and a segment of a conductive tab 508-1 extend from the perimeter 506 of the enclosure 504, providing electrical connections to the auxiliary electrode 502 and the secondary battery 100. In this embodiment, the enclosure 504 comprises a first enclosure layer 510 and a second enclosure layer 511 that are joined together to form the enclosure 504.

Referring to FIG. 6, the first enclosure layer 510 has a perimeter 512 and the second enclosure layer 511 has a perimeter 513. Each of the enclosure layers 510, 511 may comprise a flexible or semi-flexible material, such as aluminum, polymer, a thin film flexible metal, or the like. In one embodiment, one or more of the enclosure layers 510, 511 comprises a multi-layer aluminum polymer material, plastic, or the like. In another embodiment, one or more of the enclosure layers 510, 511 comprises a polymer material laminated on a metal substrate, such as aluminum. In one embodiment, the first enclosure layer 510 includes a pouch 514 (e.g., an indentation) that is sized and shaped to match the outer surface size and shape of the secondary battery 100.

The auxiliary electrode 502 partially surrounds the secondary battery 100 in the buffer system 500, and contains a source of carrier ions to replenish the lost energy capacity of the secondary battery 100 after formation (i.e., to compensate for the loss of carrier ions upon the formation of SEI and other carrier ion losses in the first charge and/or discharge cycle of the secondary battery 100). In embodiments, the auxiliary electrode 502 may comprise a foil of the carrier ions in metallic form (e.g., a foil of lithium, magnesium, or aluminum), or any of the previously mentioned materials used for the cathodically active material layers 106 and/or the anodically active material layers 104 (see FIG. 2) in their carrier-ion containing form. For example, the auxiliary electrode 502 may comprise lithiated silicon or a lithiated silicon alloy. When the buffer system 500 is assembled, the combination of the auxiliary electrode 502 and the secondary battery 100, which may be referred to as an auxiliary subassembly 516 (see FIG. 6), are inserted into the pouch 514, and the enclosure layers 510, 511 are sealed together to form the buffer system 500 as depicted in FIG. 5. The specific details of the assembly process for the buffer system 500 and how the buffer system is used during a carrier ion transfer process to the secondary battery 100 will be discussed in more detail below. The auxiliary electrode 502 in this embodiment includes an electrically conductive tab 508, which may be segmented into a conductive tab 508-2 that is partially covered by the enclosure 504 and extends outward from the enclosure, and a conductive tab 508-1 that extends outward from the conductive tab 508-2, as depicted in FIG. 5, for example, for ease of manufacturing.

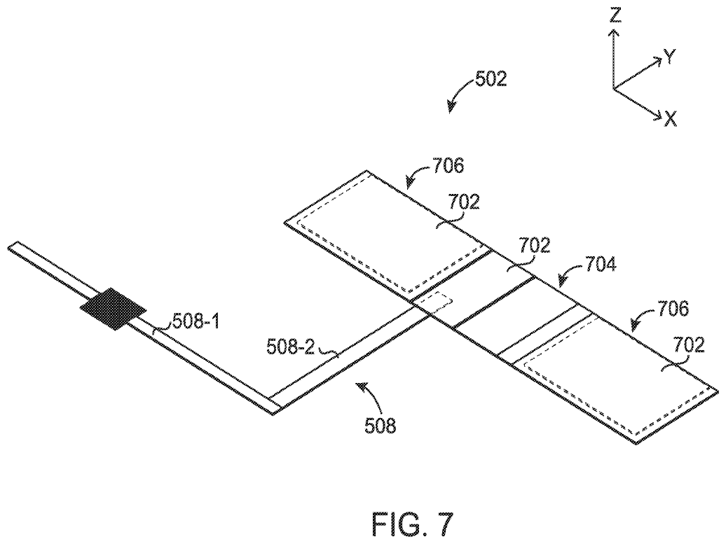

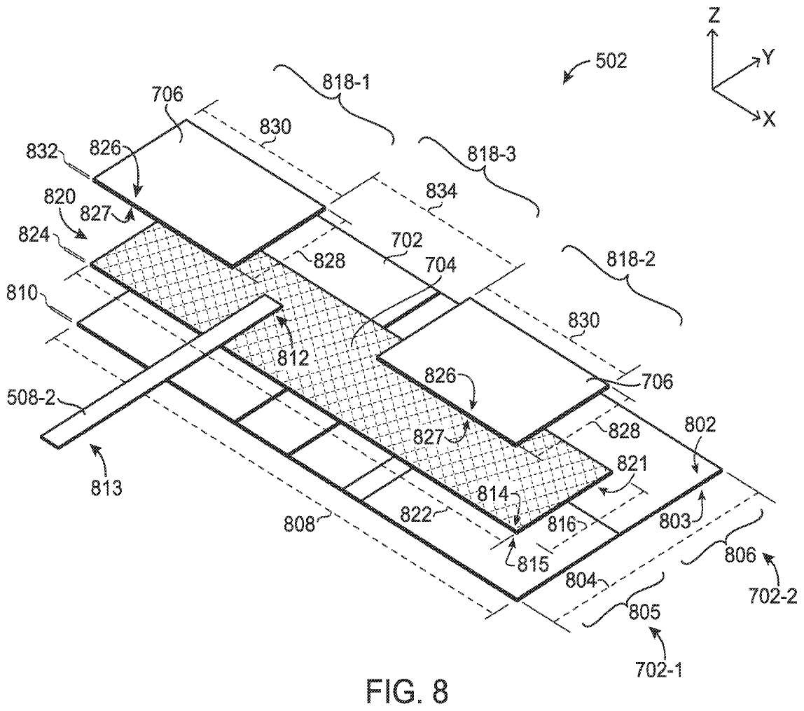

FIG. 7 is a perspective view of the auxiliary electrode 502 of an exemplary embodiment, and FIG. 8 is an exploded view of the auxiliary electrode. Referring to FIG. 7, the auxiliary electrode 502 generally includes a separator 702, which covers a conductive layer 704 and carrier ion supply layers 706. When the auxiliary electrode 502 is formed into the shape depicted in FIG. 6, the carrier ion supply layers 706 are located proximate to major surfaces 126, 127 of the secondary battery 100 (see FIG. 1), with the separator 702 insulating the casing 116 of the secondary battery 100 from the conductive layer 704 and the carrier ion supply layers 706. The separator 702 includes an electrolyte, which facilitates the transfer of carrier ions from the carrier ion supply layers 706 to the secondary battery 100 during a buffer process.

Referring to FIG. 8, the auxiliary electrode 502 includes, from bottom to top in FIG. 8, the separator 702, the conductive layer 704, and the population of carrier ion supply layers 706. The auxiliary electrode 502 in this embodiment further includes the conductive tab 508-2, which is electrically conductive and electrically coupled with the conductive layer 704. The conductive tab 508-2 provides an electrical connection with the auxiliary electrode 502. Generally, the auxiliary electrode 502 is used during the buffer process to transfer carrier ions from the carrier ion supply layers 706 to the positive electrode 208 and/or the negative electrode 209 of the secondary battery 100 during or after formation of the secondary battery 100.

The separator 702 may comprise any of the materials previously described with respect to the separator layer 108 of the secondary battery 100. The separator 702 may be permeated with an electrolyte that serves as a medium to conduct carrier ions from the carrier ion supply layers 706 to the positive electrode 208 of the secondary battery 100 and/or the negative electrode 209 of the secondary battery. The electrolyte may comprise any of the materials previously described with respect to the secondary battery 100.

The separator 702 in this embodiment includes a first surface 802 and a second surface 803 that opposes the first surface 802. The surfaces 802, 803 of the separator 702 form major surfaces for the separator 702 and are disposed in the X-Y plane in FIG. 8. The separator 702 in this embodiment has a width 804 that extends in a direction of the Y-axis. The separator 702 in this embodiment is segmented in the width 804 into a first portion 805 and a second portion 806. In some embodiments, the separator 702 may comprise a first separator layer 702-1 corresponding to the first portion 805 and a second separator layer 702-2 corresponding to the second portion 806.

In one embodiment, the width 804 of the separator 702 is about 34 mm. In other embodiments, the width 804 of the separator is about 30 mm, about 35 mm, or another suitable value. In some embodiments, the width 804 of the separator 702 lies in a range of values of about 10 mm to about 200 mm, or some other suitable range that allows the separator to function as described herein.

The separator 702, in one embodiment, has a length 808 that extends in a direction of the X-axis. In an embodiment, the length 808 of the separator 702 is about 72 mm. In other embodiments, the length 808 of the separator 702 is about 65 mm, about 70 mm, about 75 mm, or some other suitable value that allows the separator to function as described herein. In some embodiments, the length 808 of the separator 702 lies in a range of values of about 30 mm to about 200 mm, or some other suitable range of values that allows the separator to function as described herein.

In one embodiment, the separator 702 has a thickness 810 that extends in the direction of the Z-axis. Generally, the thickness 810 is a distance from the first surface 802 of the separator 702 to (and including) the second surface 803 of the separator. In one embodiment, the thickness 810 of the separator 702 is about 0.025 mm. In other embodiments, the thickness 810 of the separator 702 is about 0.015 mm, about 0.02 mm, about 0.03 mm, about 0.035 mm, or some other suitable value. In some embodiments, the thickness 810 of the separator 702 lies in a range of values of about 0.01 mm to about 1.0 mm, or some other suitable range of values that allows the separator to function as described herein.

The conductive layer 704 is electrically conductive, and may comprise a metal, a metalized film, an insulating base material with a conductive material applied thereto, or some other type of electrically conductive material. In some embodiments, the conductive layer 704 comprises copper. In other embodiments, the conductive layer 704 comprises aluminum or another metal. In this embodiment, the conductive layer 704 is electrically coupled with the conductive tab 508-2, which is also electrically conductive. The conductive tab 508-2 has a first end 812 disposed proximate to the conductive layer 704 and a second end 813 disposed distal to the conductive layer 704 that opposes the first end 812. The first end 812 of the conductive tab 508-2 is electrically coupled to the conductive layer 704. In some embodiments, the first end 812 of the conductive tab 508-2 is spot-welded to the conductive layer 704. In other embodiments, the first end 812 of the conductive tab 508-2 is soldered to the conductive layer 704. Generally, the conductive tab 508-2 may be affixed at the first end 812 to the conductive layer 704 using any suitable means that ensure a mechanical connection and an electrical connection to the conductive layer. The conductive tab 508-2 may comprise any type of electrically conductive material as desired. In one embodiment, the conductive tab 508-2 comprises a metal. In these embodiments, the conductive tab 508-2 may comprise nickel, copper, aluminum, or other suitable metals or metal alloys that allows the conductive tab 508-2 to function as described herein.

The conductive layer 704 in this embodiment includes a first surface 814 and a second surface 815 that opposes the first surface 814. The surfaces 814, 815 of the conductive layer 704 form major surfaces for the conductive layer and are disposed in the X-Y plane in FIG. 8. The conductive layer 704 in this embodiment has a width 816 that extends in a direction of the Y-axis. In an embodiment, the width 816 of the conductive layer 704 is about 15 mm. In other embodiments, the width 816 of the conductive layer 704 is about 10 mm, about 20 mm, or some other suitable value that allows the conductive layer to function as described herein.

In some embodiments, the width 816 of the conductive layer 704 lies in a range of values of about 5 mm to about 100 mm, or some other suitable range of values that allows the conductive layer to function as described herein. The first surface 814 of the conductive layer 704 in this embodiment is segmented into a first region 818-1, disposed proximate to a first end 820 of the conductive layer 704, a second region 818-2, disposed proximate to a second end 821 of the conductive layer 704, and a third region 818-3 disposed between the first region 818-1 and the second region 818-2.

The conductive layer 704 has a length 822 that extends in a direction of the X-axis. In one embodiment, the length 822 of the conductive layer 704 is about 70 mm. In other embodiments, the length 822 of the conductive layer 704 is about 60 mm, about 65 mm, about 75 mm, or some other suitable value that allows the conductive layer 704 to function as described herein. In some embodiments, the length 822 of the conductive layer 704 lies in a range of values of about 30 mm to about 200 mm, or some other suitable range of values that allows the conductive layer to function as described herein.

The conductive layer 704 has a thickness 824 that extends in a direction of the Z-axis. Generally, the thickness 824 is a distance from the first surface 814 of the conductive layer 704 to (and including) the second surface 815 of the conductive layer 704. In one embodiment, the thickness 824 of the conductive layer 704 is about 0.1 mm. In other embodiments, the thickness 824 of the conductive layer 704 is about 0.005 mm, about 0.15 mm, or about 0.2 mm. In some embodiments, the thickness 824 of the conductive layer 704 lies in a range of values of about 0.01 mm to about 1.0 mm, or any other suitable range for the thickness that allows the conductive layer to function as described herein.

The carrier ion supply layers 706, which comprise a population of carrier ion supply layers in an embodiment, comprise any carrier ion containing material previously described that may be utilized to supply carrier ions to the positive electrode 208 and/or the negative electrode 209 of the secondary battery 100. The carrier ion supply layers 706 may comprise one or more sources of lithium ions, sodium ions, potassium ions, calcium ions, magnesium ions, and aluminum ions. In this embodiment, the carrier ion supply layers 706 are disposed within the first region 818-1 and the second region 818-2 of the conductive layer 704. In some embodiments, the carrier ion supply layers 706 are also disposed in the third region 818-3 of the conductive layer 704.

The carrier ion supply layers 706 in this embodiment include a first surface 826 and a second surface 827 that opposes the first surface 826. The surfaces 826, 827 of the carrier ion supply layers 706 form major surfaces for the carrier ion supply layers and are disposed in the X-Y plane in FIG. 8. The carrier ion supply layers 706 in this embodiment have a width 828 that extends in a direction of the Y-axis. In an embodiment, the width 828 of the carrier ion supply layers 706 are about 15 mm. In other embodiments, the width 828 of the carrier ion supply layers 706 are about 10 mm, about 20 mm, or some other suitable value that allow the carrier ion supply layers to function as described herein. In some embodiments, the width 828 of the carrier ion supply layers 706 lies in a range of values of about 5 mm to about 100 mm, or some other suitable range of values that allows the carrier ion supply layers to function as described herein.

The carrier ion supply layers 706, in one embodiment, have a length 830 that extends in a direction of the X-axis. In an embodiment, the length 830 of the carrier ion supply layers 706 are about 23 mm. In other embodiments, the length 830 of the carrier ion supply layers 706 are about 15 mm, about 20 mm, about 25 mm, or some other suitable length that allows the carrier ion supply layers to function as described herein. In some embodiments, the length 830 of the carrier ion supply layers 706 lie in a range of values of about 10 mm to about 100 mm, or some other suitable range of values that allow the carrier ion supply layers to function as described herein.

The carrier ion supply layers 706 each have a thickness 832 that extends in a direction of the Z-axis. Generally, the thickness 832 is a distance between the first surface 826 of the carrier ion supply layers 706 and the second surface 827 of the carrier ion supply layers. In one embodiment, the thickness 832 of the carrier ion supply layers 706 are about 0.13 mm. In other embodiments, the thickness 832 of the carrier ion supply layers 706 are about 0.005 mm, about 0.15 mm, or about 0.2 mm. In some embodiments, the thickness 832 of the carrier ion supply layers 706 lie in a range of values of about 0.01 mm to about 1.0 mm, or any other suitable range of values for the thickness that allows the carrier ion supply layers to function as described herein.

In this embodiment, the carrier ion supply layers 706 are separated from each other by a distance 834, corresponding to the third region 818-3. In one embodiment, the distance 834 is about 23 mm. In other embodiments, the distance 834 is about 15 mm, about 20 mm, about 25 mm, or about 30 mm. In some embodiments, the distance 834 lies in a range of values of about 10 mm to about 50 mm, or any other suitable range of values that allows the carrier ion supply layers 706 to function as described herein.

In one embodiment, the carrier ion supply layers 706 are sized to be capable of providing at least 15% of the reversible coulombic capacity of the positive electrode 208 of the secondary battery 100. For example, in one such embodiment, the carrier ion supply layers 706 are sized such that they contain sufficient carrier ions (e.g., lithium, magnesium, or aluminum ions) to provide at least 30% of the reversible coulombic capacity of the positive electrode 208 of the secondary battery 100. By way of further example, in one such embodiment, the carrier ion supply layers 706 are sized such that they contain sufficient carrier ions to provide at least 100% of the reversible coulombic capacity of the positive electrode 208 of the secondary battery 100. By way of further example, in one such embodiment, the carrier ion supply layers 706 are sized such that they contain sufficient carrier ions to provide at least 200% of the reversible coulombic capacity of the positive electrode 208 of the secondary battery 100. By way of further example, in one such embodiment, the carrier ion supply layers 706 are sized such that they contain sufficient carrier ions to provide at least 300% of the reversible coulombic capacity of the positive electrode 208 of the secondary battery 100. By way of further example, in one such embodiment, the carrier ion supply layers 706 are sized such that they contain sufficient carrier ions to provide about 100% to about 200% of the reversible coulombic capacity of the positive electrode 208 of the secondary battery 100.

During an assembly process for the auxiliary electrode 502, the separator 702 may be cut from stock material or prefabricated to achieve the width 804 and the length 808 as shown in FIG. 8. The conductive layer 704 may be cut from stock material or prefabricated to achieve the width 816 and the length 822 shown in FIG. 8. In some embodiments, the conductive layer 704 is prefabricated to include the conductive tab 508-2 with the first end 812 mechanically and electrically affixed to the conductive layer 704 as depicted in FIG. 8. In other embodiments, the conductive tab 508-2 is cut from a stock material and mechanically and electrically coupled with the conductive layer 704 (e.g., by spot welding or soldering first end 812 to the conductive layer). In some embodiments, the carrier ion supply layers 706 are cut to size from stock materials, and bonded or otherwise laminated to the conductive layer 704 (e.g., by cold welding the carrier ion supply layers 706 onto the conductive layer) to achieve the orientation depicted in FIG. 8, with the second surface 827 of the carrier ion supply layers 706 in contact with the first surface 814 of the conductive layer 704. For example, the material used to form the carrier ion supply layers 706 (e.g., lithium) may exist in stock form as rolls of lithium sheets that are cut to size.

In other embodiments, the conductive layer 704 is prefabricated to include the carrier ion supply layers 706 arranged in the orientation depicted in FIG. 8. In this embodiment, the conductive layer 704 is disposed within the first portion 805 of the separator 702 in a direction of the X-axis, with the second surface 815 of the conductive layer 704 contacting the first surface 802 of the separator.

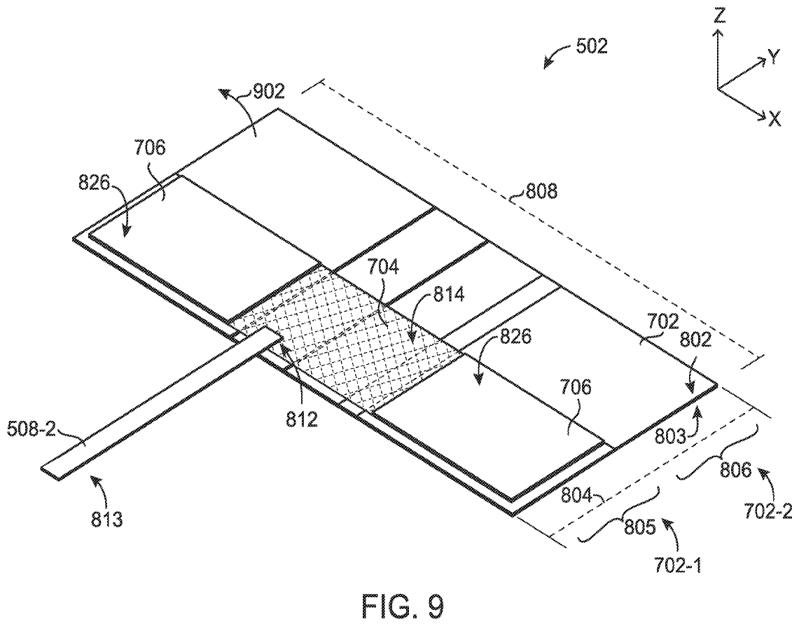

FIG. 9 is a perspective view of the auxiliary electrode 502 at an intermediate stage of the fabrication process for the auxiliary electrode. At this stage, the conductive layer 704 is disposed on the first portion 805 of the separator 702, and the conductive tab 508-2 extends to the left (in the Y-axis direction) in FIG. 9 from the first end 812, which is affixed to the conductive layer 704, away from the separator 702 and the conductive layer 704 towards the second end 813. The first surface 802 of the separator 702 is covered by the conductive layer 704 within the first portion 805 of the separator, while the first surface 802 of separator remains uncovered within the second portion 806 of the separator.

To continue the fabrication process of the auxiliary electrode 502, in one embodiment, the second portion 806 of the separator 702 is folded in the direction of an arrow 902 towards the left (about an axis parallel to the X-axis) in FIG. 9, such that the first surface 802 within the second portion 806 of the separator 702 contacts the first surfaces 826 of the carrier ion supply layers 706 and the first surface 814 of the conductive layer 704 that is exposed between the carrier ion supply layers 706. When the separator 702 comprises the first separator layer 702-1 and the second separator layer 702-2, the second separator layer may be placed such that the first surface 802 of the second separator layer contacts the first surfaces 826 of the carrier ion supply layers 706 and the first surface 814 of the conductive layer 704 that is exposed between the carrier ion supply layers.

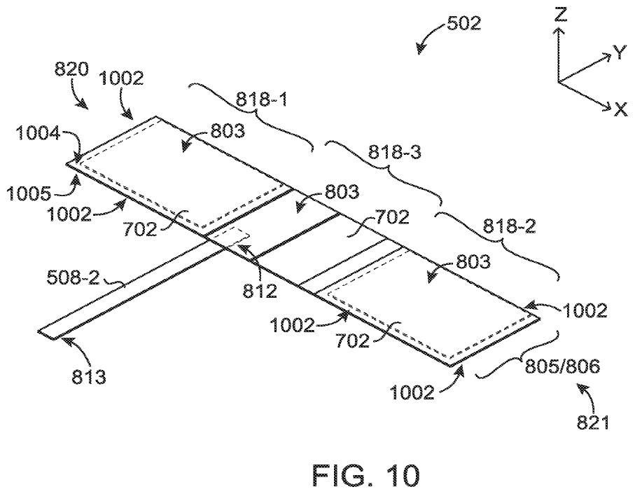

FIG. 10 is a perspective view of the auxiliary electrode 502 at another intermediate stage in the fabrication process, after folding the second portion 806 of the separator 702 as described above. At this stage, the separator 702 encapsulates the conductive layer 704 and the carrier ion supply layers 706, leaving a portion between the first end 812 of the conductive tab 508-2 and the second end 813 of the conductive tab 508-2 uncovered by the separator 702. The separator 702 may then be bonded to itself along at least a portion of an outer perimeter 1002 of the separator to encapsulate the conductive layer 704 within the first portion 805 of the separator and the second portion 806 of the separator along the first surface 802 of the separator (not visible in FIG. 10).

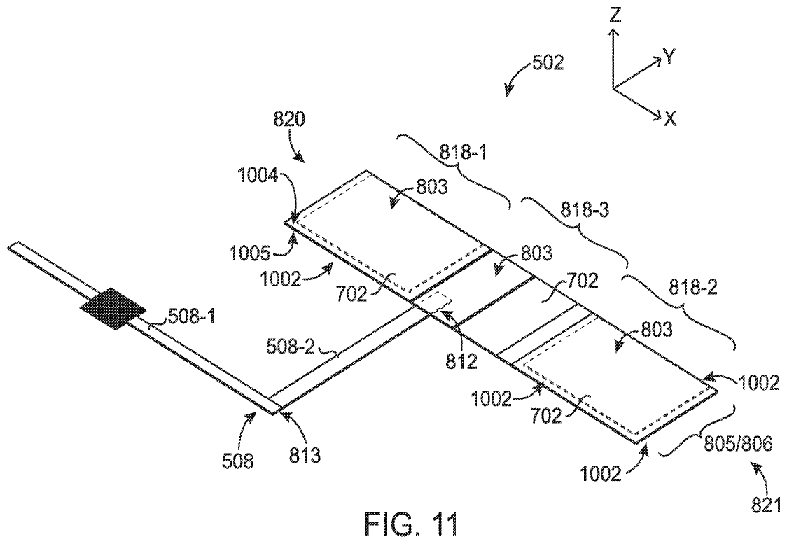

In one embodiment, the separator 702 is bonded to itself along at least a portion of an outer perimeter 1002 of the separator using a hot melt process, a welding process, a bonding process, etc. In FIG. 10, the auxiliary electrode 502 at this stage includes a first side 1004 and a second side 1005 that opposes the first side 1004. The first side 1004 includes the second surface 803 of the separator 702, which covers the carrier ion supply layers 706 in first region 818-1 proximate to first end 820 of the conductive layer 704 (not visible in FIG. 10) and the second region 818-2 proximate to the second end 821 of the conductive layer 704 (not visible in this view). In FIG. 10, the first region 818-1 is proximate to the first end 812 of the conductive tab 508-2 and the second region 818-2 is disposed away from the first end 812 of the conductive tab 508-2. The first end 812 of the conductive tab 508-2 is electrically coupled to the conductive layer 704 within the third region 818-3 of the conductive layer 704. In some embodiments, the conductive tab 508 may be extended (e.g., with the conductive tab 508-1, as shown in FIG. 11, which depicts the auxiliary electrode 502 after assembly).

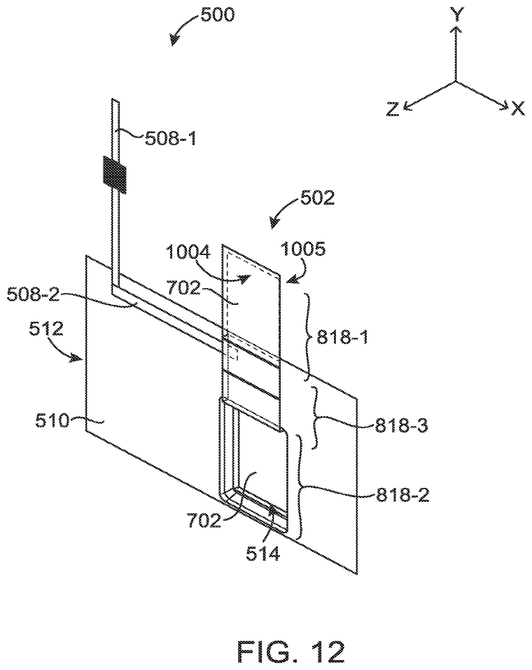

In response to fabricating the auxiliary electrode 502, performing a fabrication process for the buffer system 500 (see FIGS. 6 and 7) continues as follows. FIGS. 12-16 are perspective views of the buffer system 500 during various stages in a fabrication process. Referring to FIG. 12, the second region 818-2 of the auxiliary electrode 502 is inserted into the pouch 514 of the first enclosure layer 510, with the second side 1005 of the auxiliary electrode disposed towards the first enclosure layer 510 within the pouch 514 and the first side 1004 of the auxiliary electrode disposed away from the first enclosure layer 510 within the pouch 514. The third region 818-3 and the first region 818-1 of the auxiliary electrode 502 extend away from the pouch 514 in the direction of the Y-axis.

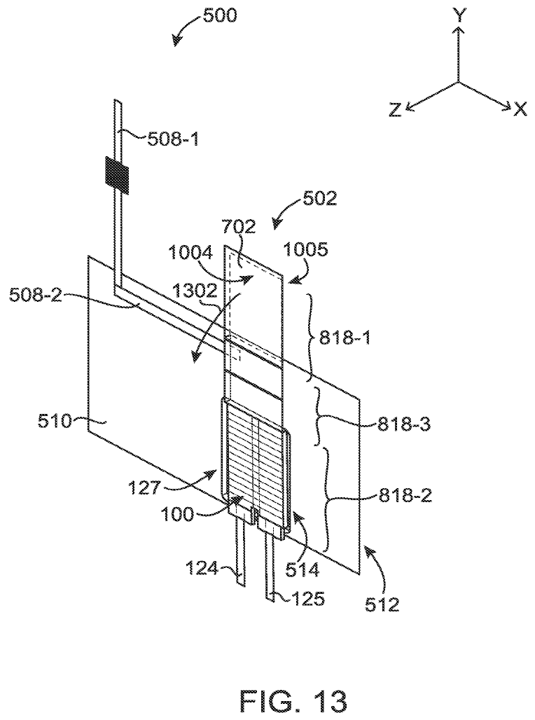

With the auxiliary electrode 502 oriented within the pouch 514 as depicted in FIG. 12, the secondary battery 100 is placed on the auxiliary electrode 502 within the pouch 514, which corresponds to the second region 818-2 of the auxiliary electrode 502 (see FIG. 13). In this embodiment, the first major surface 126 of the secondary battery 100 (see FIG. 1, not visible in FIG. 13) contacts the auxiliary electrode 502 within the pouch 514 and the second major surface 127 of the secondary battery is disposed away from the auxiliary electrode 502. The electrical terminals 124, 125 of the secondary battery 100 extend away from the pouch 514 in the direction of the Y-axis in FIG. 13, placing the electrical terminals outside of the perimeter 512 of the first enclosure layer 510. At this stage of the fabrication process for the buffer system 500, in one embodiment, an electrolyte is added to the pouch 514. In another embodiment, the separator 702 of the auxiliary electrode 502 is pre-impregnated with the electrolyte.

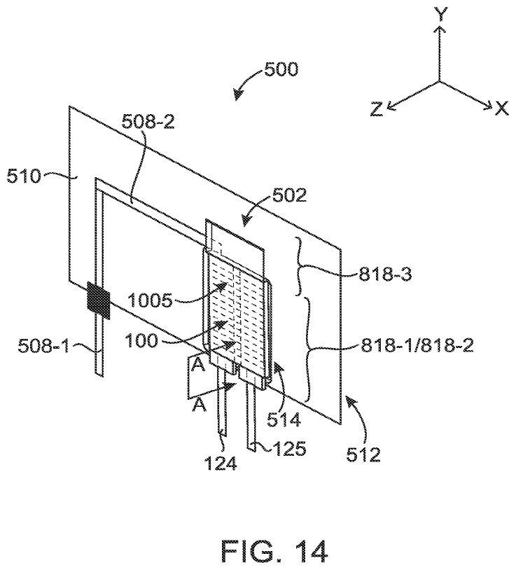

With the secondary battery 100 loaded onto the second region 818-2 of the auxiliary electrode 502 within the pouch 514, the auxiliary electrode 502 is folded in the direction of an arrow 1302 in order to position the first side 1004 of the first region 818-1 of the auxiliary electrode 502 in contact with the second major surface 127 of the secondary battery 100, the result of which is depicted in FIG. 14. In this configuration, both major surfaces 126, 127 of the secondary battery 100 (see FIG. 1) are electrochemically coupled with the carrier ion supply layers 706 of the auxiliary electrode 502, using the separator 702 (see FIGS. 7-11) and an electrolyte disposed between each of the major surfaces 126, 127 of the secondary battery 100 and the carrier ion supply layers 706.

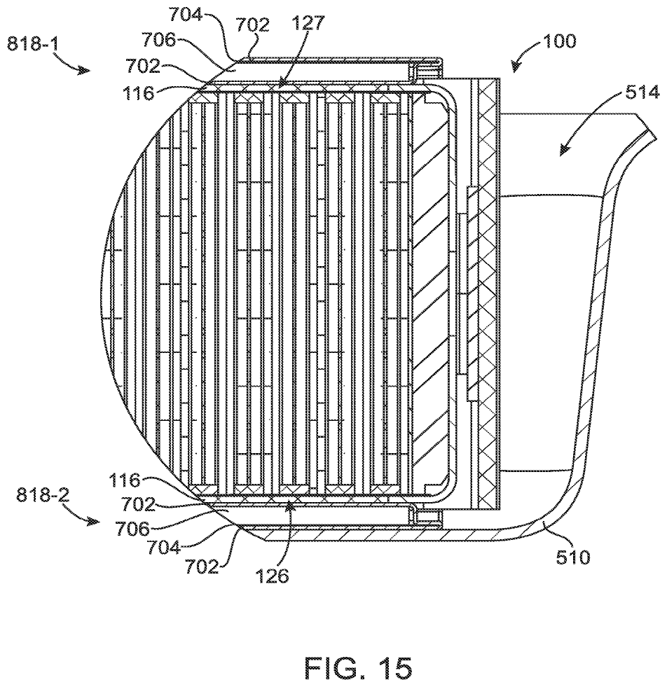

FIG. 15 is a cross-sectional view of the buffer system 500 along cut lines A-A of FIG. 14. In this view, the layers of the buffer system 500 at the pouch 514 of the first enclosure layer 510 are visible. In particular, FIG. 15 illustrates the placement of the secondary battery 100 and the auxiliary electrode 502 in the pouch 514, and specifically, from top to bottom in stacked succession, the separator 702, the conductive layer 704, one of the carrier ion supply layers 706, the separator 702, and the second major surface 127 of the secondary battery 100 at the casing 116. FIG. 15 further illustrates, from bottom to top in stacked succession, the first enclosure layer 510, the separator 702, the conductive layer 704, one of the carrier ion supply layers 706, the separator 702, and the first major surface 126 of the secondary battery 100 at the casing 116.

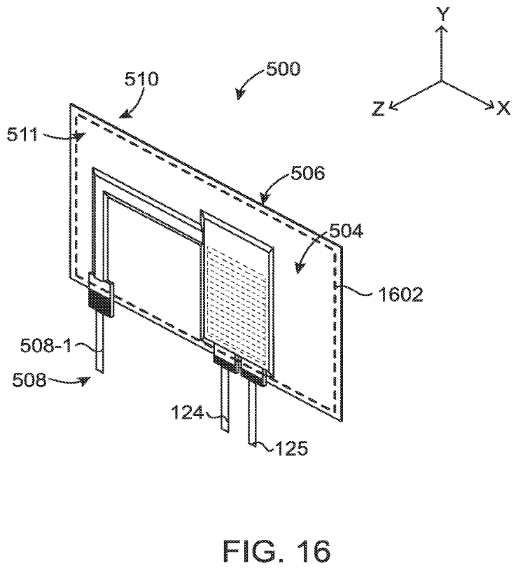

With the secondary battery 100 sandwiched by the auxiliary electrode 502 within the pouch 514 as illustrated in FIG. 15, the second enclosure layer 511 is aligned to the first enclosure layer 510, as depicted in FIG. 16. After proper placement of the second enclosure layer 511 relative to the first enclosure layer 510, the enclosure layers 510, 511 are sealed along a sealing line 1602 (denoted by the dashed line in FIG. 16) to form the enclosure 504. The enclosure layers 510, 511 may be sealed along the sealing line 1602 by welding, heat sealing, adhesive, combinations thereof, or the like. In another embodiment, the enclosure layers 510, 511 may be sealed along three sides of the sealing line 1602 creating a pocket therein. In this embodiment, the secondary battery 100 may be placed within the pocket, and the final edge of the sealing line 1602 is subsequently sealed. In one embodiment, the sealing line 1602 is sealed using a hot press, that applies a controlled temperature and pressure to the sealing line 1602 causing the enclosure layers 510, 511 to adhere or fuse together along the sealing line 1602. In another embodiment, a vacuum is applied to the secondary battery 100 during the sealing process to evacuate any excess volume occupied by air or other gas. The time for which the sealing line 1602 is subject to the hot press may be controlled and is dependent upon the materials selected for the enclosure layers 510, 511. Once sealed over the secondary battery 100, the sealed enclosure layers 510, 511 form the buffer system 500. Upon sealing, the buffer system 500 is liquid tight and/or air-tight, depending on the desired application. The electrical terminals 124 and 125 of the secondary battery 100 and the conductive tab 508-1 remain exposed and are not covered by the enclosure layers 510, 511 to allow for a subsequent buffer process to be applied to the secondary battery.

With the secondary battery 100 and the carrier ion supply layers 706 of the auxiliary electrode 502 (not visible in FIG. 16) electrochemically coupled together within the enclosure 504 of the buffer system 500, a carrier ion buffer process is performed on the secondary battery 100 during or after initial formation of the secondary battery. Generally, this carrier ion buffer process transfers carrier ions from the carrier ion supply layers 706 of the auxiliary electrode 502 into each of the first major surface 126 of the secondary battery 100 and the second major surface 127 of the secondary battery (see FIG. 15). Generally, transferring the carrier ions to the secondary battery 100 from both major surfaces 126, 127 of the secondary battery, as depicted in FIG. 15, provides a technical benefit of distributing the forces generated by anode and/or cathode swelling more equally across the casing 116 of the secondary battery 100 as more carrier ions are loaded into the anode and/or the cathode of the secondary battery.

Either prior to inserting the secondary battery 100 into the buffer system 500, or after, the secondary battery 100 is charged (e.g., via the electrical terminals 124, 125) by transferring carrier ions from the cathode structures 206 of the secondary battery to the anode structures 207 of the secondary battery. Charging may be discontinued when the positive electrode 208 of the secondary battery 100 reaches its the end-of-charge design voltage. During the initial charging cycle, SEI may form on the surfaces of the anode structures 207 of the secondary battery 100. To compensate for the loss of carrier ions to SEI, and to further provide additional carrier ions to mitigate the long term secondary reactions during cycling where carrier ions are lost due to side reactions, the positive electrode 208 and/or the negative electrode 209 of the secondary battery 100 may be replenished by applying a voltage across the auxiliary electrode 502 and the cathode structures 206 and/or the anode structures 207 (e.g., via the conductive tab 508-1 of the auxiliary electrode 502 and one of the electrical terminals 124, 125) to drive carrier ions from the carrier ion supply layers 706 of the auxiliary electrode 502 to the cathode structures 206 and/or the anode structures 207 of the secondary battery 100. Once the transfer of carrier ions from the auxiliary electrode 502 to the secondary battery 100 is complete, the negative electrode 209 of the secondary battery is again charged, this time with carrier ions transferred from the cathode structures 206 of the secondary battery 100 to the anode structures 207 of the secondary battery.

In one embodiment, the amount of carrier ions transferred from the auxiliary electrode 502 to the secondary battery 100 during the buffer process is about 50% of the reversable columbic capacity of the positive electrode 208 of the secondary battery. In other embodiments, the amount of carrier ions transferred from the auxiliary electrode 502 to the secondary battery 100 during the buffer process is about 55%, about 60%, about 65%, about 70%, about 75%, about 80%, about 85%, about 90%, about 95%, or about 100% of the reversable columbic capacity of the positive electrode 208 of the secondary battery. In some embodiments, the amount of carrier ions transferred from the auxiliary electrode 502 to the secondary battery 100 lies in a range of values of about 1% to about 100% of the reversable columbic capacity of the positive electrode 208 of the secondary battery. In one particular embodiment, the negative electrode 209 of the secondary battery 100 has about 170% of the reversable columbic capacity of the positive electrode 208 of the secondary battery stored as carrier ions when the secondary battery is charged, and about 70% of the reversable columbic capacity of the positive electrode 208 of the secondary battery stored as carrier ions when the secondary battery is discharged. An excess of carrier ions at the negative electrode 209 of the secondary battery 100 provided during the buffer process provides a technical benefit of mitigating the loss of carrier ions at the secondary battery due to SEI at initial formation. Further, an excess of carrier ions at the negative electrode 209 of the secondary battery 100 provided during the buffer process provides a technical benefit of mitigating the loss of carrier ions at the secondary battery due to side reactions that deplete carrier ions in the secondary battery as the secondary battery is cycled during use, which reduces the capacity loss of the secondary battery over time.

In some embodiments, transferring carrier ions from the auxiliary electrode 502 to the secondary battery 100 may occur concurrently with an initial formation of the secondary battery (e.g., during the first charge of the secondary battery), and/or during a subsequent charge of the secondary battery after initial formation. In these embodiments, carrier ions are transferred from the positive electrode 208 of the secondary battery 100 to the negative electrode 209 of the secondary battery. Concurrently with or based on a temporal delay or a temporal pattern, carrier ions are transferred from the auxiliary electrode 502 to the positive electrode 208 and/or the negative electrode 209 of the secondary battery 100.

In yet another embodiment, the positive electrode 208 may be replenished with carrier ions by simultaneously transferring carrier ions from the auxiliary electrode 502 to the positive electrode 208 of the secondary battery 100, while also transferring carrier ions from the positive electrode of the secondary battery to the negative electrode 209 of the secondary battery. Referring to FIG. 6, a voltage is applied across the electrical terminals 124, 125 of the secondary battery 100, to drive carrier ions from the positive electrode 208 to the negative electrode 209 of the secondary battery. While the carrier ions are being transferred from the positive electrode 208 to the negative electrode 209, a voltage is applied across the conductive tab 508-1 of the auxiliary electrode 502 and the positive electrode 208 of the secondary battery 100 to drive carrier ions from the auxiliary electrode 502 to the positive electrode 208 of the secondary battery. Thus, carrier ions are transferred from the auxiliary electrode 502 to the positive electrode 208 of the secondary battery 100 at the same time that carrier ions are being transferred from the positive electrode to the negative electrode 209 of the secondary battery. That is, a voltage is maintained across the positive electrode 208 and the negative electrode 209 of the secondary battery 100 that is sufficient to drive carrier ions from the positive electrode to the negative electrode of the secondary battery, at the same time that a voltage is maintained across the conductive tab 508-1 of the auxiliary electrode 502 and the positive electrode of the secondary battery that is sufficient to drive carrier ions from the auxiliary electrode to the positive electrode. In another embodiment, the onset of transfer of carrier ions from the auxiliary electrode 502 to the positive electrode 208 of the secondary battery 100 may commence simultaneously with onset of the transfer of carrier ions from the positive electrode to the negative electrode 209 of the secondary battery. In one embodiment, the rate of transfer of carrier ions from the positive electrode 208 to the negative electrode 209 of the secondary battery 100 is greater than or equal to the rate of transfer of carrier ions from the auxiliary electrode 502 to the positive electrode of the secondary battery, such that a good overall rate of transfer of carrier ions from the auxiliary electrode to the negative electrode of the secondary battery via the positive electrode can be maintained. That is, the relative rates of transfer between the positive electrode 208 and the negative electrode 209 of the secondary battery 100, and the auxiliary electrode 502 and the positive electrode, may be maintained such that the overall capacity of the positive electrode for additional carrier ions is not exceeded. The positive electrode 208 may thus be maintained in a state where it has the ability to accept new carrier ions from the auxiliary electrode 502, which may allow for subsequent transfer of carrier ions to the negative electrode 209 of the secondary battery 100.

In one embodiment, without being limited by any particular theory, the carrier ions are transferred from the auxiliary electrode 502 to the positive electrode 208 of the secondary battery 100 as a part of the replenishment of the negative electrode 209 of the secondary battery (as opposed to transferring from the auxiliary electrode directly to the negative electrode of the secondary battery), because the positive electrode may be capable of more uniformly accepting carrier ions across the surface thereof, thus allowing the carrier ions to more uniformly participate in the transfer thereof between the positive electrode and the negative electrode of the secondary battery.

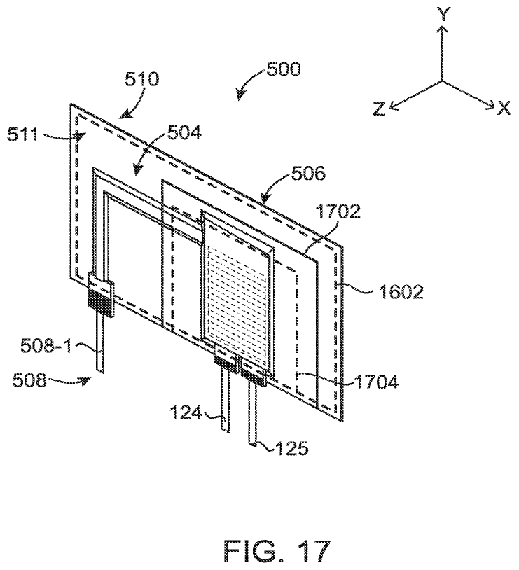

After the buffer process is performed on the secondary battery 100 utilizing the buffer system 500, the auxiliary electrode 502 may be removed from the buffer system in order to improve the energy density of the secondary battery 100 in its final form. For example, after the buffer process, the carrier ion supply layers 706 (see FIG. 7) may have been removed from the conductive layer 704, having been electrochemically transferred to the secondary battery 100. Thus, the auxiliary electrode 502 may be superfluous at this point. To remove the auxiliary electrode 502 from the enclosure 504 after the buffer process is performed, the enclosure layers 510, 511 of the enclosure may be cut along cut lines 1702, illustrated in FIG. 17 as solid lines, allowing the enclosure layers 510, 511 to be peeled back proximate to the auxiliary electrode 502. The auxiliary electrode 502 is removed from the enclosure 504 of the buffer system 500, while the secondary battery 100 remains within the pouch 514 (see FIG. 12). The enclosure layers 510, 511 may then be re-sealed along a final sealing line 1704 illustrated as dashed lines to form the enclosure 504 in its final form prior to placing the secondary battery 100 in service. This re-seal may be performed using any of the previously described processes for sealing the first enclosure layer 510 and the second enclosure layer 511 together.

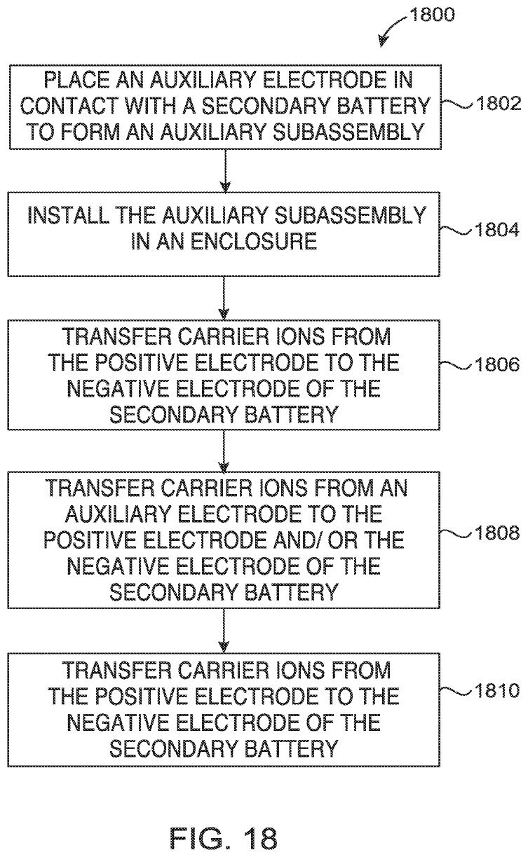

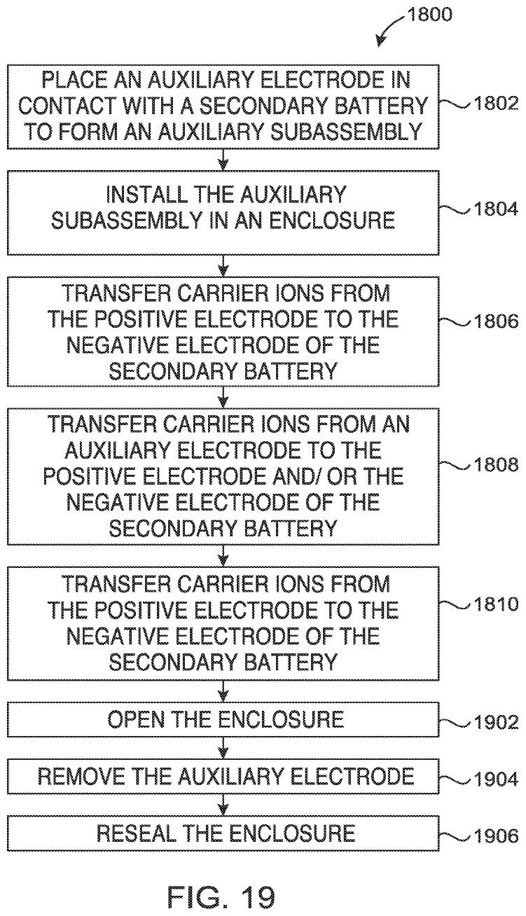

FIG. 18 is a flow chart of a method 1800 of pre-lithiating a secondary battery with carrier ions using an auxiliary electrode of an exemplary embodiment, and FIGS. 19-21 are flow charts depicting additional details of the method 1800. The method 1800 will be described with respect to the secondary battery 100, the buffer system 500, and the auxiliary electrode 502 of FIGS. 1-17, although the method 1800 may apply to other systems, not shown. The steps of the method 1800 are not all inclusive, and the method 1800 may include other steps, not shown. Further, the steps of the method 1800 may be performed in an alternate order.

In this embodiment, the secondary battery 100 (see FIG. 1) has major surfaces 126, 127 that oppose each other, and the electrical terminals 124, 125. The electrical terminals 124, 125 are coupled to one of the positive electrode 208 of the secondary battery 100 (e.g., the population of the cathode structures 206 in the secondary battery, as depicted in FIG. 2) and the negative electrode 209 of the secondary battery (e.g., the population of the anode structures 207 in the secondary battery, as depicted in FIG. 2). The secondary battery 100 comprises the microporous separator layer 108 (see FIG. 2) between the negative electrode 209 and the positive electrode 208 that is permeated with an electrolyte in ionic contact with the negative electrode 209 and the positive electrode 208. The negative electrode 209 comprises the anodically active material layer 104, such as silicon or an alloy thereof, having a coulombic capacity for the carrier ions. The positive electrode 208 comprises the cathodically active material layer 106, having a coulombic capacity for the carrier ions, with a negative electrode 209 coulombic capacity exceeding a positive electrode 208 coulombic capacity.

The auxiliary electrode 502 (see FIG. 6) is placed in contact with the major surfaces 126, 127 of the secondary battery 100 to form the auxiliary subassembly 516, where the auxiliary electrode 502 includes the electrically conductive layer 704, the carrier ion supply layers 706 disposed on the conductive layer that are proximate to the major surfaces 126, 127 of the secondary battery 100, the separator 702 disposed between the carrier ion supply layers and the major surfaces 126, 127 of the secondary battery, and the electrically conductive tab 508 coupled to the conductive layer (see step 1802 of FIG. 18, and FIGS. 12-15).

The auxiliary subassembly 516 is installed in the enclosure 504, where the electrical terminals 124, 125 of the secondary battery 100 and the electrically conductive tab 508 of the auxiliary electrode 502 electrically extend from the perimeter 506 of enclosure 504 (see step 1804, and FIG. 16).

Carrier ions are transferred from the positive electrode 208 of the secondary battery 100 to the negative electrode 209 of the secondary battery to at least partially charge the secondary battery by applying a potential voltage across the electrical terminals 124, 125 (see step 1806). Charging may be discontinued when the positive electrode 208 of the secondary battery 100 reaches its the end-of-charge design voltage. During the initial charging cycle, SEI may form on the internal structural surfaces of the negative electrode 209 of the secondary battery 100.

To compensate for the loss of carrier ions to SEI, and to further provide additional carrier ions to mitigate the long term secondary reactions during cycling where carrier ions are lost due to side reactions, carrier ions are transferred from the carrier ion supply layers 706 of the auxiliary electrode 502 to the positive electrode 208 and/or the negative electrode 209 of the secondary battery 100 by applying a potential voltage across the electrically conductive tab 508 of the auxiliary electrode 502 and one or more of the electrical terminals 124, 125 of the secondary battery (see step 1808, FIG. 16). Generally, this carrier ion buffer process transfers carrier ions from the carrier ion supply layers 706 of the auxiliary electrode 502 into each of the first major surface 126 of the secondary battery 100 and the second major surface 127 of the secondary battery (see FIG. 15). Generally, transferring carrier ions to the secondary battery 100 from both of the major surfaces 126, 127 of the secondary battery, as depicted in FIG. 15, provides a technical benefit of distributing the forces generated by anode and/or cathode swelling more equally across the casing 116 of the secondary battery as more carrier ions are loaded into the cathode and/or the anode of the secondary battery 100.

In one embodiment, the amount of carrier ions transferred from the auxiliary electrode 502 to the secondary battery 100 is about 50% of the reversable columbic capacity of the positive electrode 208 of the secondary battery. In other embodiments, the amount of carrier ions transferred from the auxiliary electrode 502 to the secondary battery 100 is about 55%, about 60%, about 65%, about 70%, about 75%, about 80%, about 85%, about 90%, about 95%, or about 100% of the reversable columbic capacity of the positive electrode 208 of the secondary battery. In some embodiments, the amount of carrier ions transferred from the auxiliary electrode 502 to the secondary battery 100 lies in a range of values of about 1% to about 100% of the reversable columbic capacity of the positive electrode 208 of the secondary battery. In one particular embodiment, the negative electrode 209 of the secondary battery 100 has about 170% of the reversable columbic capacity of the positive electrode 208 of the secondary battery stored as carrier ions when the secondary battery is charged, and about 70% of the reversable columbic capacity of the positive electrode 208 of the secondary battery stored as carrier ions when the secondary battery is discharged. An excess of carrier ions at the negative electrode 209 of the secondary battery 100 provided during the buffer process provides a technical benefit of mitigating the loss of carrier ions at the secondary battery due to SEI at initial formation. Further, an excess of carrier ions at the negative electrode 209 of the secondary battery 100 provided during the buffer process provides a technical benefit of mitigating the loss of carrier ions at the secondary battery due to side reactions that deplete carrier ions in the secondary battery as the secondary battery is cycled during use, which reduces the capacity loss of the secondary battery over time.

In some embodiments, transferring carrier ions from the auxiliary electrode 502 to the secondary battery 100 may occur concurrently with an initial formation of the secondary battery (e.g., during the first charge of the secondary battery), and/or during a subsequent charge of the secondary battery after initial formation. In these embodiments, carrier ions are transferred from the positive electrode 208 of the secondary battery 100 to the negative electrode 209 of the secondary battery. Concurrently with or based on a temporal delay or a temporal pattern, carrier ions are transferred from the auxiliary electrode 502 to the positive electrode 208 and/or the negative electrode 209 of the secondary battery 100.

Carrier ions are again transferred from the positive electrode 208 of the secondary battery 100 to the negative electrode 209 of the secondary battery to charge the secondary battery by applying a potential voltage across the electrical terminals 124, 125 of the secondary battery until the negative electrode 209 has greater than 100% of the positive electrode 208 coulombic capacity stored as the carrier ions (see step 1810).

In yet another embodiment, the positive electrode 208 may be replenished with carrier ions by simultaneously transferring carrier ions from the auxiliary electrode 502 to the positive electrode 208 of the secondary battery 100, while also transferring carrier ions from the positive electrode 208 of the secondary battery to the negative electrode 209 of the secondary battery. Referring to FIG. 6, a voltage is applied across the electrical terminals 124, 125 of the secondary battery 100, to drive carrier ions from the positive electrode 208 to the negative electrode 209 of the secondary battery. While the carrier ions are being transferred from the positive electrode 208 to the negative electrode 209, a voltage is applied across the conductive tab 508-1 of the auxiliary electrode 502 and the positive electrode 208 of the secondary battery 100 to drive carrier ions from the auxiliary electrode 502 to the positive electrode 208 of the secondary battery. Thus, carrier ions are transferred from the auxiliary electrode 502 to the positive electrode 208 of the secondary battery 100 at the same time that carrier ions are being transferred from the positive electrode 208 to the negative electrode 209 of the secondary battery. That is, a voltage is maintained across the positive electrode 208 and the negative electrode 209 of the secondary battery 100 that is sufficient to drive carrier ions from the positive electrode 208 to the negative electrode 209 of the secondary battery, at the same time that a voltage is maintained across the conductive tab 508-1 of the auxiliary electrode 502 and the positive electrode 208 of the secondary battery that is sufficient to drive carrier ions from the auxiliary electrode 502 to the positive electrode 208. In another embodiment, the onset of transfer of carrier ions from the auxiliary electrode 502 to the positive electrode 208 of the secondary battery 100 may commence simultaneously with onset of the transfer of carrier ions from the positive electrode 208 to the negative electrode 209 of the secondary battery. In one embodiment, the rate of transfer of carrier ions from the positive electrode 208 to the negative electrode 209 of the secondary battery 100 is greater than or equal to the rate of transfer of carrier ions from the auxiliary electrode 502 to the positive electrode 208 of the secondary battery 100, such that a good overall rate of transfer of carrier ions from the auxiliary electrode 502 to the negative electrode 209 of the secondary battery via the positive electrode can be maintained. That is, the relative rates of transfer between the positive electrode 208 and the negative electrode 209 of the secondary battery 100, and the auxiliary electrode 502 and the positive electrode, may be maintained such that the overall capacity of the positive electrode for additional carrier ions is not exceeded. The positive electrode 208 may thus be maintained in a state where it has the ability to accept new carrier ions from the auxiliary electrode 502, which may allow for subsequent transfer of carrier ions to the negative electrode 209 of the secondary battery 100.

In one embodiment, without being limited by any particular theory, the carrier ions are transferred from the auxiliary electrode 502 to the positive electrode 208 of the secondary battery 100 as a part of the replenishment of the negative electrode 209 of the secondary battery (as opposed to transferring from the auxiliary electrode 502 directly to the negative electrode of the secondary battery), because the positive electrode may be capable of more uniformly accepting carrier ions across the surface thereof, thus allowing the carrier ions to more uniformly participate in the transfer thereof between the positive electrode and the negative electrode of the secondary battery.

In some embodiments of the method 1800, the enclosure 504 is opened (see step 1902 of FIG. 19), and the auxiliary electrode 502 is removed from the enclosure 504 (see step 1904). In response to removing the auxiliary electrode 502 from the enclosure 504, the enclosure is resealed into its final form to encapsulate the secondary battery 100 for use (see step 1906). In other embodiments, the auxiliary electrode 502 is not removed from the enclosure 504.

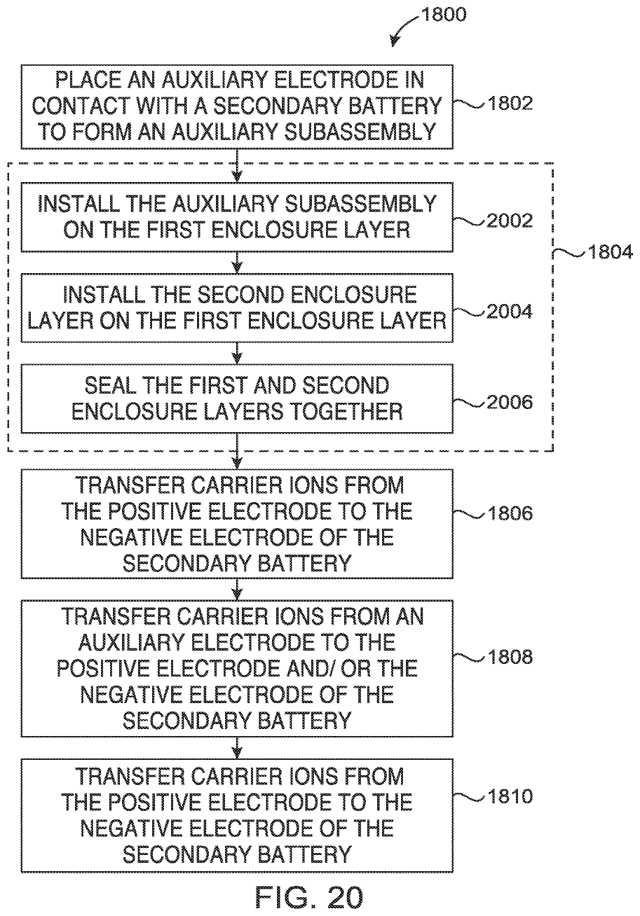

Although installing the auxiliary subassembly 516 in the enclosure 504 as previously described with respect to step 1804 detailed above, one particular embodiment comprises installing the auxiliary subassembly 516 on the first enclosure layer 510 (see step 2002 of FIG. 20). The second enclosure layer 511 is installed on the first enclosure layer 510 (see step 2004), and the first enclosure layer 510 and the second enclosure layer 511 are sealed together along the sealing line 1602 to form the enclosure 504 (see step 2006).

The enclosure layers 510, 511 may be sealed along the sealing line 1602 (see FIG. 16) by welding, heat sealing, adhesive, combinations thereof, or the like. In another embodiment, the enclosure layers 510, 511 may be sealed along three sides of the sealing line 1602 creating a pocket therein. In this embodiment, the secondary battery 100 may be placed within the pocket, and the final edge of the sealing line 1602 is subsequently sealed. In one embodiment, the sealing line 1602 is sealed using a hot press, that applies a controlled temperature and pressure to the sealing line 1602 causing the enclosure layers 510, 511 to adhere or fuse together along the sealing line 1602. In another embodiment, a vacuum is applied to the secondary battery 100 during the sealing process to evacuate any excess volume occupied by air or other gas. The time for which the sealing line 1602 is subject to the hot press may be controlled and is dependent upon the materials selected for the enclosure layers 510, 511. Once sealed over the secondary battery 100, the sealed enclosure layers 510, 511 form the buffer system 500. Upon sealing, the buffer system 500 is liquid tight and/or air-tight, depending on the desired application. The electrical terminals 124, 125 of the secondary battery 100 and the conductive tab 508 remain exposed and are not covered by the enclosure layers 510, 511.

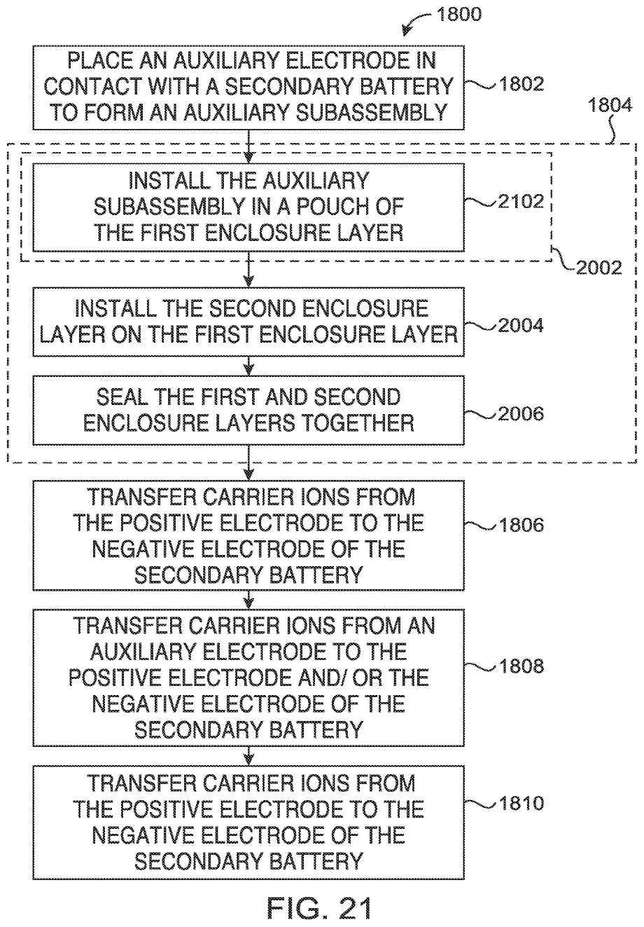

In embodiments where the first enclosure layer 510 includes the pouch 514, installing the auxiliary subassembly 516 within the enclosure 504 initially comprises placing the auxiliary subassembly 516 within the pouch 514 (see step 2102 of FIG. 21). In some embodiments, an electrolyte is added to the pouch 514 (e.g., either before or after installing the auxiliary subassembly 516 in the pouch 514), with the enclosure 504 formed subsequent thereto by sealing the first enclosure layer 510 and the second enclosure layer 511 together along the sealing line 1602.

In some embodiments, one or more steps of the formation process performed on the secondary battery 100 discussed above may be performed using a battery tray and a formation base removably attachable to the battery tray.

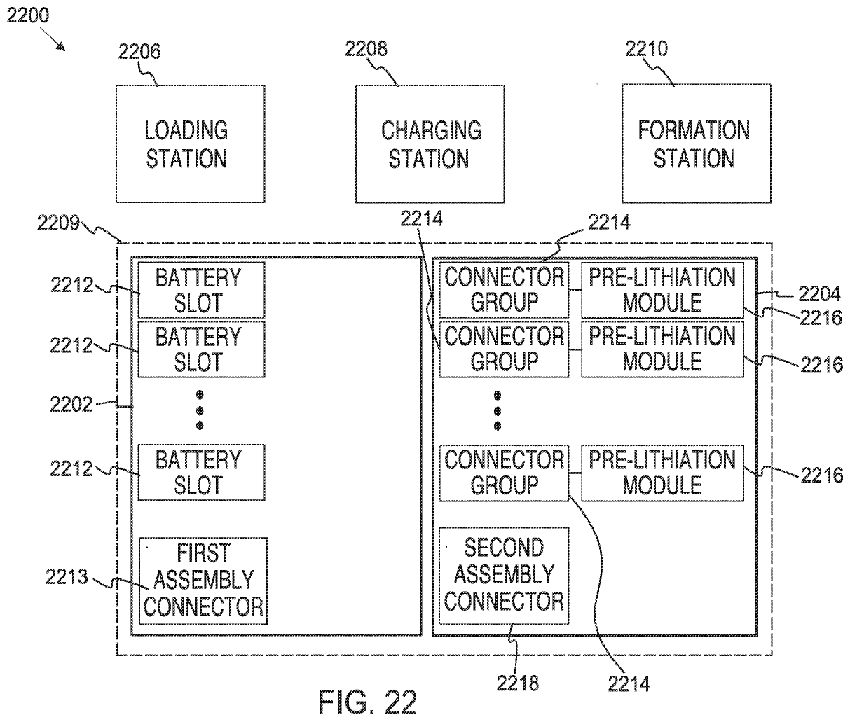

FIG. 22 is a block diagram of an example cell formation system 2200 for lithium based secondary batteries, such as the secondary battery 100. The system 2200 includes a battery tray 2202, a formation base 2204, a loading station 2206, a charging station 2208, and a formation station 2210. The battery tray 2202 and the formation base 2204 form a formation assembly 2209 when attached. Other embodiments do not include the charging station 2208, and the batteries to be processed by the cell formation system 2200 may be charged using any suitable charging system.

The battery tray 2202 includes battery slots 2212 and a first assembly connector 2213. Each battery slot 2212 is configured (e.g., sized and shaped) to receive and retain a secondary battery 100. In the example embodiment, each battery slot 2212 is configured to receive only one secondary battery 100, but in other embodiments, each battery slot may be configured to receive more than one battery. In one example embodiment, the battery tray 2202 includes one hundred and twenty battery slots 2212 arranged in three rows of forty battery slots. Other embodiments include more or fewer battery slots 2212 arranged in more or fewer rows. Openings are defined in a bottom of the battery tray 2202 at locations corresponding to the battery slots 2212 to allow the first terminal 124, the second terminal 125, and the conductive tab 508-1 to extend through the bottom of the battery tray when a secondary battery 100 is positioned in a battery slot 2212.

The formation base 2204 is sized and shaped similar to the battery tray 2202, and is configured for removable attachment to the battery tray. The formation base 2204 includes connector groups 2214, pre-lithiation modules 2216, and a second assembly connector 2218. Each connector group 2214 is configured for making electrical connection to the conductive tab 508-1, and one of the first terminal 124 and the second terminal 125 of a different secondary battery 100 when the battery tray 2202 with the secondary battery loaded therein is attached to the formation base. The one of the first terminal 124 and the second terminal 125 of a different secondary battery 100 to which the connector group 2214 connects is the cathodic terminal. In other embodiments, each connector group 2214 is configured for making electrical connection to the conductive tab 508-1, the first terminal 124, and the second terminal 125 of a different secondary battery 100 when the battery tray 2202 with the secondary battery loaded therein is attached to the formation base 2204.

Each pre-lithiation module 2216 is electrically connected to a different one of the connector groups 2214, and is configured to diffuse lithium to the electrode active materials of the secondary battery 100 connected to the connector group 2214 to which the pre-lithiation module 2216 is electrically connected. In other embodiments, each pre-lithiation module 2216 is electrically connected to more than one of the connector groups 2214, and is configured to diffuse lithium to the electrode active materials of the secondary batteries 100 connected to the more than one connector group 2214 to which the pre-lithiation module 2216 is electrically connected. In an example embodiment, the pre-lithiation modules 2216 are current sink-based pre-lithiation modules as described below. In another example, the pre-lithiation modules 2216 are switched capacitor circuits. In another example, the pre-lithiation modules 2216 include a resistor to be electrically connected between the conductive tab 508-1, and one of the first terminal 124 and the second terminal 125, and a circuit which interrupts the connection when the voltage drops to 1.5V (indicating the completion of the buffer process). Other embodiments include any other suitable pre-lithiation module. In some embodiments, each pre-lithiation module 2216 is separate from each other pre-lithiation module 2216, while in other embodiments, two or more pre-lithiation modules 2216 are integrated in a common circuit or mounted on a common support (such as rigid circuit board, a flexible circuit board, or other suitable support).

The second assembly connector 2218 is configured to matingly engage with the first assembly connector 2213 to mechanically connect the battery tray 2202 to the formation base 2204. In one example embodiment, the first assembly connector 2213 is a rectangular opening through the bottom of the battery tray 2202, and the second assembly connector 2218 is a rotatable t-shaped connector extending from the formation base 2204. In a first orientation, the second assembly connector 2218 may pass through the rectangular opening of the first assembly connector 2213 to allow the battery tray 2202 to be placed into position on the formation base 2204. When the second assembly connector 2218 is rotated to a second position (e.g., ninety degrees from the first position), the second assembly connector 2218 cannot pass through the rectangular opening of the first assembly connector 2213. Thus, after the battery tray 2202 is placed into position on the formation base 2204, the second assembly connector 2218 is rotated to the second position to lock the battery tray 2202 and the formation base 2204 together into the formation assembly 2209. Other embodiments may use other connection systems as the first and second assembly connectors 2213, 2218.

The loading station 2206, the charging station 2208, and the formation station 2210 are stations for loading batteries 100 into the battery tray 2202, charging batteries in the battery tray, and buffering batteries in the formation assembly 2209, respectively. At the loading station 2206, secondary batteries 100 are typically loaded into the battery tray 2202 by a robotic loader (not shown). In other embodiments, secondary batteries 100 are loaded into the battery tray 2202 by a human operator. The charging station 2208 is configured to receive the battery tray 2202 loaded with secondary batteries 100, and to store the loaded battery tray and charge the batteries 100 in the battery tray. The formation station 2210 is configured to receive the formation assembly 2209 including the battery tray 2202 loaded with charged secondary batteries 100, and to store the formation assembly while lithium is diffused to the electrode active materials of the secondary batteries in the battery tray by the pre-lithiation modules 2216. Some embodiments also include a mounting station (not shown) at which the battery tray 2202 is mounted to the formation base 2204. The battery tray 2202 and the formation assembly 2209 may travel between the loading station 2206, the charging station 2208, the formation station 2210, and the mounting station on a conveyer belt or any other suitable conveyance system.

The charging station 2208 includes a rack or shelving system to store the battery tray 2202, as well as electrical connections for providing power to the battery tray to charge the secondary batteries 100 in the battery tray. In some embodiments, the charging station includes charging circuitry to control the charging of the secondary batteries 100, while in other embodiments, the charging circuitry is included in the battery tray 2202 or the formation base 2204. In some embodiments, the charging station 2208 also includes communications connections to allow one or more remote computing devices to control and/or monitor charging of secondary batteries 100 at the charging station 2208.

The formation station 2210 includes a rack or shelving system to store the formation assembly 2209, as well as electrical connections for providing power for the formation process. In some embodiments, the formation station 2210 also includes communications connections to allow one or more remote computing devices to control and/or monitor the formation process at the formation station 2210.

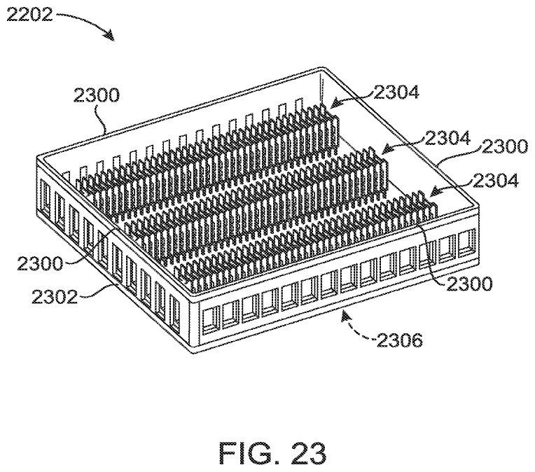

FIG. 23 is a perspective view of an example battery tray that may be used as the battery tray 2202 in the cell formation system 2200 (shown in FIG. 22). The battery tray 2202 includes sides 2300 connected to and extending above a base 2302. In the example embodiment, the battery tray 2202 includes four sides 2300 of approximately equal length, height and thickness. In other embodiments, the battery tray may include more or fewer sides 2300 and/or the sides may vary in one or more of their dimensions. The example battery tray 2202 includes one hundred and twenty battery slots 2212 arranged in three rows 2304 of forty slots each. Other embodiments may include more or fewer total slots 2212 arranged in more or fewer rows 2304. At least one opening (not shown in FIG. 23) is defined through the base 2302 at a location of each slot 2212 to permit the conductive tab 508-1, the first terminal 124, and the second terminal 125 to extend from the slot 2212 through the base of the battery tray 2202 to a position accessible from a bottom side 2306 of the base of the battery tray. The battery tray 2202 includes six first assembly connectors 2213 (not shown in FIG. 23) for matingly engaging a corresponding six second assembly connectors 2218 of the formation base 2204 to mechanically connect the battery tray 2202 to the formation base 2204. Other embodiments may include more or fewer first assembly connectors 2213 and second assembly connectors 2218.

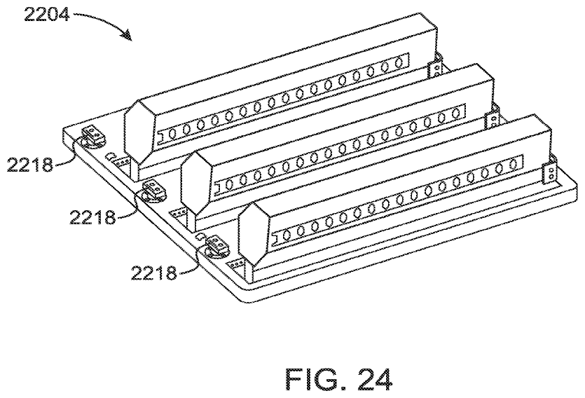

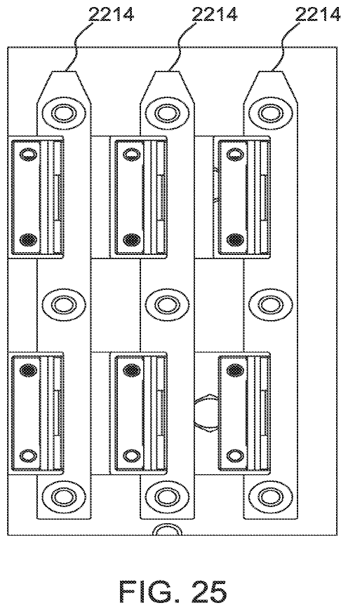

FIG. 24 is a perspective view of an example formation base that may be used as the formation base 2204 in the cell formation system 2200 (shown in FIG. 22). The formation base 2204 includes a same number of connector groups 2214 as the battery tray 2202 has battery slots 2212. Three connector groups 2214 are shown in FIG. 25. The example, formation base 2204 includes six second assembly connectors 2218 (three on each side-only one side is visible in FIG. 24) for matingly engaging the first assembly connectors 2213 of the battery tray 2202 to mechanically connect the battery tray 2202 to the formation base 2204.

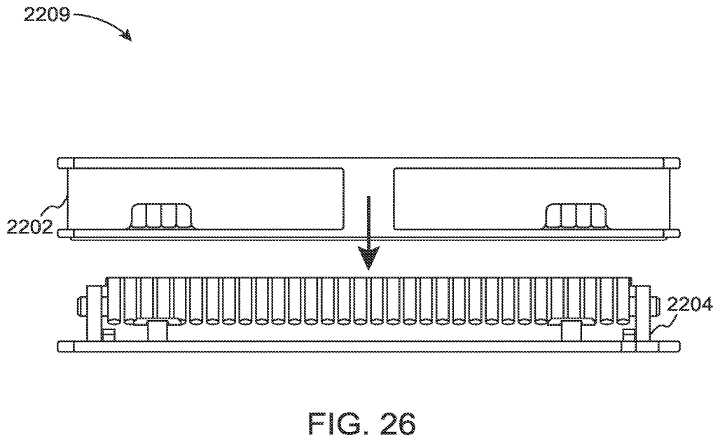

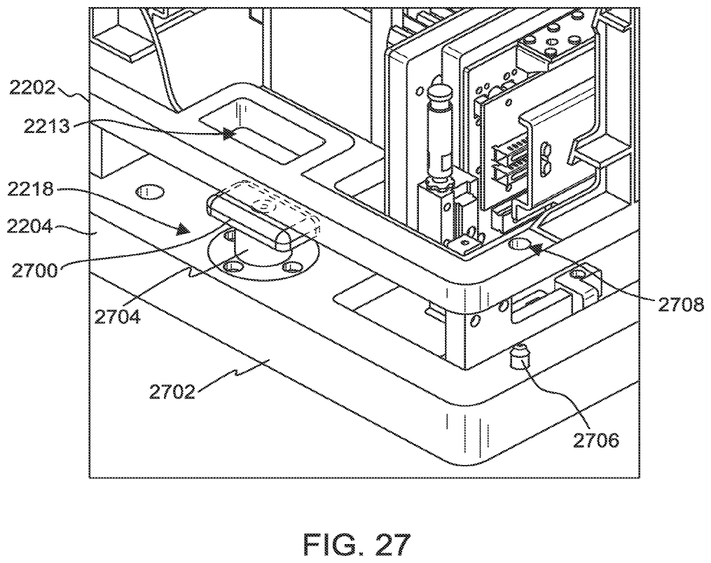

FIG. 26 is a side view of the battery tray 2202 being positioned to attach to the formation base 2204 to form the formation assembly 2209. FIGS. 27-29 show the process of engaging one of the second assembly connectors 2218 of the formation base 2204 and one of the first assembly connectors 2213 of the battery tray 2202. During connection of the battery tray 2202 to the formation base 2204, the same process would occur for each first assembly connector 2213 and second assembly connector 2218. As shown in FIG. 27, the battery tray 2202 is positioned over the formation base 2204 with the first assembly connectors 2213 aligned over the second assembly connectors 2218. In this embodiment, the first assembly connector 2213 is a rectangular opening, and the second assembly connector 2218 includes a rotatable rectangular bar 2700 supported above a base 2702 by a post 2704. The rectangular bar 2700 is sized to fit through the rectangular opening of the first assembly connector 2213, and the post 2704 is sized to be approximately the same height or a slightly greater height above the base 2702 as a thickness of the base 2302 of the battery tray. When beginning assembly of the formation assembly 2209, the second assembly connector 2218 is oriented with the rectangular bar 2700 in a first orientation that will allow it to pass through the rectangular opening of the first assembly connector 2213 when the battery tray is lowered 2202 (or the formation base 2204 is raised) to connect the battery tray 2202 and the formation base 2204. The formation base 2204 also has a population of alignment posts 2706 (only one of which is shown in FIG. 27) that correspond to alignment holes 2708 in the battery tray 2202. When the battery tray 2202 is positioned on the formation base 2204, the alignment posts 2706 pass into the alignment holes 2708 to facilitate aligning the formation base 2204 and the battery tray 2202, and to facilitate limiting movement of the battery tray 2202 relative to the formation base 2204 in a plane parallel to the base 2702.

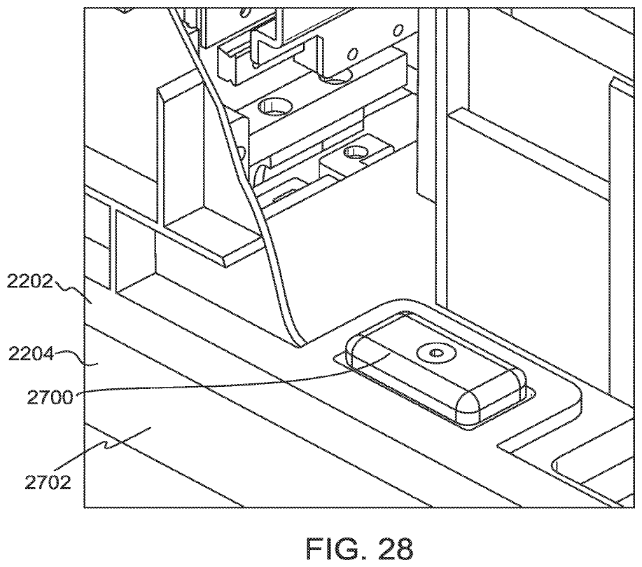

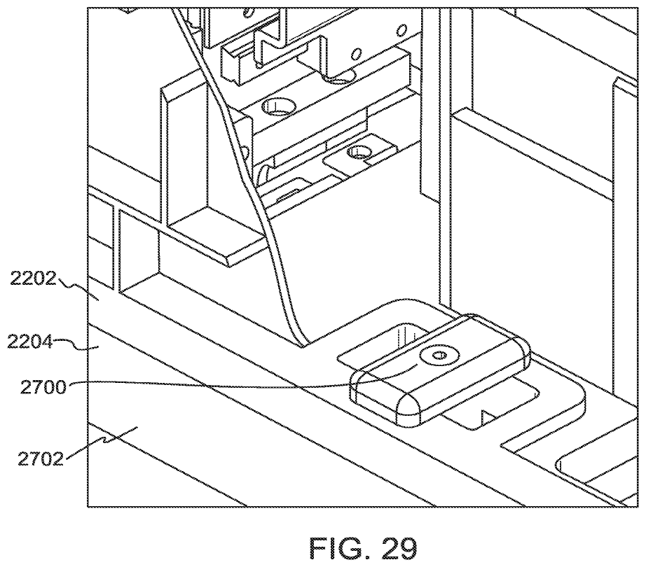

In FIG. 28, the battery tray 2202 has been lowered onto the formation base 2204 and the rectangular bar 2700 of the second assembly connector 2218 has passed through the rectangular opening of the first assembly connector 2213. The rectangular bar 2700 is still in the first orientation at this stage, and the battery tray 2202 may be lifted and removed from the formation base 2204. In FIG. 29, the rectangular bar 2700 has been rotated to a second orientation. In the second orientation, the rectangular bar 2700 of the second assembly connector 2218 cannot pass through the opening of the first assembly connector 2213, thereby securing the battery tray 2202 to the formation base 2204. Although the second orientation is about ninety degrees from the first orientation, the two orientations may differ by any angle sufficient to permit passage of the rectangular bar 2700 through the opening of the first assembly connector 2213 in the first orientation and prevent passage of the rectangular bar 2700 through the opening of the first assembly connector 2213. Other embodiments may use any other suitable types of connectors for the first assembly connector and the second assembly connector.

One example method of cell formation using the cell formation system 2200 will be described below. It should be understood that the cell formation system 2200 may be used for other methods of cell formation as well.

First, a population of lithium based secondary batteries 100 are loaded into the battery tray 2202. Each battery 100 is loaded into a different battery slot 2212 with the conductive tab 508-1, the first terminal 124, and the second terminal 125 extending through the base 2302 of the battery tray to a position accessible from a bottom side of the base of the battery tray. The battery tray 2202 is then transported to the charging station 2208, where the lithium based secondary batteries 100 in the battery tray are charged. The battery tray 2202 is removed from the charging station 2208 and the formation base 2204 is attached to the battery tray from the bottom side of the base 2302 of the battery tray to form the formation assembly 2209. The formation assembly 2209 is transported to the formation station 2210, and the lithium based secondary batteries 100 in the formation assembly 2209 are pre-lithiated using the pre-lithiation modules 2216. The formation base 2204 is removed from the battery tray 2202 after pre-lithiation is complete. One or more additional processes may be performed on the lithium based secondary batteries 100 in the battery tray 2202. The formation base 2204 is returned for re-use while the additional processes are performed. Thus, an additional population of lithium based secondary batteries 100 may be loaded into an additional battery tray 2202, and the process above may be repeated with the additional battery tray 2202 and the formation base 2204.

In some embodiments, the formation process is performed by a distributed formation system (which may include the cell formation system 2200), in which each secondary battery 100 is connected to a separate formation cluster that performs the formation process for the secondary battery 100 to which it is connected. In embodiments using the cell formation system 2200, the separate formation cluster for each secondary battery 100 may be included in the formation base 2204. In such embodiments, charging and discharging may occur with the formation base 2204 attached to the battery tray, or may occur in the battery tray without the formation base 2204 attached (e.g., the charging module and discharging modules may be in the battery tray and the pre-lithiation module may be in the formation base).

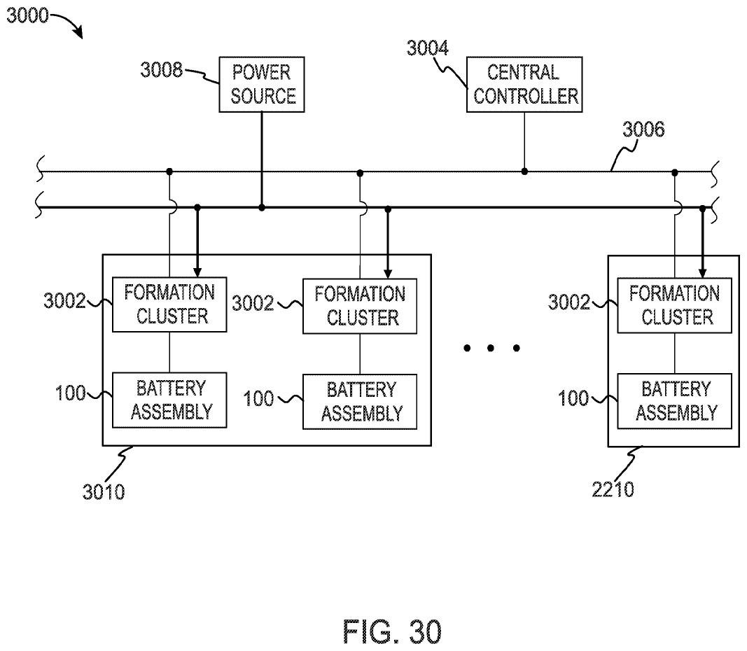

FIG. 30 is a block diagram of an example cell formation system 3000 for lithium based secondary batteries, such as the secondary battery 100. The cell formation system includes a population of formation clusters 3002 and a central controller 3004. Each formation cluster 3002 is connected to a secondary battery 100 and performs the formation process for the secondary battery 100 to which it is connected.

The formation clusters 3002 are communicatively coupled to the central controller 3004 by a network 3006. The network 3006 may be a wired or a wireless network of any type suitable for communication between the formation clusters 3002 and the central controller 3004. For example, the network 3006 may be an inter-integrated circuit (I2C) network, a controller area network (CAN), a local area network (LAN), a wide area network (WAN), or the like. Although shown connected to the same network 3006 in FIG. 30, the formation clusters 3002 and the central controller 3004 may be connected to different networks, or a combination of the same and different networks. For example, some of the formation clusters 3002 may be connected to a first LAN, some of the formation clusters may be connected to a second LAN, and the first and second LAN may be connected to the central controller 3004 through a WAN connected to both the first LAN and the second LAN.

Each formation cluster 3002 is connected to a power source 3008, such as an electrical grid, a generator, a photovoltaic system, a battery, or the like. The formation clusters 3002 use electrical power from the power source 3008 to power the formation cluster and to perform the formation process. Although illustrated connected to the same power source 3008 in FIG. 30, the formation clusters 3002 in the cell formation system 3000 may be connected to different power sources.

Groups of formation clusters 3002 are supported by a housing 3010. The housing 3010 may be an enclosure, such as a cabinet, or an open support, such as a rack. Although two formation clusters 3002 are shown in one housing 3010, and a single formation cluster 3002 is shown in another housing for simplicity, in practice each housing 3010 will typically support a larger number of formation clusters, such as 10, 25, 50, 100, 250, or a 1000 formation clusters. Notably, the central controller 3004 is separate from (and may be remotely located from) the housings 3010 and their formation clusters 3002. Moreover, the housings 3010 may be located in different locations from each other, so long as they are located somewhere with access to the power source 3008 and the network 3006. Further, each housing 3010 may support a different number of formation clusters 3002.

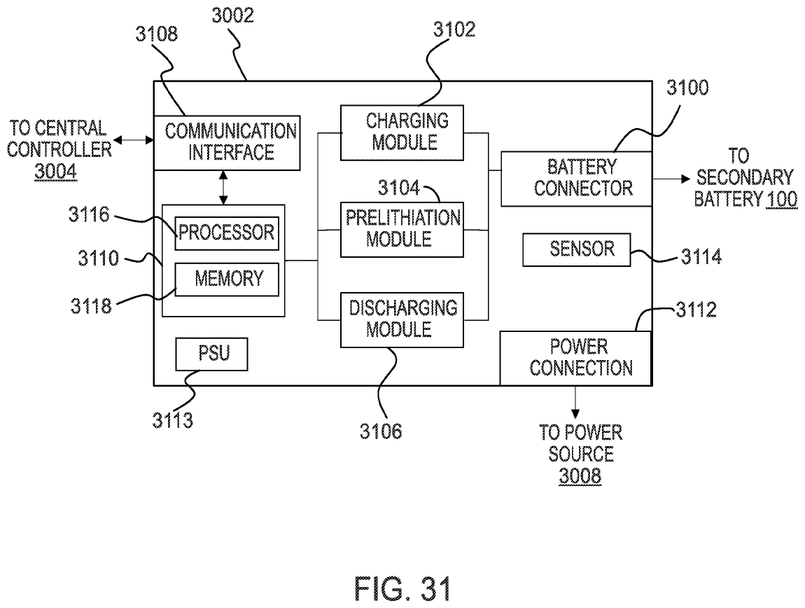

FIG. 31 is a block diagram of an example formation cluster 3002. The formation cluster 3002 includes a battery connector 3100, a charging module 3102, a pre-lithiation module 3104 (sometimes also referred to as a buffer module), a discharging module 3106, a communication interface 3108, a formation cluster controller 3110, a power connection 3112, a power supply unit (PSU) 3113, and a sensor 3114.

The battery connector 3100 connects the formation cluster 3002 to the secondary battery 100. The battery connector 3100 may be any connector suitable for connection to the secondary battery 100, including a connector configured to mate with a similar connector on the battery, a clamping connector (such as an alligator clip), a wire soldered or welded to the secondary battery and the formation cluster 3002, and the like. The battery connector 3100 is configured to connect to the anode and the cathode of the secondary battery 100. In some embodiments, the battery connector 3100 also electrically connects the formation cluster 3002 to the auxiliary electrode 502. In other embodiments, the formation cluster 3002 includes a separate connector, referred to as a pre-lithiation connector, that electrically connects the formation cluster 3002 to the auxiliary electrode 502. In some embodiments, the formation cluster 3002 includes more than one battery connector 3100, with each battery connector connected to a separate one of the modules of the formation cluster (e.g., the charging module 3102, the pre-lithiation module 3104, and the discharging module 3106).

The charging module 3102 is connected to the battery connector 3100 and is configured to charge the secondary battery 100 connected to the battery connector 3100. The pre-lithiation module 3104 is connected to the battery connector 3100 and configured to diffuse lithium carrier ions to the electrode active material layers (e.g., the cathodically active material layers 106 and/or the anodically active material layers 104) of the secondary battery 100. The discharging module 3106 is connected to the battery connector 3100 and is configured to discharge the secondary battery 100.

The communication interface 3108 connects the formation cluster 3002 to the central controller 3004. The communication interface 3108 may be any wired or wireless communications interface that permits the controller 3110 to communicate with the central controller 3004 directly or via a network. Wireless communication interfaces 3108 may include a radio frequency (RF) transceiver, a Bluetooth® adapter, a Wi-Fi transceiver, a ZigBee® transceiver, an infrared (IR) transceiver, and/or any other device and communication protocol for wireless communication. (Bluetooth is a registered trademark of Bluetooth Special Interest Group of Kirkland, Washington; ZigBee is a registered trademark of the ZigBee Alliance of San Ramon, California.) Wired communication interfaces 3108 may use any suitable wired communication protocol for direct communication including, without limitation, USB, RS232, I2C, SPI, analog, and proprietary I/O protocols. In some embodiments, the wired communication interface 3108 includes a wired network adapter allowing the controller 3110 to be coupled to a network, such as the Internet, a local area network (LAN), a wide area network (WAN), a mesh network, and/or any other network to communicate with remote devices and systems via the network.

The formation cluster controller 3110 controls the operation of the formation cluster 3002 to operate as described herein. The formation cluster controller 3110 includes a processor 3116 and a memory 3118. The processor 3116 is any programmable system including a microcontroller, microcomputer, microprocessor, reduced instruction set circuit (RISC), application specific integrated circuit (ASIC), programmable logic circuit (PLC), and any other circuit or processor capable of executing the functions described herein. The memory 3118 stores computer-readable instructions executable by the processor 3116 for control of the formation cluster 3002 as described herein. The memory 3118 may be any suitable type of memory including, but not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). In some embodiments, the processor 3116 and the memory 3118 are both embodied in a microcontroller, while in other embodiments the processor 3116 and the memory 3118 are separate components.

In the example embodiment, the formation cluster controller 3110 is programmed (by instruction stored in the memory 3118) to directly control each of the modules 3102, 3104, and 3106. That is, the formation cluster controller 3110 is programmed to control the charging module to charge the secondary battery 100, to control the pre-lithiation module 3104 to pre-lithiate (also referred to as buffering) the secondary battery 100, and to control the discharging module 3106 to discharge the secondary battery 100. The formation cluster controller 3110 is also programmed to control the overall formation process, such as when to use each of the modules 3102, 3104, and 3106.

In other embodiments one or more of the modules 3102, 3104, and 3106 includes its own module controller (having a processor and memory). In such embodiments, the formation cluster controller 3110 controls the overall formation process, but the module controllers control the specific tasks of their modules. For example, the formation cluster controller 3110 may instruct the charging module 3102 to charge the secondary battery 100, and the module controller in the charging module will then control the charging module to charge the secondary battery 100 according to instructions stored in the memory of the charging module's module controller.

In further embodiments, the formation cluster 3002 does not include the formation cluster controller 3110. Rather, each of the modules 3102, 3104, and 3106 includes its own module controller. In such embodiments, the central controller 3004 controls the overall formation process and sends instructions to the module controllers through the communication interface 3108. In such embodiments, the multiple module controllers in the formation cluster 3002 may be considered as a distributed formation cluster controller 3110.

Various levels of interaction and control may be performed by the central controller 3004 and the formation cluster controller 3110 in different embodiments. For example, in some embodiments, the central controller 3004 merely sends instructions to the formation cluster 3002 to begin the formation process. Then, in response to the instructions, the formation cluster controller 3110 controls the modules 3102, 3104, 3106 to perform the formation process. Alternatively, in response to the instructions, the formation cluster controller 3110, may instruct the modules 3102, 3104, 3106 to perform their respective functions at the appropriate times. In other embodiments, the central controller 3004 sends instructions to the formation clusters 3002 to perform an individual portion of the formation process (e.g., “charge the battery now”), and the formation cluster controller 3110 or the module controllers perform the task commanded by the central controller. In some embodiments, the central controller 3004 may send instructions to the formation clusters 3002 for how to perform one or more of the formation tasks, including sending control algorithms. In some embodiments, the formation cluster controller 3110 or the module controller may store instructions for multiple ways of performing the same task (e.g., a fast charge, a slow charge, a charge with a rest period, and the like), and the central controller's instructions may instruct the formation cluster 3002 which method to use.

In some embodiments, the central controller 3004 may program or update the programming of the formation cluster controller 3110 or the module controllers. For example, the central controller 3004 may send control algorithms to the formation cluster 3002, and the formation cluster controller 3110 and/or the module controllers may store the control algorithms in their respective memories. In other embodiments, the central controller may send a modification of a control algorithm already stored in the formation cluster, such as a change to a variable, a change in timing, or the like. The formation cluster controller 3110 or the controller modules then store the modification in memory for use in the formation process.

The formation cluster controller 3110 also transmits information back to the central controller 3004 in some embodiments. The information sent to the central controller 3004 may include confirmation that instructions were received, confirmation that a commanded process has begun, status of the operations being performed, data collected from the sensor 3114, or any other suitable information.

The power connection 3112 connects the formation cluster 3002 to the power source 3008. The power connection 3112 may be any connector suitable for connection to the power source 3008, including a plug configured for insertion into a mating socket of the power source, a wire soldered or welded to the power source, a clamping connector for clamping onto a terminal or wire of the power source, or the like. The PSU 3113 converts and/or distributes power from the power source to the rest of the formation cluster 3002 for use in the formation process. The PSU 3113 may be an AC/DC power converter, a DC/DC power converter, an inverter, or any other unit for suitable for converting and/or distributing power to the formation cluster. Some embodiments do not include a PSU, and utilize power from the power source 3008 directly.

The sensor 3114 is any sensor capable of monitoring a variable of interest to the formation process. For example, the sensor 3114 may be a voltage sensor for monitoring the voltage of the secondary battery 100, an ambient temperature sensor for monitoring the temperature around the formation cluster 3002, a temperature sensor for monitoring the temperature of the battery secondary or a component of the formation cluster, a current sensor for monitoring current flowing into, out of, or through the secondary, etc. Some embodiments include more than one sensor 3114, including combinations of the sensors described above. Moreover, some sensors 3114 may perform more than one of the above-described monitoring tasks.

The modular and distributed nature of the cell formation system 3000 allows for the system to be easily expanded or contracted as desired. Unlike traditional centralized systems that are configured for formation of a set number of batteries at one time, the system 3000 may be expanded to any number of batteries simply by adding more formation clusters 3002 (including increasing the number of batteries by as few as one additional battery). With a traditional centralized system, increases to the number of batteries to be formed would require acquisition of an additional system and an increase by some set number of batteries (determined by the size and configuration of the centralized system acquired). Further, centralized systems typically require running significant additional wiring for each additional battery in order to provide controlled power and communication to the additional batteries. In contrast, the cell formation system 3000 merely requires connecting additional formation clusters 3002 to a power source and an already existing communication network. The formation clusters 3002 in the system 3000 need not all be the same, so long as the central controller 3004 knows the configuration of each formation cluster 3002. Moreover, the formation clusters 3002 in the system 3000 may be used to form different batteries, either at different times or at the same time, so long as the central controller 3004 or the formation cluster controller 3110 knows what secondary battery 100 is connected to the formation cluster 3002.

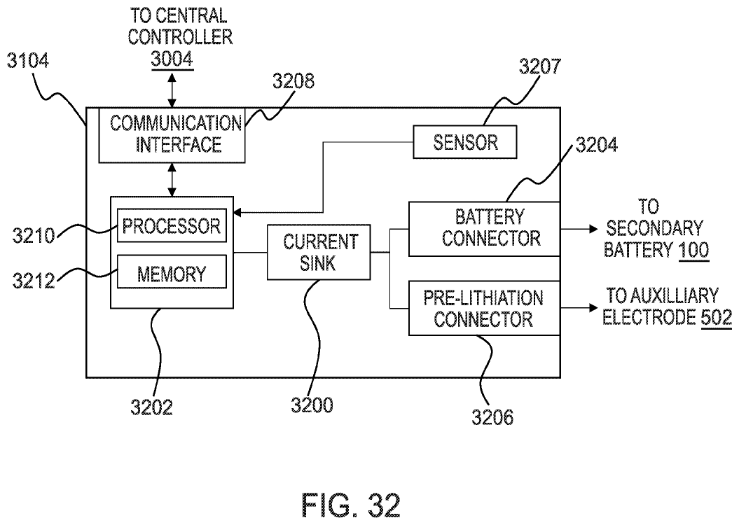

FIG. 32 is a block diagram of an example pre-lithiation module 3104 for use in the cell formation clusters 3002, as part of a different formation system, as a standalone pre-lithiation module, or the like. As described above, the pre-lithiation module 3104 is configured to diffuse lithium to the electrode active material layers (e.g., the cathodically active material layers 106 and/or the anodically active material layers 104) of the secondary battery 100. The pre-lithiation module 3104 includes a controlled current sink 3200, a pre-lithiation module controller 3202, a battery connector 3204, a pre-lithiation connector 3206, one or more sensors 3207, and a communication interface 3208.

The current sink 3200 is controlled by the pre-lithiation module controller 3202 to selectively conduct current between the auxiliary electrode 502 and one of the electrodes (e.g., one of the positive electrode 208 and the negative electrode 209) of the secondary battery 100 to diffuse lithium from the auxiliary electrode to the electrode active material layers (e.g., the cathodically active material layers 106 or the anodically active material layers 104) of the secondary battery 100. In an example embodiment, the current sink 3200 is a linear current regulator. In other embodiments, any other suitable controllable current sink may be used as the current sink 3200.

The pre-lithiation module controller 3202 controls operation of the pre-lithiation module 3104 pre-lithiate the secondary battery 100 by selectively conducting current through the auxiliary electrode 502 to diffuse lithium to the electrode active material layers of the secondary battery. The pre-lithiation module controller 3202 includes a processor 3210 and a memory 3212. The memory 3212 stores instructions that, when executed by the processor 3210 cause the processor to perform the pre-lithiation as described herein. The processor 3210 is any programmable system including a microcontroller, microcomputer, microprocessor, reduced instruction set circuit (RISC), application specific integrated circuit (ASIC), programmable logic circuit (PLC), field-programmable gate array (FPGA), and any other circuit or processor capable of executing the functions described herein. The memory 3212 may be any suitable type of memory including, but not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). In some embodiments, the processor 3210 and the memory 3212 are both embodied in a microcontroller, while in other embodiments the processor and the memory are separate components.

The battery connector 3204 connects the pre-lithiation module 3104 to the secondary battery 100. The battery connector 3204 may be the battery connector 3100 or may be a separate battery connector connected only to the pre-lithiation module 3104. The battery connector 3204 may be any connector suitable for connection to the secondary battery 100, including a connector configured to mate with a similar connector on the secondary battery, a clamping connector (such as an alligator clip), a wire soldered or welded to the secondary battery and the pre-lithiation module 3104, and the like. The battery connector 3204 is configured to connect to the anode (e.g., the negative electrode 209) and the cathode (e.g., the positive electrode 208) of the secondary battery 100.

The pre-lithiation connector 3206 connects the pre-lithiation module 3104 to the auxiliary electrode 502 of the secondary battery 100. The pre-lithiation connector 3204 may be any connector suitable for connection to the secondary battery 100, including a connector configured to mate with a similar connector on the battery, a clamping connector (such as an alligator clip), a wire soldered or welded to the secondary battery and the pre-lithiation module 3104, and the like. In some embodiments, the pre-lithiation connector 3206 is part of the battery connector 3100.

The sensors 3207 include sensors to monitor the pre-lithiation of the secondary battery 100 by the pre-lithiation module 3104. In the example embodiment, the sensors 3207 include voltage sensors to monitor voltages of the secondary battery 100 and the auxiliary electrode 502, as will be described in more detail below. The sensors 3207 may include temperature sensors for monitoring the ambient temperature around the secondary battery 100 and/or the temperature of the secondary battery, current sensors for monitoring current flowing through the secondary battery, or any other suitable sensors for monitoring the secondary battery or the pre-lithiation process. The sensors 3207 may include or may be connected to the pre-lithiation module controller 3202 through one or more other components, such as amplifiers, analog to digital converters (ADCs), filters, signal processors, or the like.

The communication interface 3208 connects the pre-lithiation module 3104 to the central controller 3004. The communication interface 3208 may be the communication interface 3108 or may be a separate communication interface. The communication interface 3208 may allow the pre-lithiation module 3104 to communicate directly with the central controller 3004, or it may allow the pre-lithiation module 3104 to communicate indirectly with the central controller, such as via the formation cluster controller 3110. The communication interface 3208 may be any wired or wireless communications interface that permits the controller 3202 to communicate with the communication central controller 3004 directly or via a network. Wireless communication interfaces 3208 may include a radio frequency (RF) transceiver, a Bluetooth® adapter, a Wi-Fi transceiver, a ZigBee® transceiver, an infrared (IR) transceiver, and/or any other device and communication protocol for wireless communication. (Bluetooth is a registered trademark of Bluetooth Special Interest Group of Kirkland, Washington; ZigBee is a registered trademark of the ZigBee Alliance of San Ramon, California). Wired communication interfaces 3208 may use any suitable wired communication protocol for direct communication including, without limitation, USB, RS232, I2C, SPI, analog, and proprietary I/O protocols. In some embodiments, the wired communication interface 3108 includes a wired network adapter allowing the controller 3202 to be coupled to a network, such as the Internet, a local area network (LAN), a wide area network (WAN), a mesh network, and/or any other network to communicate with remote devices and systems via the network.

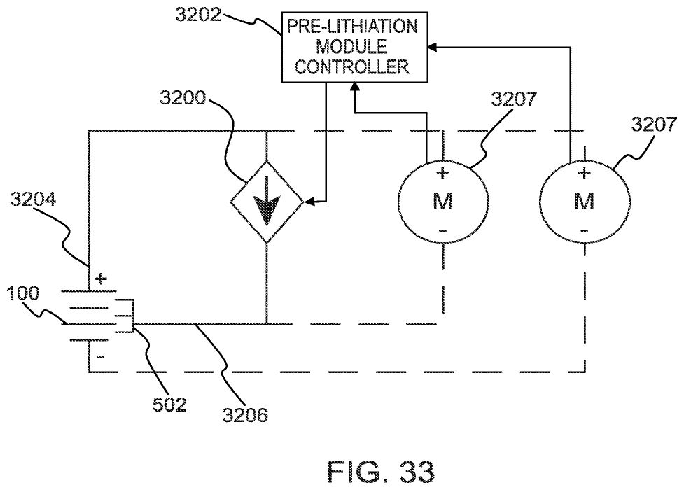

FIG. 33 is a simplified circuit diagram of an example embodiment of the pre-lithiation module 3104 connected to the secondary battery 100 and the auxiliary electrode 502. The sensors 3207 are voltage sensors configured to monitor a first voltage between the cathode (e.g., the positive electrode 208) of the secondary battery 100 and the auxiliary electrode 502, and a second voltage between the cathode and the anode (e.g., the negative electrode 209) of the secondary battery. In some embodiments, a sensor 3207 may additionally or alternatively monitor the voltage between the auxiliary electrode 502 and the anode of the secondary battery 100. Other embodiments may monitor more or fewer voltages and/or different combinations of voltages. The connection to the anode and/or cathode of the secondary battery 100 may be a connection directly or indirectly to the current collectors (e.g., the anode current collectors 202 and cathode current collectors 204) or to the respective busbars (e.g., the first and second busbars 110, 112).

The pre-lithiation module controller 3202 controls the current sink 3200 to pre-lithiate the secondary battery 100 according to a control algorithm stored in its memory 3212. Specifically, the pre-lithiation module controller 3202 adjusts the amplitude of the current through the current sink 3200 according to the control algorithm.

In a first embodiment, the control algorithm is a pulsed control algorithm. The pre-lithiation module controller 3202 drives the current sink 3200 to conduct a current between the cathode of the secondary battery 100 and the auxiliary electrode 502 for a first predetermined time. After the predetermined time, the pre-lithiation module controller 3202 turns off the current sink 3200 for a second predetermined time. In the example embodiment, the first and second predetermined times are the same length of time, resulting in a fifty percent duty cycle for the pulsed current provided by the current sink 3200. In other embodiments, the first and second predetermined times are not equal. In some embodiments, the first and second predetermined times are both about 15 seconds. In other embodiments, the first and second predetermined times may be longer or shorter than 15 seconds. In some embodiments, the first and second predetermined times are selectable/configurable by an operator. While the current sink 3200 is off, the pre-lithiation module controller 3202 samples the cathode to auxiliary electrode voltage (the first voltage) and the cathode to anode voltage (the second voltage) using the sensors 3207. The pre-lithiation module controller 3202 compares the first and second voltage and adjusts the amplitude of the current provided by the current sink 3200 (if needed) to attempt to minimize the different between the two voltages. The pre-lithiation module controller 3202 then begins to drive the current sink 3200 again and the process repeats. In the example embodiment, the process repeats until the first voltage decreases below a predetermined voltage threshold. In other embodiments, the process repeats for a predetermined length of time, a predetermined number of cycles, or until the current drops to a minimum level and stays there for a predetermined length of time.

In another example, the control algorithm does not pulse the current between the cathode of the secondary battery 100 and the auxiliary electrode 502 and attempts to maintain the voltage from the auxiliary electrode 502 to the anode of the secondary battery 100 at a small negative value. In this example, the pre-lithiation module controller 3202 drives the current sink 3200 to conduct a current between the cathode of the secondary battery 100 and the auxiliary electrode 502. While current is being conducted, the pre-lithiation module controller 3202 samples the cathode to auxiliary electrode voltage (the first voltage) and the cathode to anode voltage (the second voltage) using the sensors 3207.

The pre-lithiation module controller 3202 compares the first and second voltage and adjusts the amplitude of the current provided by the current sink 3200 (if needed) to maintain the voltage from the auxiliary electrode 502 to the anode of the secondary battery 100 at a small negative value. The small negative voltage may be predetermined. In an example embodiment, the small negative value is about negative ten millivolts. In other embodiments, the small negative voltage may be about negative ten millivolts, about negative nine millivolts, about negative eight millivolts, about negative seven millivolts, about negative six millivolts, about negative five millivolts, about negative four millivolts, about negative three millivolts, about negative two millivolts, or about negative one millivolts. The predetermined negative voltage may, in some embodiments, be greater than about negative ten millivolts. In some embodiments, the pre-lithiation module controller 3002 may selectively adjust the amplitude of the current provided by the current sink 3200 to maintain the voltage from the auxiliary electrode 502 to the anode of the secondary battery 100 at a voltage between zero volts and the predetermined negative voltage. In other embodiments, any other suitable negative voltage value may be used. By preventing this voltage from becoming positive, the possibility of lithium from the auxiliary electrode 502 unintentionally plating other components in the secondary battery 100 (such as casing/constraint 116) may be avoided.

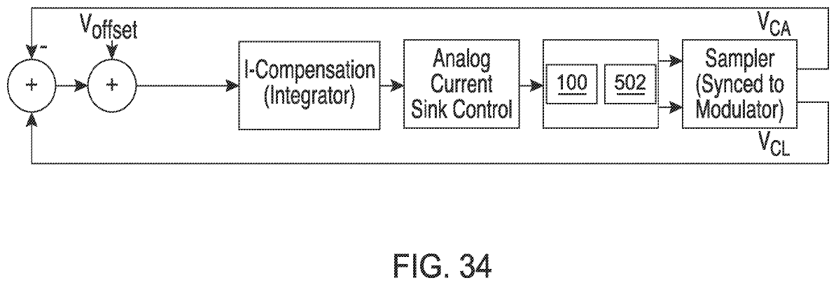

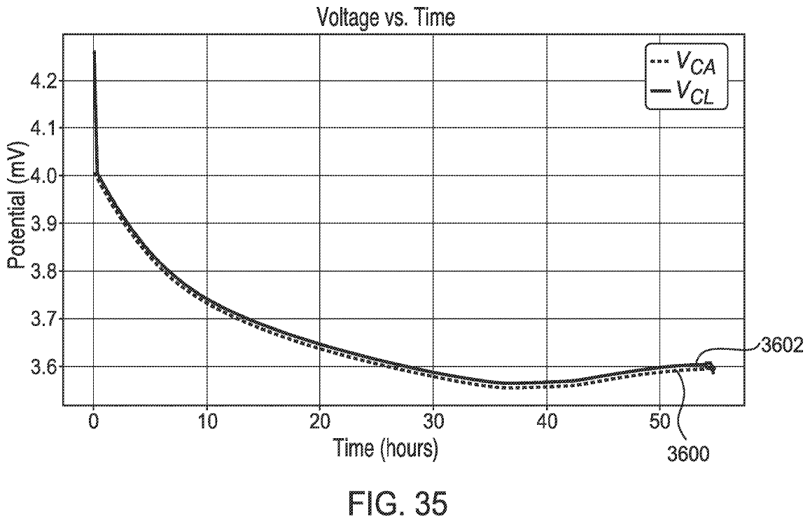

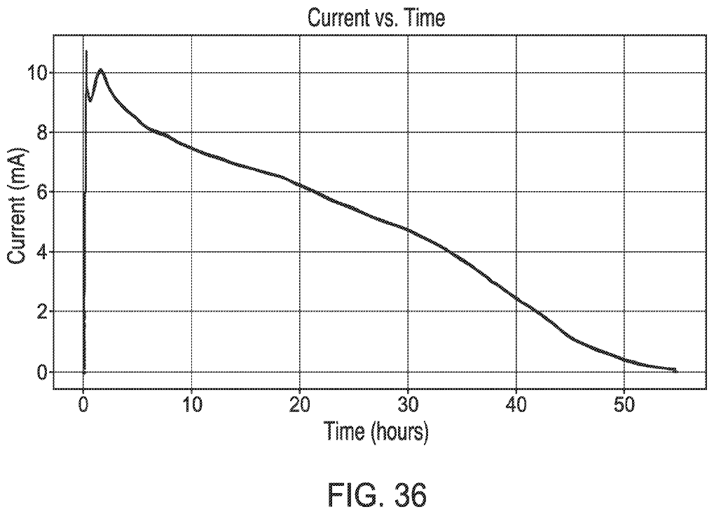

FIG. 34 is a signal flow graph of this example algorithm. In the Figure, V_{CA} is the second voltage, V_{CL} is the first voltage, and V_{offset} is the desired small negative voltage for the voltage from the auxiliary electrode 502 to the anode of the secondary battery 100. FIG. 35 is a graph of the first and second voltages as a function of time during pre-lithiation according to this example control algorithm. As shown, the pre-lithiation module controller 3202 controls the current using the current sink 3200 to keep the second voltage (trace 3600) about ten millivolts below the first voltage (trace 3602). As a result, the voltage from the auxiliary electrode 502 to the anode of the secondary battery 100 (e.g., the second voltage minus the first voltage) is about negative ten millivolts. In other embodiments, the voltage from the auxiliary electrode 502 to the anode of the secondary battery 100 may be measured directly and the current sink 3200 may be controlled to maintain the directly measured voltage from the auxiliary electrode to the anode at the desired small negative voltage (with or without also measuring the first and second voltages). FIG. 36 is a graph of the current from the cathode of the secondary battery 100 to the auxiliary electrode 502 during pre-lithiation according to this example control algorithm. As shown, the current begins at a relatively high value (around 10 milliamps) and decreases over time. That is, less current is needed to maintain the small negative voltage from the auxiliary electrode 502 to the anode of the secondary battery 100 as time progresses and lithium is distributed from the auxiliary electrode. In some embodiments, this decreasing current is used to determine when to stop the pre-lithiation process. In such embodiments, the current is periodically measured and the process is stopped when the current decreases below a threshold value, such as below 1 milliamps (mA), 500 microamps (μA), 250 μA, 100 μA, or the like for a predetermined length of time. In other embodiments, the process repeats until the first voltage decreases below a predetermined voltage threshold. In other embodiments, the process repeats for a predetermined length of time, a predetermined number of cycles, or until the current drops to a minimum level and stays there for a predetermined length of time.

The speed of the pre-lithiation process may be increased by decreasing (relative to the embodiment above) the voltage difference between the auxiliary electrode 502 and the anode of the secondary battery 100 to zero volts or a smaller negative value. The small negative value between the auxiliary electrode and the anode in the above examples is used (rather than 0 volts) in part as an offset to accommodate component tolerances and offsets, drift, and temperature based fluctuations (generally referred to sometimes as measurement error) affecting the pre-lithiation circuitry, such as pre-lithiation module 3202, that could result in a positive voltage from the auxiliary electrode to the anode of no offset were used. At least some of the following examples are operable to determine the measurement error and compensate for it in the control of the prelithiation process, thereby allowing prelithiation to be controlled with a smaller negative voltage (or a zero voltage) difference between the auxiliary electrode 502 and the anode of the secondary battery 100.

One example method of pre-lithiating a lithium based secondary battery (e.g., the secondary battery 100) with such a decreased voltage difference includes connecting a current sink (e.g., the current sink 3200) to an electrode (e.g., the positive electrode 208) and a source of lithium carrier ions (e.g., the auxiliary electrode 502) and controlling the current sink to conduct a current from the electrode through the auxiliary electrode to diffuse lithium from the auxiliary electrode to electrode active material layers of the lithium based secondary battery. The method includes periodically detecting a voltage between the auxiliary electrode and a counter-electrode (e.g., the negative electrode 208) periodically determining an adjustment to the voltage. The current sink is then controlled to control an amplitude of the current from the electrode through the auxiliary electrode to cause a sum of the voltage and the adjustment to be about zero volts. The connections to the electrode and counter-electrode by be by connection directly or indirectly to the current collectors (e.g., the anode current collectors 202 and cathode current collectors 204) or to the respective busbars (e.g., the first and second busbars 110, 112).

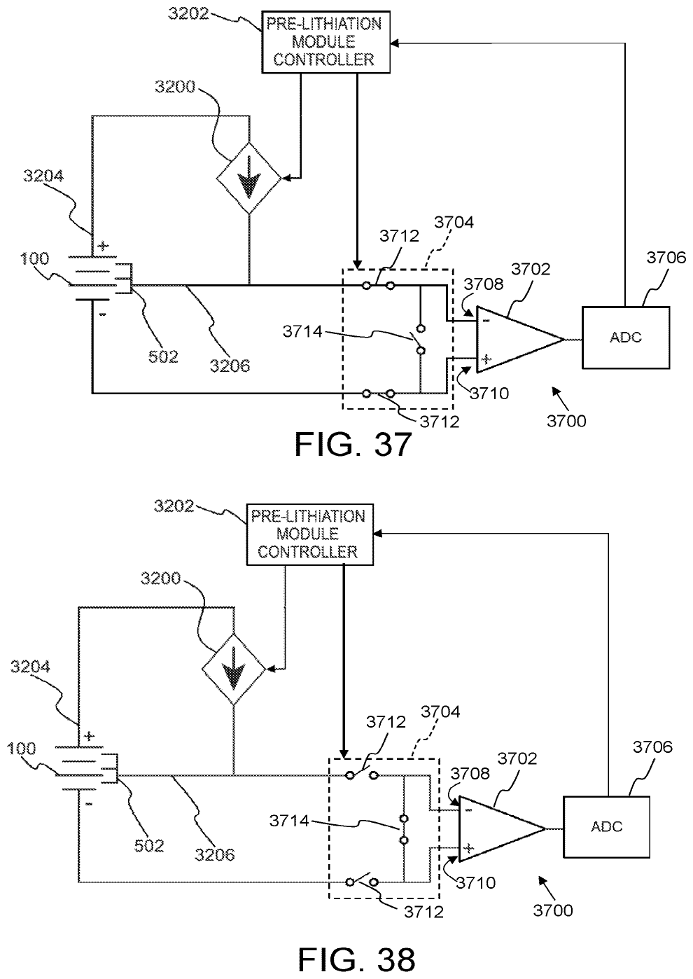

FIGS. 37 and 38 are simplified circuit diagrams of two different operational states of another example embodiment of the pre-lithiation module 3104 connected to the secondary battery 100 and the auxiliary electrode 502 that may be used to perform lithiation according to the above method to decrease the voltage difference between the from the auxiliary electrode 502 to the anode of the secondary battery 100 during prelithiation. Components of the embodiment shown in FIG. 37 that are shared with the embodiments above are identified by the same reference numerals and function in the same way, except as otherwise described below.

A detection circuit 3700 is an example sensor 3207 configured to monitor a voltage between the auxiliary electrode 502 and the anode (e.g., the negative electrode 209) of the secondary battery 100. In some embodiments, a second sensor 3207 may additionally monitor the voltage between the voltage between the cathode (e.g., the positive electrode 208) of the secondary battery 100 and the auxiliary electrode 502 of the secondary battery 100. The connection to the anode and/or cathode of the secondary battery 100 may be a connection directly or indirectly to the current collectors (e.g., the anode current collectors 202 and cathode current collectors 204) or to the respective busbars (e.g., the first and second busbars 110, 112).

The detection circuit 3700 includes an amplifier 3702 and a switch circuit 3704. The detection circuit uses an analog to digital converter (ADC) 3706, which may be a part of the detection circuit or may be a part of the pre-litionation module separate from the detection circuit. The amplifier may be an op-amp or any other amplifier suitable for providing an amplified voltage signal from an input voltage appropriate to a secondary battery. The example amplifier includes a first input 3708 and a second input 3710. The first input 3708 is coupled to the auxiliary electrode through the switch circuit. The second input 3710 is coupled to the anode of the secondary battery 100 through the switch circuit. In embodiments in which the amplifier is an op-amp, the first input is an inverting input of the amplifier and the second input is the non-inverting input of the amplifier.

The switch circuit 3704 includes a pair of first switches 3712 and a second switch 3714. The switch circuit is controlled by the pre-lithiation module controller 3202. The first switches are switched together (e.g., both on/closed or both off/open). The second switch is generally switched opposite of the first switches. That is, when the first switches are closed, the second switch is open. When transitioning which of the first switches and the second switch are opened/closed, there will be an overlap when all switches in the switch circuit are open in some embodiments to avoid the possibility of all three switches being closed at the same time. Thus, for example, when the first switches are closed, the second switch is open, and it is determined to open the first switches and close the second switch, the first switches are opened first and the second switch is only closed after the first switches are opened. The first switches selectively couple the first input 3708 to the auxiliary electrode 502 and the second input 3710 to the anode of the secondary battery. When the first switches are closed/on, the first input 3708 is electrically connected to the auxiliary electrode 502 and the second input 3710 is electrically connected to the anode of the secondary battery 100, and when the first switches are open/off, the first input 3708 is electrically disconnected from the auxiliary electrode 502 and the second input 3710 is electrically disconnected from the anode of the secondary battery 100. The second switch connects the first input to the second input. When the second switch is closed, the first input and the second input are electrically connected, and when the second switch is open, the first input and the second input are electrically disconnected. FIG. 37 shows the pre-lithiation module 3104 in a first operational state with the first switches closed and the second switch open, and FIG. 38 shows the pre-lithiation module 3104 in a second operational state with the first switches open and the second switch closed.

In the first operational state (FIG. 37), the detection circuit 3700 outputs the voltage between the auxiliary electrode 502 and the anode of the secondary battery 100 to the pre-lithiation module controller 3202 and the pre-lithiation module controller samples the voltage. In the second operational state (FIG. 38), the detection circuit 3700 outputs a voltage offset of the amplifier 3702 to the pre-lithiation module controlled 3202 and the pre-lithiation module controller samples the voltage offset.

When pre-lithiating the secondary battery 100 using the embodiments of the pre-lithiation module shown in FIGS. 37 and 38, the pre-lithiation module controller 3202 generally uses the current sink to pre-lithiate the battery 100 as described above, but periodically checks the voltage offset of the amplifier and adjusts the pre-lithiation based on the sampled voltage offset. For example, in a first embodiment, pre-lithiation module controller 3202 uses a pulsed control algorithm. The pre-lithiation module controller 3202 drives the current sink 3200 to conduct a current between the cathode of the secondary battery 100 and the auxiliary electrode 502 for a first predetermined time. After the predetermined time, the pre-lithiation module controller 3202 turns off the current sink 3200 for a second predetermined time. In the example embodiment, the first and second predetermined times are the same length of time, resulting in a fifty percent duty cycle for the pulsed current provided by the current sink 3200. In other embodiments, the first and second predetermined times are not equal. In some embodiments, the first and second predetermined times are both about 15 seconds. In other embodiments, the first and second predetermined times may be longer or shorter than 15 seconds. In some embodiments, the first and second predetermined times are selectable/configurable by an operator. While the current sink 3200 is off, the pre-lithiation module controller 3202 samples the auxiliary electrode to anode voltage using the detection module 3704 with in a first operational state (FIG. 37) with the first switches closed and the second switch open. The pre-lithiation module controller 3202 then samples the voltage offset of the amplifier 3792 using the detection module 3704 with in a second operational state with the first switches open and the second switch closed. The voltage offset is used as an adjustment to the sampled voltage from the auxiliary electrode to anode. The pre-lithiation module controller 3202 adjusts the amplitude of the current provided by the current sink 3200 (if needed) to attempt to cause the sum of the sampled auxiliary electrode to anode voltage and the voltage offset (the adjustment) to be about zero volts or a very small negative voltage. The pre-lithiation module controller 3202 then begins to drive the current sink 3200 again and the process repeats until pre-lithiation is completed. In other embodiments, the voltage offset is sampled while the current sink is conducting current and samples the auxiliary electrode to anode voltage when the current sink is not conducting current. In still other embodiments, the auxiliary electrode to anode voltage and the voltage offset are sampled periodically during any suitable times. In the example embodiment, the values are sampled every cycle, in other embodiments, they may be sampled less than every cycle of the pulsed prelithiation (e.g., every other cycle, every fifth cycle, every tenth cycle, or the like). Moreover, in some embodiments, the auxiliary electrode to anode voltage is sampled more frequently than the voltage offset. For example, the current auxiliary electrode to anode voltage may be sampled every cycle and the voltage offset may be sampled less than every cycle (e.g., the every other cycle, every fifth cycle, every tenth cycle, once every thirty seconds, once every minute, or the like) and the last sampled voltage offset may be used as the adjustment until the voltage offset is sampled again. In such embodiments, the pre-lithiation module controller controls the amplitude of the current provided by the current sink to attempt to cause the sum of the current auxiliary electrode to anode voltage and last sampled voltage offset to be about zero volts or a very small negative voltage.

In another example, the control algorithm does not pulse the current between the cathode of the secondary battery 100 and the auxiliary electrode 502 and attempts to maintain a sum of the voltage offset and the voltage from the auxiliary electrode 502 to the anode of the secondary battery 100 close to zero or a small negative value. In this example, the pre-lithiation module controller 3202 drives the current sink 3200 to conduct a current between the cathode of the secondary battery 100 and the auxiliary electrode 502. While current is being conducted, the pre-lithiation module controller 3202 samples the auxiliary electrode to anode voltage using the detection module 3704 with in a first operational state (FIG. 37) with the first switches closed and the second switch open. The pre-lithiation module controller 3202 then samples the voltage offset of the amplifier 3792 using the detection module 3704 with in a second operational state (FIG. 38) with the first switches open and the second switch closed. The voltage offset is used as an adjustment to the sampled voltage from the auxiliary electrode to anode. The pre-lithiation module controller 3202 adjusts the amplitude of the current provided by the current sink 3200 (if needed) to attempt to cause the sum of the sampled auxiliary electrode to anode voltage and the voltage offset (the adjustment) to be about zero volts or a very small negative voltage. The auxiliary electrode to anode voltage and the voltage offset are sampled periodically during any suitable times. In the example embodiment, the values at similar intervals (e.g., twice a second, once every second, once every ten seconds, once every thirty seconds, or the like). Moreover, in some embodiments, the auxiliary electrode to anode voltage is sampled more frequently than the voltage offset. For example, the current auxiliary electrode to anode voltage may be sampled at a first interval (e.g, twice a second, once every second, once every ten seconds, once every thirty seconds, or the like) and the voltage offset may be sampled at a second interval longer than the first interval (e.g., twice the first interval, five times the first interval, ten times the first interval, thirty times the first interval, sixty times the first interval, or the like) and the last sampled voltage offset may be used as the adjustment until the voltage offset is sampled again. In such embodiments, the pre-lithiation module controller controls the amplitude of the current provided by the current sink to attempt to cause the sum of the current auxiliary electrode to anode voltage and last sampled voltage offset to be about zero volts or a very small negative voltage.

In the example control algorithms described above, the pre-lithiation module controller 3202 adjusts the amplitude of the current provided by the current sink 3200 (if needed) to maintain the voltage from the auxiliary electrode 502 to the anode of the secondary battery 100 at about zero or at or below a very small negative value. The very small negative voltage may be predetermined. In an example embodiment, the very small negative value is less than about negative ten millivolts. In other embodiments, the very small negative voltage may be about or less than about negative nine millivolts, negative eight millivolts, negative seven millivolts, negative six millivolts, negative five millivolts, negative four millivolts, negative three millivolts, negative two millivolts, or negative one millivolts. In some embodiments, the pre-lithiation module controller 3002 may selectively adjust the amplitude of the current provided by the current sink 3200 to maintain the voltage from the auxiliary electrode 502 to the anode of the secondary battery 100 at a voltage between zero volts and the predetermined negative voltage. In other embodiments, any other suitable negative voltage value may be used. By preventing this voltage from becoming positive, the possibility of lithium from the auxiliary electrode 502 unintentionally plating other components in the secondary battery 100 (such as casing/constraint 116) may be avoided.

Temperature may affect the pre-lithiation process using any of the control algorithms described herein. An increased temperature may result in an increased current being able to be applied from the cathode of the secondary battery 100 to the auxiliary electrode 502. Thus, by operating at a higher temperature, more current may be conducted, which may result in pre-lithiation being completed more quickly. The gain may be greatest early in the pre-lithiation process and may decrease later in the process. Accordingly, in some embodiments, the pre-lithiation process is performed at higher temperatures early in the process in order to accelerate the pre-lithiation. In some embodiments, the gain relationship may be about 1 mA/1 C in the early pre-lithiation process.

Embodiments of the present disclosure utilize auxiliary electrodes to transfer or buffer carrier ions to a secondary battery during or subsequent to, initial formation of the secondary battery. Transferring carrier ions to the secondary battery (also referred to as pre-lithiating or buffering) mitigates carrier ion losses during formation due to, for example, SEI, thereby providing a technical benefit of improving the capacity of the secondary battery. Further, transferring carrier ions to the secondary battery provides the negative electrode of the secondary battery additional carrier ions beyond the coulombic capacity of the positive electrode of the secondary battery, thereby providing a reservoir of addition carrier ions over the cycle life of the secondary battery, further mitigating carrier ion loss during cycling due to side reactions which remove the carrier ions from availability during cycling. The result of the additional carrier ions at the negative electrode provides a further technical benefit of reducing the amount of capacity loss in the secondary battery from one discharge-charge cycle to the next, thereby improving the overall capacity of the secondary battery during its cycle life.

The following embodiments are provided to illustrate various aspects of the present disclosure. The following embodiments are not intended to be limiting and therefore, the present disclosure further supports other aspects and/or embodiments not specifically provided below.

Embodiment 1. A method of pre-lithiating a lithium based secondary battery, the lithium based secondary battery comprising a population of unit cells, an electrode busbar, and a counter-electrode busbar, wherein each unit cell of the population of unit cells comprises an electrode structure, a separator structure, and a counter-electrode structure, the electrode structure of each member of the unit cell population comprises an electrode current collector and an electrode active material layer, the counter-electrode structure of each member of the unit cell population comprises a counter-electrode current collector and a counter-electrode active material layer, and an auxiliary electrode containing lithium metal is connected to the population of unit cells. The method includes connecting a current sink to the electrode busbar and the auxiliary electrode, controlling the current sink to conduct a current from the electrode busbar through the auxiliary electrode to diffuse lithium from the auxiliary electrode to the electrode active material layers of the lithium based secondary battery, periodically detecting a voltage between the auxiliary electrode and counter-electrode busbar, periodically determining an adjustment to the voltage, and controlling the current sink to control an amplitude of the current from the electrode busbar through the auxiliary electrode to cause a sum of the voltage and the adjustment to be about zero volts.

Embodiment 2. The method of Embodiment 1, wherein periodically detecting the voltage comprises periodically detecting the voltage using a detection circuit coupled to the auxiliary electrode and the counter-electrode busbar.

Embodiment 3. The method of Embodiment 2, wherein periodically determining the adjustment to the voltage comprises: periodically determining a voltage offset of the detection circuit; and determining the adjustment to the voltage as a value will counter the voltage offset when detecting the voltage using the detection circuit.

Embodiment 4. The method of Embodiment 3, wherein the detection circuit comprises one or more amplifier having a first input for connection to the auxiliary electrode and a second input for connection to the counter-electrode busbar.

Embodiment 5. The method of Embodiment 4, wherein periodically detecting the voltage using the detection circuit comprises: connecting the auxiliary electrode to the first input and the counter electrode busbar to the second input using a switch circuit; and sampling the voltage using the detection circuit while the auxiliary electrode is connected to the first input and the counter electrode busbar is connected to the second input.

Embodiment 6. The method of Embodiment 5, wherein periodically determining the voltage offset of the detection circuit comprises: disconnecting the auxiliary electrode from the first input and disconnecting the counter electrode busbar from the second input using the switch circuit; connecting the first input of the amplifier to the second input of the amplifier; and sampling the voltage offset of the amplifier while the first input is connected to the second input.

Embodiment 7. The method of any one previous Embodiment, wherein controlling the current sink to control the amplitude of the current from the electrode busbar through the auxiliary electrode to cause the sum of the voltage and the adjustment to be about zero volts comprises controlling the current sink to control the amplitude of the current from the electrode busbar through the auxiliary electrode to cause the sum of the voltage and the adjustment to be between zero volts and a predetermined negative voltage.

Embodiment 8. The method of Embodiment 7, wherein the predetermined negative voltage is negative one millivolt.

Embodiment 9. The method of Embodiment 7, wherein the predetermined negative voltage is between zero volts and negative one millivolt.

Embodiment 10. The method of any one previous Embodiment, wherein periodically detecting the voltage between the auxiliary electrode and counter-electrode busbar and periodically determining the adjustment to the voltage comprise alternating between detecting the voltage and determining the adjustment.

Embodiment 11. The method of any one previous Embodiment, wherein controlling the current sink to cause the sum of the voltage and the adjustment to be about zero volts comprises controlling the current sink to prevent the sum of the voltage and the adjustment from becoming positive.

Embodiment 12. The method of any one previous Embodiment, wherein the electrode busbar is a cathode busbar, the electrode structure is a cathode structure, the electrode current collector is a cathode current collector, the electrode active material layer is a cathode active material layer, counter-electrode busbar is an anode busbar, the counter-electrode structure is an anode structure, the counter-electrode current collector is an anode current collector, and the counter-electrode active material layer is an anode active material layer.

Embodiment 13. The method of any one previous Embodiment, wherein periodically determining the adjustment to the voltage comprises: periodically determining a voltage error in the voltage; and determining the adjustment as a value to counter the voltage error when detecting the voltage.

Embodiment 14. A pre-lithiation module for pre-lithiating a lithium based secondary battery using auxiliary electrode containing lithium metal. The lithium based secondary battery comprises a population of unit cells, an electrode busbar, and a counter-electrode busbar. Each unit cell of the population of unit cells comprises an electrode structure, a separator structure, and a counter-electrode structure. The electrode structure of each member of the unit cell population comprises an electrode current collector and an electrode active material layer. The counter-electrode structure of each member of the unit cell population comprises a counter-electrode current collector and a counter-electrode active material layer. The auxiliary electrode is connected to the population of unit cells. The pre-lithiation module comprises a current sink; a pre-lithiation module controller connected to the current sink, the pre-lithiation module controller including a processor and a memory; a battery connector for electrical connection of the current sink to the electrode busbar of the lithium based secondary battery; and a pre-lithiation connector for electrical connection of the current sink to the auxiliary electrode. The memory of the pre-lithiation module controller stores instructions that program the pre-lithiation module controller to: control the current sink to conduct a current from the electrode busbar through the auxiliary electrode to diffuse lithium from the auxiliary electrode to the electrode active material layers of the lithium based secondary battery; periodically detect a voltage between the auxiliary electrode and counter-electrode busbar; periodically determine an adjustment to the voltage; and control the current sink to control an amplitude of the current from the electrode busbar through the auxiliary electrode to cause a sum of the voltage and the adjustment to be about zero volts.

Embodiment 15. The pre-lithiation module of Embodiment 14, further comprising detection circuit connected to the pre-lithiation module controller, wherein the instructions program the pre-lithiation module controller to detect the voltage between the auxiliary electrode and the counter-electrode busbar using the detection circuit.

Embodiment 16. The pre-lithiation module of Embodiment 15, wherein the instructions program the pre-lithiation module controller to periodically determining the adjustment to the voltage by: periodically determining a voltage offset of the detection circuit; and determining the adjustment to as a value will counter the voltage offset when detecting the voltage using the detection circuit.

Embodiment 17. The pre-lithiation module of Embodiment 16, wherein the detection circuit comprises one or more amplifier having a first input for connection to the auxiliary electrode and a second input for connection to the counter-electrode busbar.

Embodiment 18. The pre-lithiation module of Embodiment 17, further comprising a switch circuit connected to the detection circuit, wherein the instructions program the pre-lithiation module controller to periodically detect the voltage using the detection circuit by: connecting the auxiliary electrode to the first input and the counter electrode busbar to the second input using the switch circuit; and sampling the voltage using the detection circuit while the auxiliary electrode is connected to the first input and the counter electrode busbar is connected to the second input.

Embodiment 19. The pre-lithiation module of Embodiment 18, wherein the instructions program the pre-lithiation module controller to periodically determine the voltage offset of the detection circuit by: disconnecting the auxiliary electrode from the first input and disconnecting the counter electrode busbar from the second input using the switch circuit; connecting the first input of the amplifier to the second input of the amplifier; and sampling the voltage offset of the amplifier while the first input is connected to the second input.

Embodiment 20. The pre-lithiation module any one of Embodiments 14-19, wherein the instructions program the pre-lithiation module controller to control the current sink to control the amplitude of the current from the electrode busbar through the auxiliary electrode to cause the sum of the voltage and the adjustment to be about zero volts by controlling the current sink to control the amplitude of the current from the electrode busbar through the auxiliary electrode to cause the sum of the voltage and the adjustment to be between zero volts and a predetermined negative voltage.

Embodiment 21. The pre-lithiation module of Embodiment 20, wherein the predetermined negative voltage is negative one millivolt.

Embodiment 22. The pre-lithiation module of Embodiment 20, wherein the predetermined negative voltage is between zero volts and negative one millivolt.

Embodiment 23. The pre-lithiation module any one of Embodiments 14-22, wherein the instructions program the pre-lithiation module controller to periodically detect the voltage between the auxiliary electrode and counter-electrode busbar and periodically determining the adjustment to the voltage by alternating between detecting the voltage and determining the adjustment.

Embodiment 24. The pre-lithiation module of any one of Embodiments 14-23, wherein the instructions program the pre-lithiation module controller to control the current sink to cause the sum of the voltage and the adjustment to be about zero volts by controlling the current sink to prevent the sum of the voltage and the adjustment from becoming positive.

Embodiment 25. The pre-lithiation module of any one of Embodiments 14-24, wherein the electrode busbar is a cathode busbar, the electrode structure is a cathode structure, the electrode current collector is a cathode current collector, the electrode active material layer is a cathode active material layer, counter-electrode busbar is an anode busbar, the counter-electrode structure is an anode structure, the counter-electrode current collector is an anode current collector, and the counter-electrode active material layer is an anode active material layer.

Embodiment 26. The pre-lithiation module of any one of Embodiments 14-25, wherein the instructions program the pre-lithiation module controller to periodically determine the adjustment to the voltage by: periodically determining a voltage error in the voltage; and determining the adjustment as a value to counter the voltage error when detecting the voltage.

Embodiment 27. The pre-lithiation module of any one of Embodiments 14-26, wherein the pre-lithiation module controller is powered by the lithium based secondary battery connected to the battery connector.

Embodiment 28. The pre-lithiation module of any one of Embodiments 14-27, wherein the pre-lithiation module controller comprises a microcontroller.

Embodiment 29. The pre-lithiation module of any one of Embodiments 14-28, wherein the pre-lithiation module controller comprises a communication interface for communicative coupling to a central controller.

Embodiment 30. The pre-lithiation module of Embodiment 29, wherein the instructions program the pre-lithiation module controller to control the current sink to conduct a current from the electrode busbar through the auxiliary electrode to diffuse lithium from the auxiliary electrode to the electrode active material layers of the lithium based secondary battery in response to instructions received from the central controller.

Embodiment 31. A formation cluster for connection to a single lithium based secondary battery in a cell formation system for lithium based secondary batteries, the formation cluster comprising: a battery connector configured for connecting to the lithium based secondary battery; a charging module connected to the battery connector and configured to charge the lithium based secondary battery connected to the battery connector; a discharging module connected to the battery connector and configured to discharge the lithium based secondary battery connected to the battery connector; and the pre-lithiation module of any one of claims 14-30.

Embodiment 32. The formation cluster of Embodiment 31, wherein the formation cluster is configured to charge, discharge, and pre-lithiate lithium based secondary battery connected to the battery connector by instructions stored in a memory of a controller, the controller including the memory and a processor.

Embodiment 33. The formation cluster of any one of Embodiments 31 and 32, further comprising the controller communicatively coupled to the charging module, the discharging module, and the pre-lithiation module.

Embodiment 34. The formation cluster of Embodiment 33, wherein the controller comprises a charging controller coupled to and programmed to control the charging module, a discharging controller coupled to and programmed to control the discharging module, and a pre-lithiation controller coupled to and programmed to control the pre-lithiation module.

Embodiment 35. The formation cluster of any one of Embodiments 31 and 32, wherein the controller comprises a central controller remote from the formation cluster, and the formation cluster further comprises a communication interface for communicatively coupling the formation cluster to the controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1.-13. (canceled)

14. A pre-lithiation module for pre-lithiating a lithium based secondary battery using auxiliary electrode containing lithium metal, the lithium based secondary battery comprising a population of unit cells, an electrode busbar, and a counter-electrode busbar, wherein each unit cell of the population of unit cells comprises an electrode structure, a separator structure, and a counter-electrode structure, the electrode structure of each member of the unit cell population comprises an electrode current collector and an electrode active material layer, the counter-electrode structure of each member of the unit cell population comprises a counter-electrode current collector and a counter-electrode active material layer, and the auxiliary electrode is connected to the population of unit cells, the pre-lithiation module comprising:
a current sink;
a pre-lithiation module controller connected to the current sink, the pre-lithiation module controller including a processor and a memory;
a battery connector for electrical connection of the current sink to the electrode busbar of the lithium based secondary battery; and
a pre-lithiation connector for electrical connection of the current sink to the auxiliary electrode,
wherein the memory of the pre-lithiation module controller stores instructions that program the pre-lithiation module controller to:
control the current sink to conduct a current from the electrode busbar through the auxiliary electrode to diffuse lithium from the auxiliary electrode to the electrode active material layers of the lithium based secondary battery;
periodically detect a voltage between the auxiliary electrode and counter-electrode busbar;
periodically determine an adjustment to the voltage; and
control the current sink to control an amplitude of the current from the electrode busbar through the auxiliary electrode to cause a sum of the voltage and the adjustment to be about zero volts.

15. The pre-lithiation module of claim 14, further comprising detection circuit connected to the pre-lithiation module controller, wherein the instructions program the pre-lithiation module controller to detect the voltage between the auxiliary electrode and the counter-electrode busbar using the detection circuit.

16. The pre-lithiation module of claim 15, wherein the instructions program the pre-lithiation module controller to periodically determining the adjustment to the voltage by:
periodically determining a voltage offset of the detection circuit; and
determining the adjustment to as a value will counter the voltage offset when detecting the voltage using the detection circuit.

17. The pre-lithiation module of claim 16, wherein the detection circuit comprises one or more amplifier having a first input for connection to the auxiliary electrode and a second input for connection to the counter-electrode busbar.

18. The pre-lithiation module of claim 17, further comprising a switch circuit connected to the detection circuit, wherein the instructions program the pre-lithiation module controller to periodically detect the voltage using the detection circuit by:
connecting the auxiliary electrode to the first input and the counter electrode busbar to the second input using the switch circuit; and
sampling the voltage using the detection circuit while the auxiliary electrode is connected to the first input and the counter electrode busbar is connected to the second input.

19. The pre-lithiation module of claim 18, wherein the instructions program the pre-lithiation module controller to periodically determine the voltage offset of the detection circuit by:
disconnecting the auxiliary electrode from the first input and disconnecting the counter electrode busbar from the second input using the switch circuit;
connecting the first input of the amplifier to the second input of the amplifier; and
sampling the voltage offset of the amplifier while the first input is connected to the second input.

20. The pre-lithiation module of claim 14, wherein the instructions program the pre-lithiation module controller to control the current sink to control the amplitude of the current from the electrode busbar through the auxiliary electrode to cause the sum of the voltage and the adjustment to be about zero volts by controlling the current sink to control the amplitude of the current from the electrode busbar through the auxiliary electrode to cause the sum of the voltage and the adjustment to be between zero volts and a predetermined negative voltage.

21. The pre-lithiation module of claim 20, wherein the predetermined negative voltage is negative one millivolt.

22. The pre-lithiation module of claim 20, wherein the predetermined negative voltage is between zero volts and negative one millivolt.

23. The pre-lithiation module of claim 14, wherein the instructions program the pre-lithiation module controller to periodically detect the voltage between the auxiliary electrode and counter-electrode busbar and periodically determining the adjustment to the voltage by alternating between detecting the voltage and determining the adjustment.

24. The pre-lithiation module of claim 14, wherein the instructions program the pre-lithiation module controller to control the current sink to cause the sum of the voltage and the adjustment to be about zero volts by controlling the current sink to prevent the sum of the voltage and the adjustment from becoming positive.

25. The pre-lithiation module of claim 14, wherein the electrode busbar is a cathode busbar, the electrode structure is a cathode structure, the electrode current collector is a cathode current collector, the electrode active material layer is a cathode active material layer, counter-electrode busbar is an anode busbar, the counter-electrode structure is an anode structure, the counter-electrode current collector is an anode current collector, and the counter-electrode active material layer is an anode active material layer.

26. The pre-lithiation module of claim 14, wherein the instructions program the pre-lithiation module controller to periodically determine the adjustment to the voltage by:
periodically determining a voltage error in the voltage; and
determining the adjustment as a value to counter the voltage error when detecting the voltage.

27. The pre-lithiation module of claim 14, wherein the pre-lithiation module controller is powered by the lithium based secondary battery connected to the battery connector.

28. The pre-lithiation module of claim 14, wherein the pre-lithiation module controller comprises a microcontroller.

29. The pre-lithiation module of claim 14, wherein the pre-lithiation module controller comprises a communication interface for communicative coupling to a central controller.

30. The pre-lithiation module of claim 29, wherein the instructions program the pre-lithiation module controller to control the current sink to conduct a current from the electrode busbar through the auxiliary electrode to diffuse lithium from the auxiliary electrode to the electrode active material layers of the lithium based secondary battery in response to instructions received from the central controller.

31. A formation cluster for connection to a single lithium based secondary battery in a cell formation system for lithium based secondary batteries, each lithium based secondary battery comprising a population of unit cells, an electrode busbar, and a counter-electrode busbar, wherein each unit cell of the population of unit cells comprises an electrode structure, a separator structure, and a counter-electrode structure, the electrode structure of each member of the unit cell population comprises an electrode current collector and an electrode active material layer, the counter-electrode structure of each member of the unit cell population comprises a counter-electrode current collector and a counter-electrode active material layer, and an auxiliary electrode containing lithium metal is connected to the population of unit cells, the formation cluster comprising:
a battery connector configured for connecting to the lithium based secondary battery;
a charging module connected to the battery connector and configured to charge the lithium based secondary battery connected to the battery connector;
a discharging module connected to the battery connector and configured to discharge the lithium based secondary battery connected to the battery connector; and
a pre-lithiation module connected to the battery connector and configured to diffuse lithium to the electrode active material layers of the lithium based secondary battery connected to the battery connector, the pre-lithiation module comprising:
a current sink; and
an auxiliary electrode connector for connection to the auxiliary electrode;
the formation cluster configured to charge the lithium based secondary battery connected to the battery connector using the charging module, discharge the lithium based secondary battery connected to the battery connector using the discharging module, and pre-lithiate the lithium based secondary battery connected to the battery connector by:
controlling the current sink to conduct a current from the electrode busbar through the auxiliary electrode to diffuse lithium from the auxiliary electrode to the electrode active material layers of the lithium based secondary battery;
periodically detecting a voltage between the auxiliary electrode and counter-electrode busbar;
periodically determining an adjustment to the voltage; and
controlling the current sink to control an amplitude of the current from the electrode busbar through the auxiliary electrode to cause a sum of the voltage and the adjustment to be about zero volts.

32. The formation cluster of claim 31, wherein the formation cluster is configured to charge, discharge, and pre-lithiate lithium based secondary battery connected to the battery connector by instructions stored in a memory of a controller, the controller including the memory and a processor.

33. The formation cluster of claim 32, further comprising the controller communicatively coupled to the charging module, the discharging module, and the pre-lithiation module.

34.-48. (canceled)
